(19) United States
(12) Patent Application Publication
(10) Pub. No.: US 2017/0337212 A1
(43) Pub. Date: Nov. 23, 2017

(54) COMPUTER PROGRAM PRODUCT, METHOD, APPARATUS AND DATA STORAGE SYSTEM FOR MANAGING DEFRAGMENTATION IN FILE SYSTEMS

(71) Applicant: HITACHI DATA SYSTEMS ENGINEERING UK LIMITED, Bracknell, Berkshire (GB)

(72) Inventors: Mitsuo HAYASAKA, Brisbane, CA (US); Akira YAMAMOTO, Brisbane, CA (US); Christopher James ASTON, High Wycombe, Buckinghamshire (GB)

(21) Appl. No.: 15/522,304

(22) PCT Filed: Jan. 13, 2015
(86) PCT No.: PCT/EP2015/050491

§ 371 Date: Apr. 27, 2017

(51) Int. Cl. G06F 17/30; G06F 3/06; G06F 12/10

(52) U.S. Cl. CPC G06F 17/30135; G06F 12/10; G06F 17/30194; G06F 17/30091; G06F 3/0626; G06F 3/067; G06F 3/0643; G06F 3/064; G06F 2212/657

(57) ABSTRACT

Aspects of managing defragmentation in a data storage system comprising one or more storage apparatuses and a file system server connected to the one or more storage apparatuses and to one or more host computers are described, comprising: providing free space allocation information; allocating, in response to receiving an update request to update data stored in one or more first storage units of a plurality of storage units, one or more second storage units of the plurality of storage units indicated to be free based on the provided free space allocation information for writing update data of the update request, controlling writing update data to the allocated one or more second storage units, and controlling swapping logical addresses associated with the one or more second storage units with respective logical addresses associated with the one or more first storage units.

The present invention relates to data storage systems and controlling and managing data storage systems. In particular, the present invention relates to managing I/O operations to/from file systems provided in the data storage systems.

### BACKGROUND

In today's information age, data storage systems often are configured to manage file systems that include huge amounts of storage space. It is common for file systems to include many terabytes of storage space spread over multiple storage devices. In a dynamic file system environment, blocks of storage space (storage blocks) often get used, freed, and re-used over time as files are created, modified and deleted. It is common for such file systems to include mechanisms for identifying, freeing, and re-using storage blocks that are no longer being used in the file system. Traditional storage block re-use schemes, which may search through the file system storage space sequentially in order to locate free storage blocks for re-use, and data writes to areas of fragmented used and re-used storage blocks may lead to situations in which write operation performance is reduced due to the necessity of small-sized fragmented writes to fragmented areas of storage.

In view of the above, it is among the objects to improve write operation performance and efficiency, and to improve write operation performance in particular in connection with fragmented areas of storage, in particular in storage systems that have different performance for small sized fragmented writes and larger sized writes contiguously to non-fragmented areas of storage space.

### SUMMARY

According to exemplary embodiments, there may be provided a computer program product comprising computer-readable program instructions which, when running on or loaded into a file system server or computer connected to the file system server or when being executed by one or more processors or processing units of the file system server or the computer, cause the file system server to execute a method for managing defragmentation of a file system in a data storage system comprising the file system server connectable to one or more storage apparatuses and to one or more host computers.

The method may be comprising: allocating, in response to receiving an update request to update data stored in one or more first storage units (e.g. blocks or block units) of the of the plurality of storage units, one or more second storage units of the plurality of storage units indicated to be free based on free space allocation information for writing update data of the update request; controlling writing update data to the allocated one or more second storage units, and/or controlling swapping logical addresses associated with the one or more second storage units with respective logical addresses associated with the one or more first storage units.

The method may be further comprising: managing defragmentation management information indicating logical addresses associated with the one or more second storage units and logical addresses associated with the one or more first storage units.

The method may be further comprising: determining, upon receiving the update request, the logical addresses of the one or more first storage units of data to be updated with update data, and/or upon allocating the one or more second storage units based on the free space allocation information, registering respective logical addresses of the allocated one or more second storage units together with the respective determined logical addresses of the one or more second storage units in managing defragmentation management information.

Exemplarily, controlling swapping logical addresses may be executed on the basis of defragmentation management information.

Exemplarily, controlling swapping logical addresses may be executed synchronously or asynchronously with respect to receiving the update request.

Exemplarily, the one or more storage apparatuses may include a plurality of storage devices, and/or the one or more second storage units are allocated such that the update data stored to the allocated one or more second storage units may be stored on same storage device as the data stored to the one or more first storage units.

The method may be further comprising: reading update data from the one or more second storage units and writing the read update data to the one or more first storage units after controlling swapping logical addresses associated with the one or more second storage units with respective logical addresses associated with the one or more first storage units, and/or, in particular at the same time further comprising reading data from the one or more first storage units and writing the read data to the one or more second storage units to swap actual data of the one or more first storage units and the one or more second storage units.

The method may be further comprising: issuing a request to update an address mapping based on the swapping of the logical addresses associated with the one or more second storage units with the respective logical addresses associated with the one or more first storage units.

Exemplarily, the request to update an address mapping is a request to swap corresponding logical addresses in a logical-to-logical address map managed at a parity management unit configured to manage data redundant parity.

Exemplarily, the request to update an address mapping is a request to swap corresponding logical addresses or physical addresses in a logical-to-physical address map of a parity management layer managed at a parity management unit configured to manage data redundant parity or in a logical-to-physical address map of a storage device management layer managed at a storage device management unit configured to manage an array of one or more storage devices.

The method may be further comprising: providing mapping configuration information, wherein the mapping configuration information may indicate one or more logical-to-logical or logical-to-physical addresses mapping layers, and/or further indicates a layer at which the address mapping is to be updated, and/or the request to update the address mapping is issued on the basis of the provided mapping configuration information.

The method may be further comprising: managing data redundant parity including calculating, upon receiving the update request, one or more intermediate parities respectively based on data of the one or more first data storage units and the update data of the one or more second data storage units.

Exemplarily, controlling swapping logical addresses associated with the one or more second storage units with respective logical addresses associated with the one or more first storage units may be performed for data stored on a cache extension device, and/or the method may be further comprising contiguously writing data associated with logical addresses of the one or more first storage units after swapping with logical addresses of the one or more second storage units to storage areas of the one or more storage devices.

According to one or more of the above aspects, there may be provided a method for managing defragmentation of a file system in a data storage system comprising a file system server connectable to one or more storage apparatuses and to one or more host computers, the method comprising: allocating, in response to receiving an update request to update data stored in one or more first storage units of the of the plurality of storage units, one or more second storage units of the plurality of storage units indicated to be free based on free space allocation information for writing update data of the update request, controlling writing update data to the allocated one or more second storage units, and/or controlling swapping logical addresses associated with the one or more second storage units with respective logical addresses associated with the one or more first storage units.

According to one or more of the above aspects, there may be provided an apparatus, in particular a file system server, being connectable to one or more storage apparatuses and to one or more host computers, the apparatus being adapted for use in a data storage system comprising a file system server connectable to one or more storage apparatuses and to one or more host computers, the apparatus comprising a file system management controller configured to execute: allocating, in response to receiving an update request to update data stored in one or more first storage units of the of the plurality of storage units, one or more second storage units of the plurality of storage units indicated to be free based on free space allocation information for writing update data of the update request, controlling writing update data to the allocated one or more second storage units, and/or controlling swapping logical addresses associated with the one or more second storage units with respective logical addresses associated with the one or more first storage units.

According to one or more of the above aspects, there may be provided a data storage system comprising: one or more storage apparatuses, and/or an apparatus according to one or more of the above aspects being connected to the one or more storage apparatuses and being connectable to one or more host computers.

### BRIEF DESCRIPTION OF DRAWINGS

FIG. 1 is an exemplary schematic diagram showing a data storage system according to an exemplary embodiment of the present invention;

FIG. 2 is an exemplary schematic diagram showing an architecture of a file system server according to an exemplary embodiment of the present invention;

FIG. 3A is another exemplary schematic diagram showing an architecture of a file system server according to an exemplary embodiment of the present invention;

FIG. 3B is another exemplary schematic diagram showing an architecture of a file system server according to an exemplary embodiment of the present invention;

FIG. 4A is an exemplary schematic diagram showing an architecture of a storage apparatus according to an exemplary embodiment of the present invention;

FIG. 4B is an exemplary schematic diagram showing an architecture of a storage apparatus system according to an exemplary embodiment of the present invention;

FIG. 4C is an exemplary schematic diagram showing an architecture of another storage apparatus system according to an exemplary embodiment of the present invention;

FIG. 5 is an exemplary schematic diagram showing a free space object according to an exemplary embodiment of the present invention;

FIG. 6 is an exemplary schematic diagram showing a relationship between a set of indicators of a free space object and storage blocks according to an exemplary embodiment of the present invention;

FIGS. 7A to 7D show examples of free space objects according to exemplary embodiments of the invention;

FIGS. 8A to 8E exemplarily illustrate operations of writing and updating file data in a file system based on an example of a free space object;

FIGS. 9A and 9B exemplarily illustrate management of parity for the operations of FIGS. 8A to 8E;

FIGS. 10A and 10B exemplarily illustrate a random write operation and management of parity for the random write operation;

FIG. 11A exemplarily illustrates a relationship of file system management, parity management and storage device management;

FIG. 11B exemplarily illustrates a process of defragmentation based on the relationship of file system management, parity management and storage device management of FIG. 11A in accordance with exemplary embodiments of the present invention;

FIG. 11C exemplarily illustrates a process of defragmentation based on the relationship of file system management, parity management and storage device management of FIG. 11A in accordance with another exemplary embodiments of the present invention;

FIG. 12 exemplarily illustrates a free space object and logical block configuration based on the processes of FIGS. 11B and 11C;

FIG. 13A exemplarily illustrates another relationship of file system management, parity management and storage device management;

FIG. 13B exemplarily illustrates a process of defragmentation based on the relationship of file system management, parity management and storage device management of FIG. 13A in accordance with exemplary embodiments of the present invention;

FIG. 13C exemplarily illustrates a process of defragmentation based on the relationship of file system management, parity management and storage device management of FIG. 13A in accordance with another exemplary embodiments of the present invention;

FIG. 14A exemplarily illustrates another relationship of file system management and storage device management;

FIG. 14B exemplarily illustrates a process of defragmentation based on the relationship of file system management and storage device management of FIG. 14A in accordance with exemplary embodiments of the present invention;

FIG. 15 is an exemplary flow chart of a process of I/O update request processing in accordance with exemplary embodiments of the present invention;

FIG. 16 is an exemplary flow chart of a process of defragmentation information processing in accordance with exemplary embodiments of the present invention;

FIG. 17 exemplarily illustrates an example of defragmentation information in accordance with exemplary embodiments of the present invention;

FIG. 18 exemplarily illustrates an example of logical/physical mapping configuration information in accordance with exemplary embodiments of the present invention;

FIG. 19 is an exemplary flow chart of a process of defragmentation processing in accordance with exemplary embodiments of the present invention;

FIG. 20 is an exemplary flow chart of a process of erase information processing in accordance with exemplary embodiments of the present invention;

FIG. 21 is an exemplary flow chart of a process of parity processing in accordance with exemplary embodiments of the present invention;

FIG. 22 is an exemplary flow chart of a process of I/O update processing in data storage systems having a cache extension device in accordance with exemplary embodiments of the present invention;

FIG. 23 exemplarily illustrates I/O update processing in a data storage system having a cache extension device in accordance with exemplary embodiments of the present invention;

FIG. 24A exemplarily illustrates a relationship of file system management, LBA translation management, parity management and storage device management;

FIG. 24B exemplarily illustrates a process of defragmentation based on the relationship of file system management, LBA translation management, parity management and storage device management of FIG. 24A in accordance with exemplary embodiments of the present invention;

FIG. 25 is an exemplary logical block diagram of an embodiment of a file server to which various aspects of the present invention are applicable;

FIG. 26 is an exemplary block diagram of a file system module in accordance with an embodiment of the present invention;

FIG. 27 is an exemplary schematic block diagram of a file storage system in accordance with an exemplary embodiment of the present invention;

FIG. 28 is an exemplary schematic block diagram showing the general format of a file system in accordance with an exemplary embodiment of the present invention;

FIG. 29 is an exemplary schematic block diagram showing the general format of an object tree structure in accordance with an exemplary embodiment of the present invention;

FIG. 30 is an exemplary block diagram illustrating use of multiple layers of indirect onodes placed between the root onode and the direct onodes in accordance with an exemplary embodiment of the present invention;

FIG. 31 is an exemplary schematic diagram that shows the structure of an exemplary object that includes four data blocks and various onodes at a checkpoint number 1 in accordance with an exemplary embodiment of the present invention;

FIG. 32 is an exemplary schematic diagram that shows the structure of the exemplary object of FIG. 31 after a new root node is created for the modified object, after a modified copy of a data block is created, after a new direct onode is created to point to the modified copy of the data block, after a new indirect onode is created to point to the new direct onode, and after the new root node is updated to point to the new indirect onode in accordance with an embodiment of the present invention;

FIG. 33 is an exemplary schematic diagram showing various file system structures prior to the taking of a checkpoint, in accordance with an exemplary embodiment of the present invention using a circular list of DSBs to record checkpoints;

FIG. 34 is an exemplary schematic diagram showing the various file system structures of FIG. 33 after a checkpoint is taken and after modification of the indirection object, in accordance with an exemplary embodiment of the present invention using a circular list of DSBs to record checkpoints;

FIG. 35 is an exemplary schematic diagram showing various file system structures prior to the taking of a checkpoint, in accordance with an exemplary embodiment of the present invention in which one DSB is reused to create successive checkpoints; and

FIG. 36 is an exemplary schematic diagram showing the various file system structures of FIG. 35 after a checkpoint is taken and after modification of the indirection object, in accordance with an exemplary embodiment of the present invention in which one DSB is reused to create successive checkpoints.

### DETAILED DESCRIPTION OF DRAWINGS AND OF PREFERRED EMBODIMENTS

In the following, preferred aspects and exemplary embodiments will be described in more detail with reference to the accompanying figures. Same or similar features in different drawings and embodiments are sometimes referred to by similar reference numerals. It is to be understood that the detailed description below relating to various preferred aspects and preferred embodiments are not to be meant as limiting the scope of the present invention.

As used in this description and the accompanying claims, the following terms shall have the meanings indicated, unless the context otherwise requires:

A “storage device” is a device or system that is used to store data. A storage device may include one or more magnetic or magneto-optical or optical disk drives, solid state storage devices, or magnetic tapes. For convenience, a storage device is sometimes referred to as a “disk” or a “hard disk.” A data storage system may include the same or different types of storage devices having the same or different storage capacities.

A “RAID controller” is a device or system that combines the storage capacity of several storage devices into a virtual piece of storage space that may be referred to alternatively as a “system drive” (“SD”), a “logical unit” (“LU” or “LUN”), or a “volume.” Typically, an SD is larger than a single storage device, drawing space from several storage devices, and includes redundant information so that it can withstand the failure of a certain number of disks without data loss. In exemplary embodiments, each SD is associated with a unique identifier that is referred to hereinafter as a “logical unit identifier” or “LUID,” and each SD will be no larger than a predetermined maximum size, e.g., 2 TB-64 TB or more.

When commands are sent to an SD, the RAID controller typically forwards the commands to all storage devices of the SD at the same time. The RAID controller helps to overcome three of the main limitations of typical storage devices, namely that the storage devices are typically the slowest components of the storage system, they are typically the most likely to suffer catastrophic failure, and they typically have relatively small storage capacity.

A “RAID system” is a device or system that includes one or more RAID controllers and a number of storage devices. Typically, a RAID system will contain two RAID controllers (so that one can keep working if the other fails, and also to share the load while both are healthy) and a few dozen storage devices. In exemplary embodiments, the RAID system is typically configured with between two and thirty-two SDs. When a file server needs to store or retrieve data, it sends commands to the RAID controllers of the RAID system, which in turn are responsible for routing commands onwards to individual storage devices and storing or retrieving the data as necessary.

With some RAID systems, mirror relationships can be established between SDs such that data written to one SD (referred to as the “primary SD”) is automatically written by the RAID system to another SD (referred to herein as the “secondary SD” or “mirror SD”) for redundancy purposes. The secondary SD may be managed by the same RAID system as the primary SD or by a different local or remote RAID system. Mirroring SDs effectively provides RAID 1+0 functionality across SDs in order to provide recovery from the loss or corruption of an SD or possibly even multiple SDs in some situations.

A “file system” is a structure of files and directories (folders) stored in a file storage system. Within a file storage system, file systems are typically managed using a number of virtual storage constructs, and in exemplary embodiments, file systems are managed using a hierarchy of virtual storage constructs referred to as ranges, stripesets, and spans. File system functionality of a file server may include object management, free space management (e.g. allocation) and/or directory management.

A “range” is composed of either a primary SD on its own or a primary/secondary SD pair that are supposed to contain identical data and therefore offer the same storage capacity as a single SD.

A “stripeset” is composed of one or more ranges.

A “span” is composed of one or more stripesets. Thus, a span is ultimately composed of one or more SDs (typically four to fifty SDs). A span can be divided into one or more file systems, with each file system having a separate name and identifier and potentially different characteristics (e.g., one file system may be formatted with 32 KB blocks and another with 4 KB blocks, one file system may be Worm and another not, etc.). Each file system on the span is formatted, mounted, and unmounted separately. File systems may be created and deleted in any order and at any time. File systems typically can be configured to expand automatically (or alternatively to prevent or restrict auto-expansion) or can be expanded manually.

A “block” or “storage block” is a unit of storage in the file system that corresponds to portion of physical storage in which user data and/or system data is stored. A file system object (discussed below) generally includes one or more blocks. A “data block” is a unit of data (user data or metadata) to be written to one storage block.

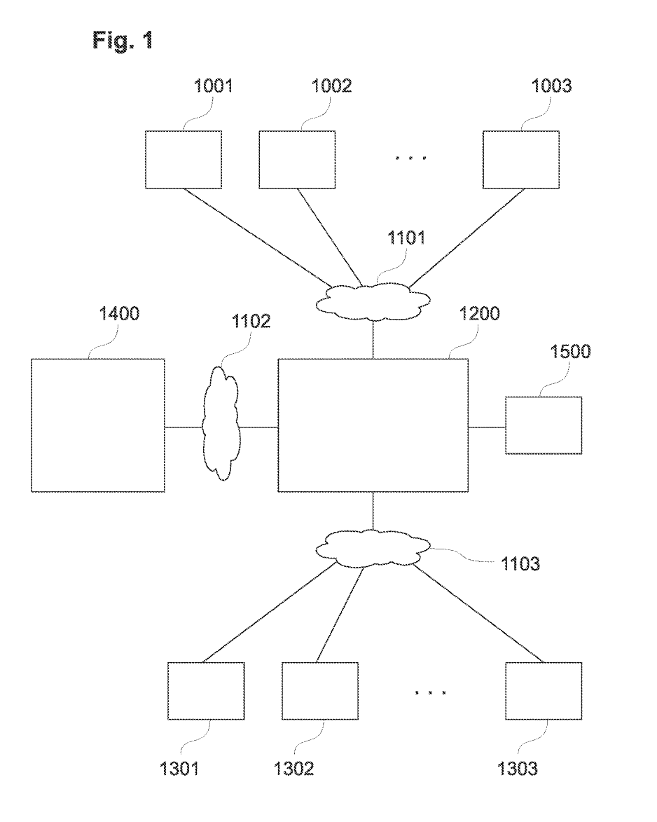

FIG. 1 exemplarily shows a schematic illustration of a configuration of a data storage system. The data storage system comprises a file system server 1200 connected to at least one host computer (client) and in FIG. 1 exemplarily a plurality of host computers (clients) 1001, 1002 and 1003 via a communication network 1101 (which may be organized and managed as a LAN, for example). The file system server 1200 is further connected to a plurality of storage apparatuses 1301, 1302 and 1303 via another communication network 1103 (which may be organized and managed as a SAN, for example). In other embodiments, only one storage apparatus may be connected to the file system server 1200, or in other embodiments the file system server and the one or more storage apparatuses may be implemented within one single device.

The file system server 1200 is adapted to manage one or a plurality of file systems, each file system being accessible by one or more of the host computers 1001 to 1003, possibly depending on individually set access rights, and, for accessing the one or more file systems, the host computers issue access requests to the file system server 1200.

Such access may include operations such as write new user data (e.g. write new files) and create new directories of the file system(s), read user data (read user data of one or more files), lookup directories, delete user data (such as delete existing files) and delete directories, modify user data (e.g. modify an existing file such as by modifying the file data or extend the file data by adding new user data to the file), create copies of files and directories, create soft links and hard links, rename files and directories etc. Also, the host computers 1001 to 1003 may issue inquiries with respect to metadata of the file system objects (e.g. metadata on one or more files and metadata on one or more directories of the file systems).

The file system server 1200 manages the access requests and inquiries issued from the host computers 1001 to 1003, and the file system server 1200 manages the file systems that are accessed by the host computers 1001 to 1003. The file system server 1200 manages user data and metadata. The host computers 1001 to 1003 can communicate via one or more communication protocols with the file system server 1200, and in particular, the host computers 1001 to 1003 can send I/O requests to the file system server 1200 via the network 1101.

A management computer 1500 is exemplarily connected to the file system server 1200 for enabling control and management access to the file system server 1200. An administrator/user may control and adjust settings of the file system management and control different functions and settings of the file system server 1200 via the management computer 1500. For controlling functions and settings of the file system management of the file system server 1200, the user can access the file system server 1200 via a Graphical User Interface (GUI) and/or via a Command Line Interface (CLI). In other embodiments such control of the file system management of the file system server 1200 can be performed via one or more of the host computers instead of the management computer 1500.

The file system server 1200 is additionally connected to the one or more storage apparatuses 1301 to 1303 via the network 1103, and the user data (and potentially also the metadata of the one or more file systems managed on the file system server 1200) is stored to storage devices of the storage apparatuses 1301 to 1303, wherein the storage devices may be embodied by plural storage disks and/or flash memory devices. In some embodiments, the storage devices of the storage apparatuses 1301 to 1303 may be controlled according to one or more RAID configurations of specific RAID levels.

Exemplarily, the file system server 1200 is additionally connected to a remote storage apparatus 1400 via another communication network 1102 for remote mirroring of the file system data (user data and/or metadata) to a remote site. Such remote mirroring may be performed synchronously and asynchronously, for example, and settings of the function of the remote mirror operation may be controlled also via the management computer 1500. The storage apparatus 1400 may be comprised of one or more apparatuses similar to the storage apparatuses 1301 to 1303 or it may be embodied by another remote file system server connected to one or more apparatuses similar to the storage apparatuses 1301 to 1303.

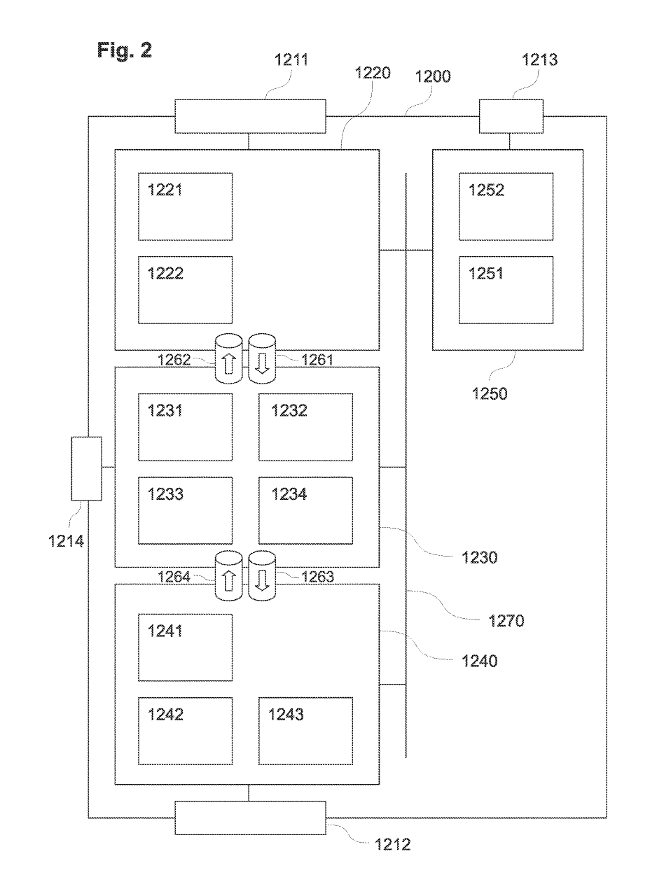

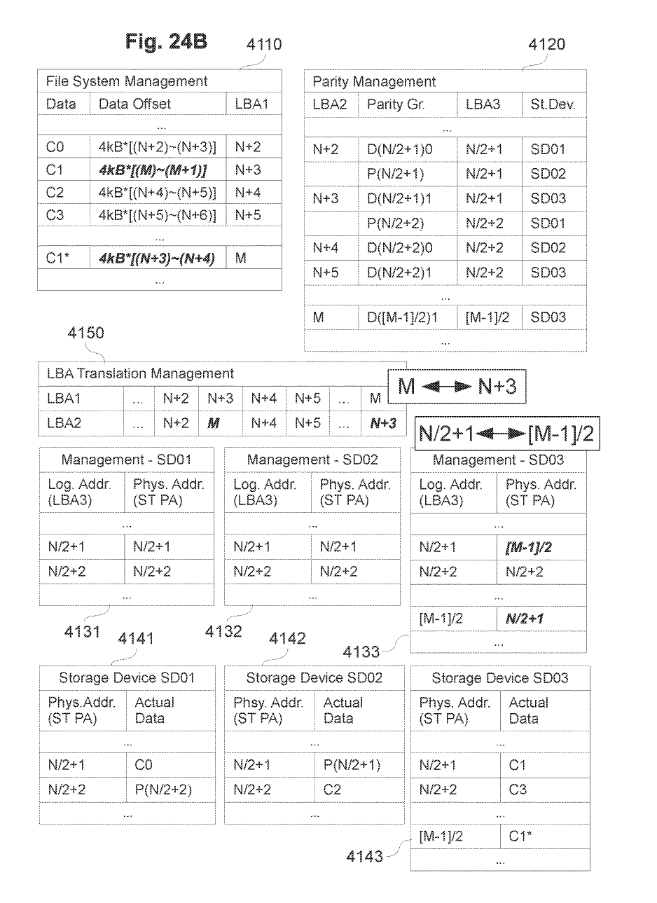

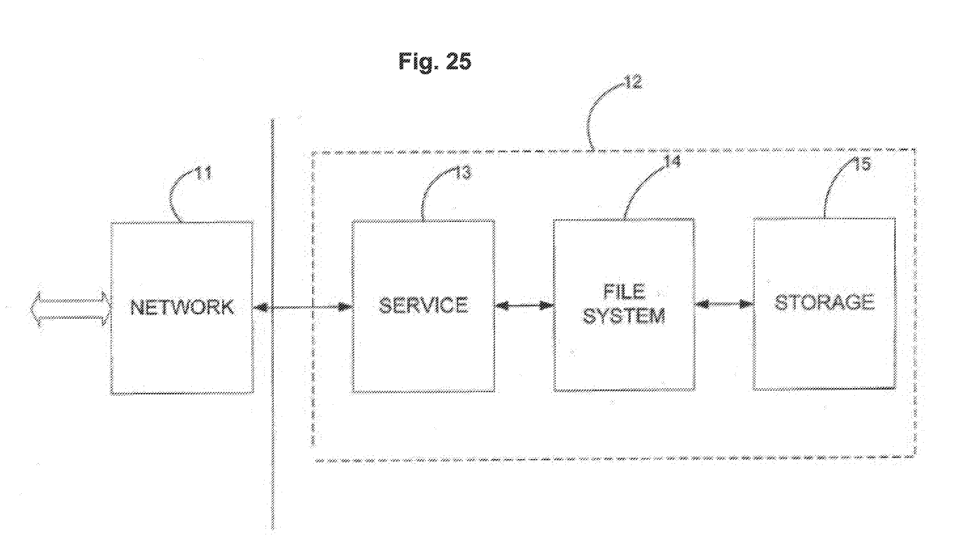

FIG. 2 exemplarily shows a schematic illustration of a configuration of a file system server 1200 (file system management apparatus) according to exemplary embodiments, please also see FIGS. 24 and 25 for related implementations.

The file system server 1200 comprises a network interface 1211 for connection to the host computers 1001 to 1003 (e.g. based on Ethernet connections or other technologies), a disk interface 1212 (or also referred to as a storage interface in that the “disk interface” of the file system server may not connect to a disk itself but rather connect to a network for communicating with a storage apparatus such as one or more storage arrays) for connection to the storage apparatuses 1301 to 1303 (e.g. based on Fibre Channel connections or other technologies), a management interface 1213 for connection to the management computer 1500 (e.g. based on Ethernet connections or other technologies), and a remote network interface 1214 for connection to the remote storage apparatus 1400 (e.g. based on Fibre Channel or Ethernet connections or other technologies).

The inner architecture of the file system server 1200 exemplarily comprises four functionally and/or structurally separated portions, each of which may be implemented as a software-based implementation, as a hardware-based implementation or as a combination of software-based and hardware-based implementations. For example, each of the portions may be provided on a separate board, in a separate module within one chassis or in a separate unit or even in a separate physical chassis.

Specifically, the file system server 1200 comprises a network interface portion 1220 (also referred to as NIP) that is connected to the network interface 1211, a data movement and file system management portion 1230 (also referred to as DFP) which may be further separated (functionally and/or structurally) into a data movement portion (also referred to as DMP) and a file system portion (also referred to as FMP), a disk interface portion 1240 (also referred to as DIP) that is connected to the disk interface, 1212, and a management portion 1250 (also referred to as MP). The various components may be connected by one or more bus systems and communication paths such as, e.g. the bus system 1270 in FIG. 2. Exemplarily, the data movement and file system management portion 1230 is connected to the remote network interface 1214.

The network interface portion 1220 is configured to manage receiving and sending data packets from/to hosts via the network interface 1211. The network interface portion 1220 comprises a processing unit 1221 (which may comprises one or more processors such as one or more CPUs (in particular, here and in other aspects, one or more CPUs may be provided as single-core CPUs or even more preferably as one or more multi-core CPUs) and/or one or more programmed or programmable hardware-implemented chips or ICs such as for example one or more Field Programmable Gate Arrays referred to as FPGAs) and a network interface memory 1222 for storing packets/messages/requests received from the host(s), prepared response packets/messages prior to sending the packets to host(s), and/or for storing programs for control of the network interface portion 1220 and/or the processing unit 1221.

The network interface portion 1220 is connected to the data movement and file system management portion 1230 via the fastpath connections 1262 and 1261 for sending received packets, messages, requests and user data of write requests to the data movement and file system management portion 1230 and for receiving packets, messages, requests, file system metadata and user data in connection with a host-issued read request from the data movement and file system management portion 1230. The fastpath connections (communication paths 1261 and 1262) may be embodied, for example, a communication connection operating according to Low Differential Voltage Signaling (LVDS, see e.g. ANSI EIA/TIA-644 standard) such as one or more LVDS communication paths so as to allow for high and efficient data throughput and low noise.

The data movement and file system management portion 1230 is configured to manage data movement (especially of user data) between the network interface portion 1220 and the disk interface portion 1240, and to further manage the one or more file system(s), in particular manage file system objects of the one or more file systems and metadata thereof, including the management of association information indicating an association relation between file system objects and actual data stored in data blocks on the storage devices or the storage apparatuses 1301 to 1303.

The data movement and file system management portion 1230 comprises a processing unit 1231 (which may comprises one or more processors such as one or more CPUs and/or one or more programmed or programmable hardware-implemented chips or ICs such as for example one or more Field Programmable Gate Arrays referred to as FPGAs) and a DFP memory 1232 for storing packets/messages/requests received from the NIP, prepared response packets/messages prior to sending the packets to the NIP, and/or for storing programs for control of the data movement and file system management portion 1230 and/or the processing unit 1231.

The data movement and file system management portion 1230 is connected to the disk interface portion 1240 via the fastpath connections 1263 and 1264 for sending received packets, messages, requests and user data of write requests to the disk interface portion 1240 and for receiving packets, messages, requests, and user data in connection with a host-issued read request from the disk interface portion 1240. The fastpath connections (communication paths 1263 and 1264) may be embodied, for example, a communication connection operating according to Low Differential Voltage Signaling (LVDS, see e.g. ANSI EIA/TIA-644 standard) such as one or more LVDS communication paths so as to allow for high and efficient data throughput and low noise.

The data movement and file system management portion 1230 exemplarily further comprises a metadata cache 1234 for storing (or temporarily storing) metadata of the file system(s) and file system objects thereof used for managing the file system.

The data movement and file system management portion 1230 exemplarily further comprises a non-volatile memory 1233 (such as e.g. an NVRAM) for storing data of packets, messages, requests and, especially, for storing user data associated with write requests and read requests. Especially, since the data of write requests can be saved quickly and efficiently to the non-volatile memory 1233 of the DFP 1230, the response to the hosts can be issued quickly directly after the associated data has been safely stored to the non-volatile memory 1233 even before actually writing the data to one or more caches or to the storage devices of the storage apparatuses 1301 to 1303.

The disk interface portion 1240 is configured to manage receiving and sending user data, data packets, messages, instructions (including write instructions and read instructions) from/to storage apparatuses 1301 to 1303 via the network interface 1212.

The disk interface portion 1240 comprises a processing unit 1241 (which may comprises one or more processors such as one or more CPUs and/or one or more programmed or programmable hardware-implemented chips or ICs such as for example one or more Field Programmable Gate Arrays referred to as FPGAs) and a disk interface memory 1242 for storing packets/messages/requests received from the DFP and/or for storing programs for control of the disk interface portion 1240 and/or the processing unit 1241.

In addition, the disk interface portion 1240 exemplarily further comprises a user data cache 1243 (sometimes also referred to as disk interface cache or sector cache, not to be confused with a cache of a storage apparatus described later) for storing or temporarily storing data to be written to storage apparatuses and/or data read from storage apparatuses via the disk interface 1212.

Finally, the management portion 1250 connected to the management interface 1213 comprises a processing unit 1251 (which may comprises one or more processors such as one or more CPUs and/or one or more programmed or programmable hardware-implemented chips or ICs such as for example one or more Field Programmable Gate Arrays referred to as FPGAs) and a management memory 1252 for storing management information, management setting information and command libraries, and/or for storing programs for control of the management portion 1250 and/or the processing unit 1251, e.g. for controlling a Graphical User Interface and/or a Command Line Interface provided to the user of the management computer 1500.

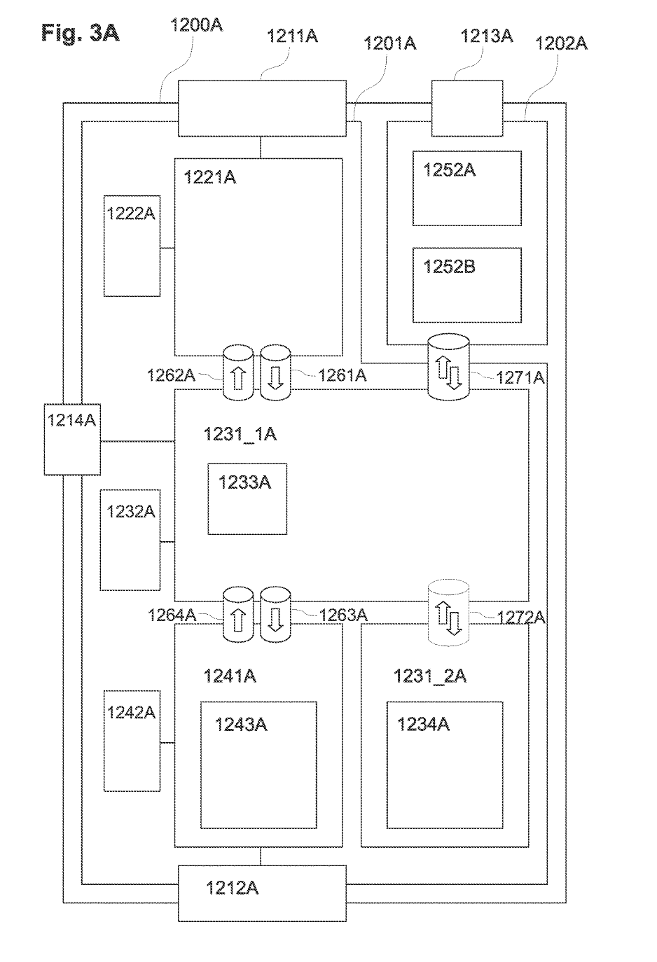

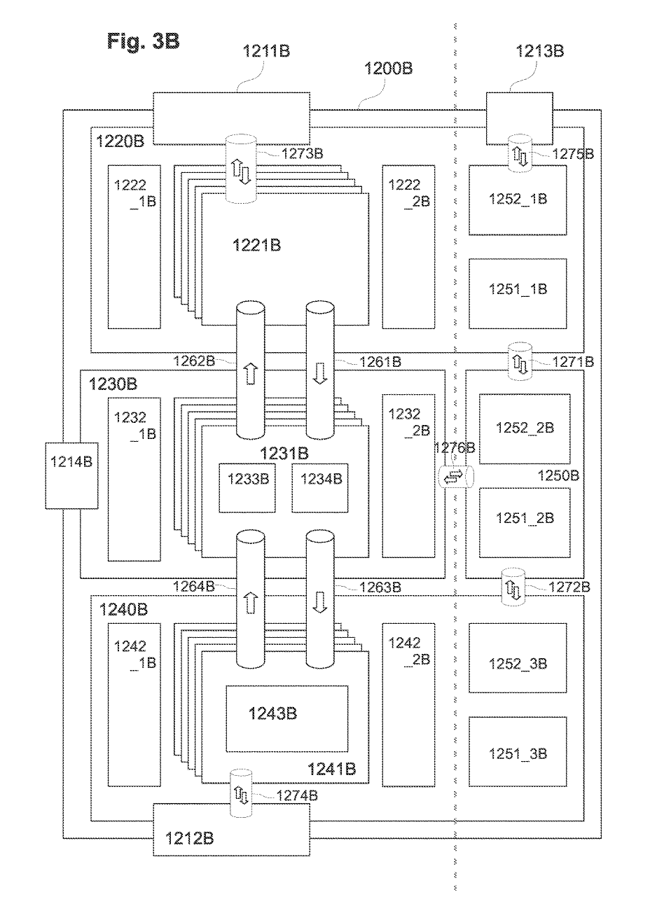

FIG. 3A exemplarily shows a schematic illustration of a more specific configuration of a file system server 1200A (file system management apparatus) according to an exemplary embodiment. Exemplarily, the file system server 1200A comprises a file system unit 1201A and a management unit 1202A. In some embodiments, the file system unit 1201A and the management unit 1202A may be embodied by separate boards, i.e. a file system board and a management board, that may be implemented in one server module (one or more of the modules may be implemented in one server chassis) or as separate modules, e.g. as a file system module and a management module, which may be implemented in one or more server chassis.

In this embodiment of FIG. 3A, the management unit 1202A may functionally and/or structurally correspond to the management portion 1250 of FIG. 2. The management unit 1202A (e.g. a management board) comprises the management interface 1213A (corresponding to the management interface 1213), the processing unit 1251A (corresponding to the processing unit 1251), preferably comprising one or more CPUs, and the management memory 1252A (corresponding to the management memory 1252).

The file system unit 1201A may functionally and/or structurally correspond to the portions 1220 to 1240 of FIG. 2. The file system unit 1201A (e.g. a file system board) comprises the network interfaces 1211A (corresponding to network interface 1211), the disk interface 1212A (corresponding to disk interface 1212), and the remote network interface 1214A (corresponding to remote network interface 1214).

Corresponding to the network interface portion 1220, the file system unit 1201A comprises a network interface memory 1222A and a network interface unit (NIU) 1221A which corresponds to processing unit 1221 and may be embodied by one or more programmed or programmable hardware-implemented chips or ICs such as for example one or more Field Programmable Gate Arrays referred to as FPGAs.

Corresponding to the disk interface portion 1240, the file system unit 1201A comprises a disk interface memory 1242A and a disk interface unit 1241A (DIU), which corresponds to processing unit 1241, and may be embodied by one or more programmed or programmable hardware-implemented chips or ICs such as for example one or more Field Programmable Gate Arrays referred to as FPGAs. The disk interface unit 1241A comprises the sector cache memory 1243A (corresponding to the sector cache memory 1243).

Corresponding to the data movement portion of the DFP 1230, the file system unit 1201A comprises a DM memory 1232A (corresponding to DMP memory 1232), a DM unit 1231_1A (data movement management unit—DMU) and a FS unit 1231_2A (file system management unit—FSU) corresponding to processing unit 1231, and both being possibly embodied by one or more programmed or programmable hardware-implemented chips or ICs such as for example one or more Field Programmable Gate Arrays referred to as FPGAs.

The DM unit 1231_1A comprises or is connected to the non-volatile memory 1233A (corresponding to the non-volatile memory 1233) and the FS unit 1231_2A comprises or is connected to the metadata cache memory 1234A (corresponding to the metadata cache memory 1234). The FS unit 1231_2A is configured to handle management of the file system(s), file system objects and metadata thereof and the DM unit 1231_1A is configured to manage user data movement between the network and disk interface units 1221A and 1241A.

The network interface unit 1221, the DM unit 1231_1A and the disk interface unit 1241A are respectively connected to each other by the data connection paths 1261A and 1262A, and 1263A and 1264A (e.g. fastpath connections corresponding to paths 1261 to 1264). In addition, the DM unit 1231_1A is connected to the management unit 1202A by communication path 1271A and to the DM unit 1231_1A by communication path 1272A (which may be implemented via fastpaths or regular data connections such as via an internal bus system etc.).

FIG. 3B exemplarily shows a schematic illustration of another more specific configuration of a file system server 1200B (file system management apparatus) according to an embodiment. Exemplarily, the file system server 1200B comprises a network interface module 1220B, a data movement and file system management module group comprising the data movement and file system module 1230B and a management module 1250B, and a disk interface module 1240B. In some embodiments, each of the above modules may be provided separately and inserted into a physical server chassis to be connected to each other according to a modular assembly (i.e. single modules may be exchanged if required, or some or all of the modules may be provided at a higher number depending on the requirements).

For management purposes, each of the network interface module 1220B, the management module 1250B and the disk interface module 1240B comprises a respective management memory 1252_1B, 1252_2B and 1252_3B and a respective processing unit 1251_1B, 1251_2B and 1251_3B (each of which may comprises one or more processors such as one or more CPUs). Accordingly, the components on the right side of the dashed line in FIG. 3B correspond to the management portion 1250 of FIG. 2 or portion 1202A of FIG. 3A, however, exemplarily, different processing units and associated memories are provided for controlling management of the network interfaces, the file system and data movement management, and the disk interfaces. The respective portions of the modules are communicably connected via communication paths 1271B, 1272B and 1275B to allow for communication to the management computer 1500 via the interface 1213B (the communication paths 1271B, 1272B and 1275B may be implemented via fastpaths or regular data connections such as via a bus system etc.).

Corresponding to the network interface portion 1220, the network interface module 1220B exemplarily comprises two network interface memories 1222_1B and 1222_2B and a plurality of network interface units (NIU) 1221B (corresponding to processing unit 1221) which are connected to the network interface via communication path 1273B and may be embodied by a plurality of programmed or programmable hardware-implemented chips or ICs such as for example Field Programmable Gate Arrays referred to as FPGAs.

Corresponding to the disk interface portion 1240, the disk interface module 1240B exemplarily comprises two disk interface memories 1242_16 and 1242_26 and a plurality of disk interface units 1241B (DIU), which corresponds to processing unit 1241, and which may be embodied by a plurality of programmed or programmable hardware-implemented chips or ICs such as for example one or more Field Programmable Gate Arrays referred to as FPGAs. The disk interface units 1241B comprise or are connected to the sector cache memory 1243B (corresponding to the sector cache memory 1243) and are connected to the disk interface 1212B via communication path 1274B.

Corresponding to the DFP 1230, the file system and data movement management module 1201A comprises a data movement management memory 1232_1 B, a file system management memory 1232_26 and a plurality of DFP units 1231B (corresponding to processing unit 1231) and which may be embodied by a plurality of programmed or programmable hardware-implemented chips or ICs such as for example Field Programmable Gate Arrays referred to as FPGAs. Preferably, one or more of the DFP units 1231B is/are responsible mainly for management of data movement (e.g. similar to the responsibilities of unit 1231_1A) and one or more of the DFP units 1231B is/are responsible mainly for management of the file system and metadata (e.g. similar to the responsibilities of unit 1231_2A). The DFP units 1231B comprise or are connected to the non-volatile memory 1233B (corresponding to the non-volatile memory 1233) and the metadata cache memory 1234B (corresponding to the metadata cache memory 1234).

In the above aspects, data connection lines and data connection paths between modules, boards and units of the file server architecture, in particular those other than fastpaths, may be provided as one or more bus systems, e.g. on the basis of PCI, in particular PCI-E.

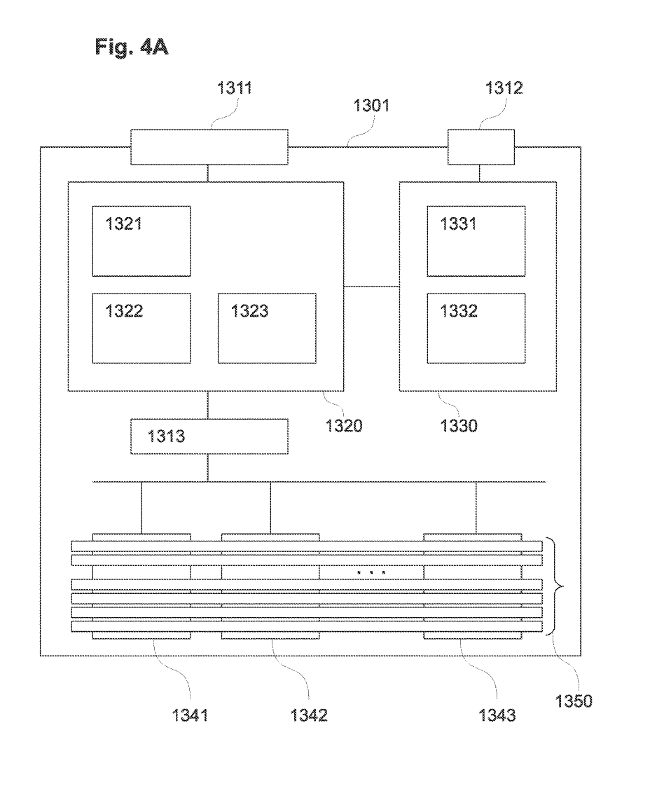

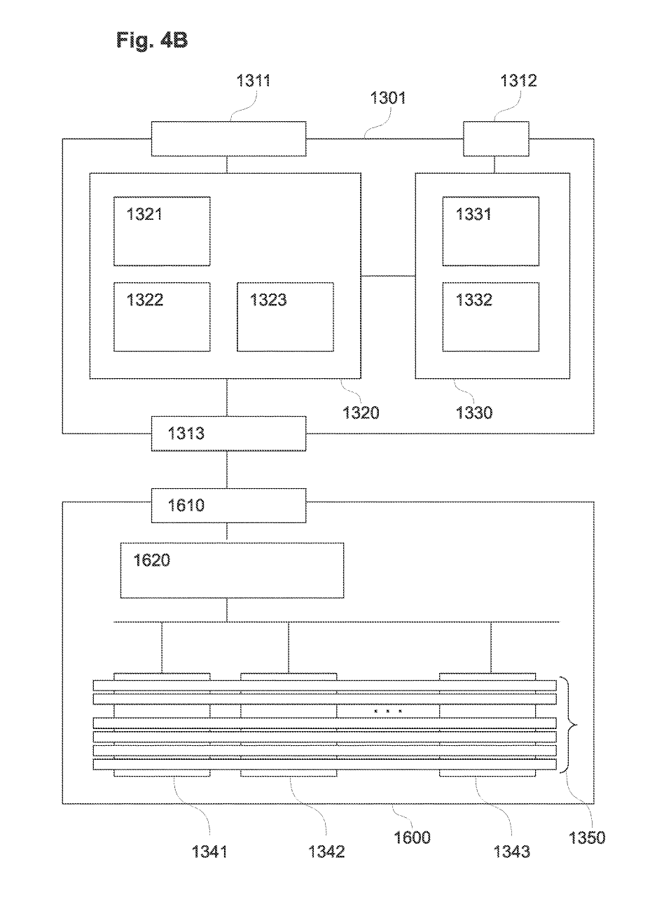

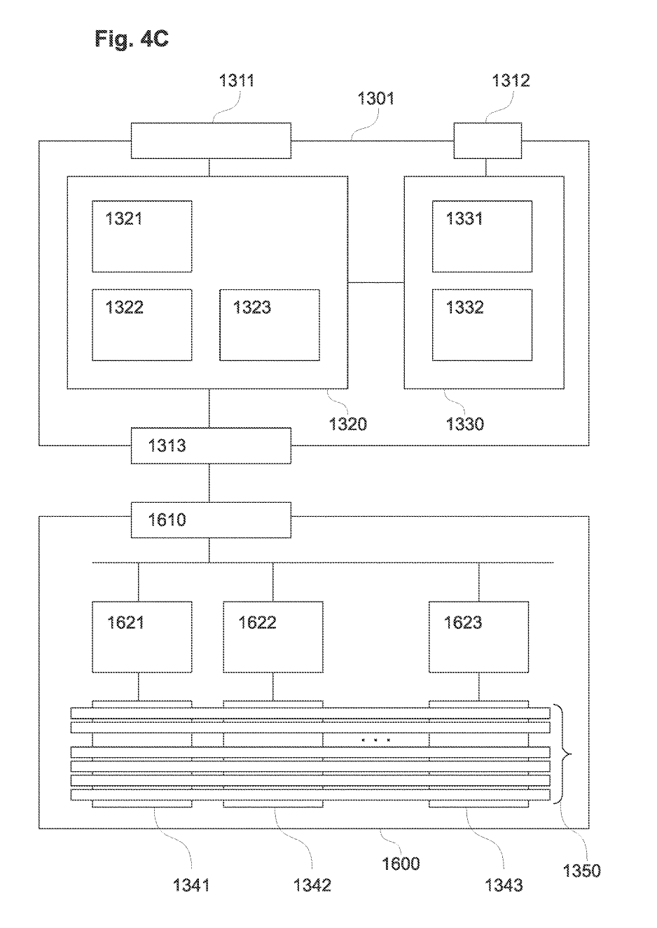

FIG. 4A exemplarily shows a schematic illustration of a configuration of a storage apparatus 1301 according to an embodiment. The storage apparatus 1301 (e.g. a storage array) comprises a network interface 1311 for connection to the disk interface of the file system server 1200 via network 1103 and a memory control unit 1320 for controlling the data movement from/to the network interface 1311 and the disk interface 1313 that is connected to a plurality of storage devices 1341, 1342 and 1343 which may be embodied by storage drives such as storage disks such as Fibre Channel disks or SATA disks, by flash memory devices, flash memory drives, solid state drives, hybrid storage drives, magnetic drives and tapes and optical disks, or combinations thereof.

The memory control unit 1320 comprises a processing unit 1321, a memory 1322 and a cache memory 1323. The memory control unit 1320 (sometimes also referred to as storage control unit, storage controller or storage management unit/storage management section) is configured to manage receiving and sending user data, data packets, messages, instructions (including write instructions and read instructions) from/to the file system server 1200.

The processing unit 1321 may comprises one or more processors such as one or more CPUs and/or one or more programmed or programmable hardware-implemented chips or ICs such as for example one or more Field Programmable Gate Arrays referred to as FPGAs, and the memory 1322 is provided for storing packets/messages/requests received from the file system server and response packets to be sent to the file system server, and/or for storing programs for control of the memory control unit 1320 and/or the processing unit 1321. The cache 1323 (sometimes also referred to as disk cache) is provided for storing or temporarily storing data to be written to disk and/or data read from disk via the disk interface 1313.

Finally, a management unit 1330 of the storage apparatus 1301 is connected to a management interface 1312 and comprises a processing unit 1331 (which may comprises one or more processors such as one or more CPUs and/or one or more programmed or programmable hardware-implemented chips or ICs such as for example one or more Field Programmable Gate Arrays referred to as FPGAs) and a management memory 1332 for storing management information, management setting information and command libraries, and/or for storing programs for control of the management unit 1330 and/or the processing unit 1331, e.g. for controlling a Graphical User Interface and/or a Command Line Interface provided to a user of a management computer (not shown, or may be the management computer 1500) connected via the management interface 1312.

The data to be stored on the storage devices 1341 to 1343 (storage disks and/or flash memory devices, herein commonly referred to as disks) is controlled to be stored in RAID groups 1350. The management of RAID groups distributed over the plurality of storage devices 1341 to 1343, and calculation of required parities according to selected RAID configurations is preferably performed by the memory control unit 1320.

FIG. 4B is an exemplary schematic diagram showing an architecture of a storage apparatus system according to some exemplary embodiments. While the operating functions, operation characteristics and various units may be similar as in the example of FIG. 4A and same reference numerals refer to equal or similar units, the exemplary embodiments of FIG. 4B are merely distinguished from the exemplary architecture of FIG. 4A in that the storage devices 1341 to 1343 are provided in a separate storage array apparatus 1600 having the multiple storage devices 1341 to 1343 and an interface 1610 to be connected to the interface 1313 of the storage apparatus 1301 (which may also be referred to as storage control apparatus in some embodiments such as e.g. in FIGS. 4B and 4C).

Exemplarily, the storage array apparatus 1600 may further include a storage device control unit 1620. For example, if one or more of the storage devices 1341 to 1343 may be embodied by or comprise one or more solid state storage devices or flash memory devices (e.g. solid state drives, solid state drive arrays or USB flash drives or the like), the storage device control unit 1620 may be configured to control or manage specific control or management operations of solid state storage devices or flash memory devices such as control and memory operations relating to flash drive block erasure management, memory wearing management (e.g. related to level wearing etc.) and/or garbage collection management or the like. In some embodiments, the storage device control unit 1620 may include a memory to store management information including address map data for associating or linking logical block addresses (as e.g. referred to by the file system management or the storage management and parity calculation management) and physical addresses of the physical storage regions of the solid-state/flash storage device.

FIG. 4C is an exemplary schematic diagram showing another example architecture of another storage apparatus system according to some exemplary embodiments. The only difference to the exemplary embodiments of FIG. 4B is that instead of one single storage device control unit 1620 for each (or at least some) of the storage devices 1341 to 1343, the storage array apparatus 1600 has multiple storage device control units 1621 to 1623, each being associated and responsible for only one of the respective storage devices 1341 to 1343.

For example, if one or more of the storage devices 1341 to 1343 may be embodied by or comprise one or more solid state storage devices or flash memory devices (e.g. solid state drives, solid state drive arrays or USB flash drives or the like), the storage device control units 1621 to 1623 may be configured to control or manage specific control or management operations of solid state storage devices or flash memory devices such as control and memory operations relating to flash drive block erasure management, memory wearing management (e.g. related to level wearing etc.) and/or garbage collection management or the like. In some embodiments, the storage device control units 1621 to 1623 may include respective memories to store respective management information including respective address map data for associating or linking logical block addresses (as e.g. referred to by the file system management or the storage management and parity calculation management) and physical addresses of the physical storage regions of the respective solid-state/flash storage device(s).

It is to be noted that the exemplary embodiments of FIGS. 4B and 4C are not limited to embodiments in which all of the storage devices of the storage array apparatus 1600 have an associated storage device control unit. For example, in case of mixed storage arrays including different types of storage devices such as e.g. including hard disk drives and solid state drives or flash memory devices, it is conceivable that only solid state drives or flash memory devices have one or more associated storage device control units 1620, 1621, 1622 or 1623, while hard disk drives may be connected directly or indirectly (i.e. via interfaces) to the control unit 1320 or the like.

Also, it is conceivable that one or more storage device control units 1620, 0.1621, 1622 or 1623 are added to be connected between one, more or all of the storage devices 1341 to 1343 in FIG. 4A and the control unit 1320, in particular preferably if one or more of the storage devices 1341 to 1343 are embodied by or comprise one or more solid state storage devices or flash memory devices (e.g. solid state drives, solid state drive arrays or USB flash drives or the like).

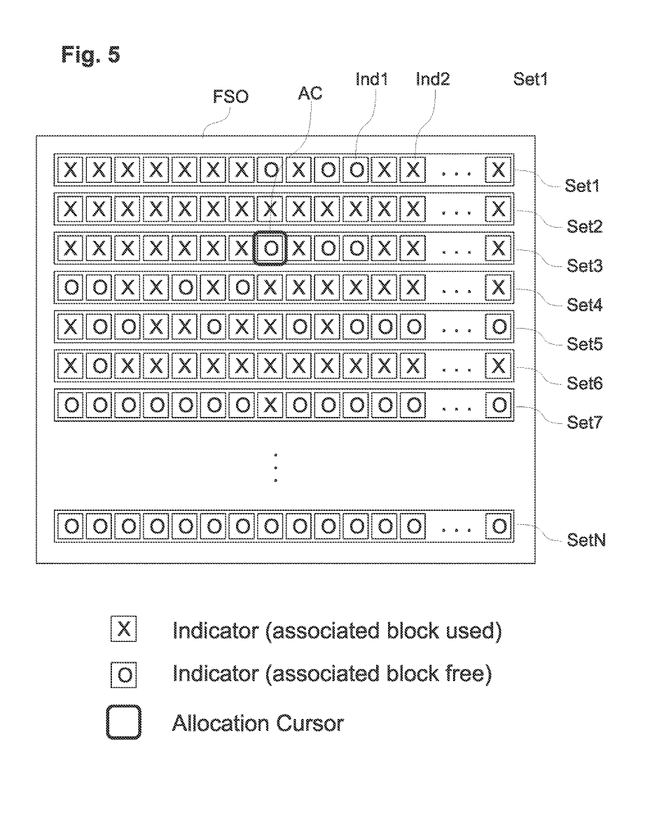

FIG. 5 exemplarily shows a schematic view of a free space object FSO according to exemplary embodiments. The free space object FSO may be an object (e.g. managed as a file system object, such as discussed above) that is stored in the metadata cache of the file system server 1200 (e.g. metadata cache 1234, 1234A or 1234B) and is used by the file system management portion/file system management unit/file system management module to manage allocation of storage blocks in the storage devices 1341 to 1343 when user data is to be written to disk upon receipt of a write request.

Basically, the indicators are exemplarily provided in two types, wherein a first-type indicator Ind1 indicates that the associated storage block is free (i.e. it can be allocated to new user data and new user data can be written to the respective storage block, e.g. because no user data is yet stored in the respective storage block or because the user data stored in the storage block is not longer required, e.g. because an associated file system object such as the respective file is deleted), and a first-type indicator Ind2 indicates that the associated storage block is used (i.e. it cannot be allocated to new user data because it is used in that user data is stored already in the respective storage block and is still required, e.g. because the associated file system object such as the respective file not deleted, or deleted but still needed for older snapshots).

Exemplarily, in FIG. 5, the indicators of the free space object FSO are ordered in groups so as to form plural sets of Indicators referred to as Set1 to SetN in FIG. 5. The free space object FSO comprises an allocation cursor AC which indicates the current position of the block allocation operation. That is, the allocation cursor AC indicates the first free and non-allocated block in the storage devices 1341 to 1343 that is to be allocated next (or the last non free and allocated block in the storage devices 1341 to 1343 that is followed by the next free and unallocated block to be allocated next, or the position between the last non free and allocated block and the first free and non-allocated block that is to be allocated next), when new user data is to be written.

Accordingly, when new data (user data and/or metadata) is to be written to the storage devices 1341 upon receipt of a write request from one of the host computers, the new user data (which may typically comprise data of the size of plural blocks) is allocated to storage blocks of the next free blocks indicated by the first-type indicators Ind1 starting at the allocation position of the allocation cursor AC.

As exemplarily shown in FIG. 5, the free space object FSO comprises a plurality of indicators Ind1 and Ind2, wherein each indicator is associated (directly or indirectly via one or more abstract layers of logical block addresses and address maps) with a respective storage block in the storage devices 1341 to 1343.

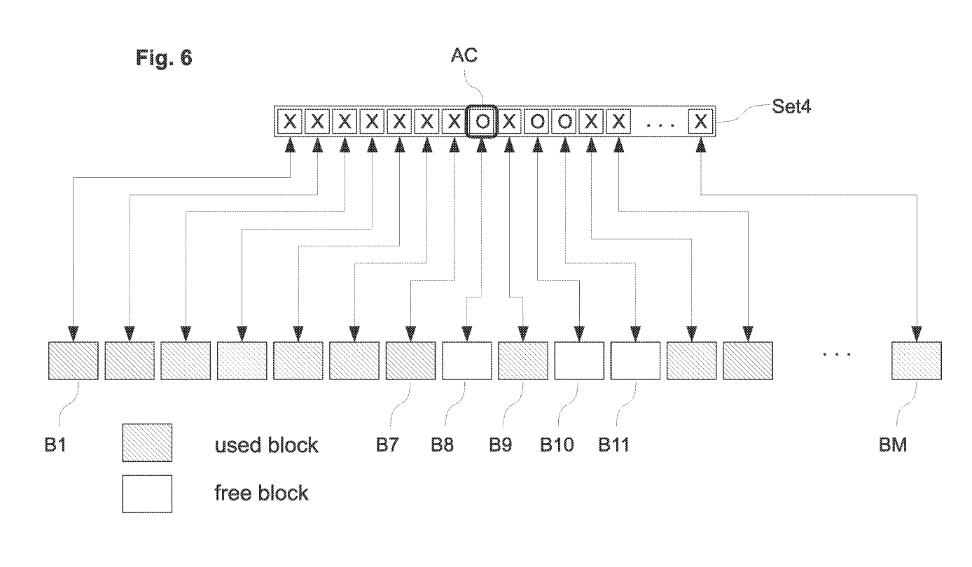

For example, FIG. 6 exemplarily shown the association between the indicators of the set of indicators referred to as Set4 and storage blocks B1 to BM (herein, exemplarily, it is assumed that B1 to BM do represent or correspond to logical block addresses, which are again associated directly or indirectly via one or more abstract layers of logical block addresses and address maps to respective actual physical storage blocks in the storage drives such as e.g. hard disks and solid state drives/flash memories of the storage devices).

Exemplarily, the block B8 is the first unused (free) block and corresponds to the indicator that is indicated by the allocation cursor AC. Accordingly, if new user data is to be written to disk, the next block to be allocated is block B8, thereafter block B10 because block B9 is used etc.

Accordingly, the file system may be managed as a log structured file system in which new data is typically written to new disk space (e.g. not in place) so that I/O patterns may be affected by the free space allocation operations. Aspects thereof will be described in further below.

It is to be noted that in some embodiments, it may be possible to perform combined flush write operation in which plural data blocks are contiguously written to consecutive free allocateable data blocks (e.g. to a non-fragmented area of blocks). Here, the size of the set of indicators may exemplarily corresponds to the number of blocks that can be written in one combined flush write operation. In other embodiments, it may also correspond to an integer multiple of the number of blocks that are written in one combined flush write operation. Also, the size of the set of indicators can be selected so as to be optimized for or in accordance with characteristics or requirements of the respective storage apparatus or in accordance with a RAID configuration.

For example, in some storage apparatuses, it may be beneficial to select the size of the set of indicators in accordance with a stripe size of a RAID configuration, in order to reduce time required for parity calculations. Specifically, the size of the set of indicators may be selected such that the total storage size of all blocks that are written in one combined flush write operation corresponds to a stripe size of a RAID configuration of the RAID group to which the data is written (stripe size means user data of a RAID stripe excluding parity information), or such that the total storage size of all blocks that are written in one combined flush write operation corresponds to a integer multiple of stripe size of a RAID configuration of the RAID group to which the data is written. This has the advantage that write operations to fragmented storage areas can be handled much more efficiently by avoiding unnecessary parity calculations due to one combined flush write to a stripe size (excluding parity information) of a RAID configuration of the RAID group.

In the above, the free space object (as an example for free space allocation information) was discussed in a general manner. As mentioned, the free space object exemplarily stores a plurality of indicators, each indicator being associated with one of a plurality of storage blocks for storing data blocks in the one or more storage apparatuses and each indicator indicating whether the associated storage block is free or used.

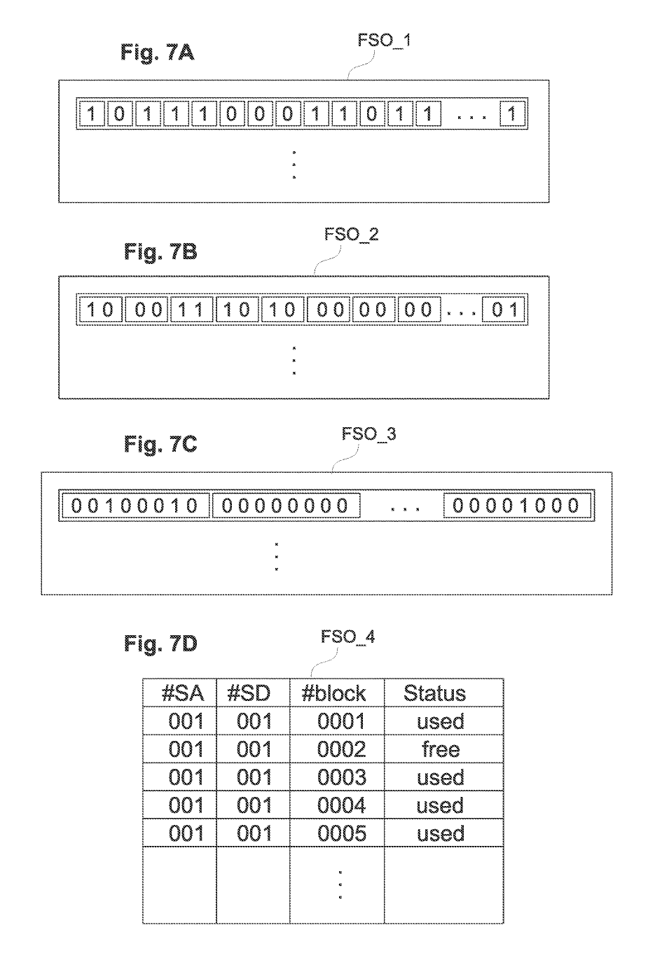

FIGS. 7A to 7D show examples of free space objects/free space allocation information according to some exemplary embodiments.

In some embodiments, as exemplarily shown in FIG. 7A, the free space object may be provided as a free space bitmap FSO_1 in which each indicator is provided as one bit, wherein exemplarily a bit “1” may indicate that the associated storage block is used and a bit “0” may indicate that the associated storage block is free, or vice versa.

On the other hand, it may occur that the free space object shall indicate plural states of the associated block such as “free”, “used for a live file system” (i.e. referenced by a file system object of the live file system), “used for one or more snapshots” (i.e. referenced by a file system object of a snapshot of the file system at an earlier checkpoint) and “used for a live file system and for one or more snapshots” (i.e. referenced by a file system object of the live file system and referenced by a file system object of a snapshot of the file system at an earlier checkpoint). Then, such four states may be indicated in a free space bitmap FSO_2 as exemplarily shown in FIG. 7B by indicators corresponding to two bits, i.e. each indicator comprising two bits. Such indicators of a two-bit free space bitmap may indicate the four states by “00”, “01”, “10” and “11”, wherein “00” may exemplarily indicate a free block, and “01”, “10” and “11” may indicate a used block. For example, in embodiments, the four states by “00”, “01”, “10” and “11” may indicate “free”, “used” (used by live file system), “snapshot” (used by a snapshot), and “root” (used for the root onode of a file system object).

Of course, if further states need to be indicated, the indicators may be provided such as to include more than two bits. For example, FIG. 7C shows an eight-bit (or 1 byte) free space bitmap FSO_3 in which each indicator comprises eight bits, and an indicator “00000000” may indicate a free block while the other 255 combinations of bits may indicate different states of used blocks. Also 4-bits per indicator are possible, or other numbers of bits per indicator depending the requirements. Such additional bits may be needed, for example, in file systems that are managed to avoid duplicated information (e.g. same data blocks being stored multiple times in different storage blocks) in order to indicate whether a storage block contains duplicate data.

In such file systems that are deduplicated in the in the sense of removing or at least avoiding duplicated information (e.g. same data blocks being stored multiple times in different storage blocks), a storage block can be freed to deduplicate, if the same data is stored as a duplicate already in another storage block, however prior to freeing the deduplicated block, all block pointers pointing to the to-be-freed storage block must be changed to point to the other (remaining) storage block also having the duplicate data block so that the reference count of the remaining storage block will be increased. Also, storage blocks can only be freed if the reference count becomes 0. Then, the indicators of the free space bitmap having more than two bits (e.g. 4 bits or even 8 bits per indicator) may be used to additionally indicate the reference count of a storage block (e.g. the 4 bits or 8 bits of the indictor may be used to indicate whether the storage block is free, used by the live file system and/or used by a snapshot, and to additionally indicate the reference count of the respective storage block).

Especially in case plural file systems are managed by the file system server, the file systems may be controlled differently and according to different snapshot policies, de-duplication policies etc. Then, different file systems may need different information included in the indicators. Then, in case free space bitmaps are used in embodiments, it may be preferable to provide plural free space objects of indicators of different bit size, e.g. a 2-bit-per-indicator bitmap for a first storage system, a 4-bit-per-indicator bitmap for a second storage system, and an 8-bit-per-indicator bitmap for a third storage system.

Furthermore, in addition to providing the free space object as a free space bitmap, the free space object may be provided in other forms such as e.g. in the form of a table such as free space table FSO_4 as exemplarily shown in FIG. 7D which exemplarily has four columns for indicating a storage apparatus (#SA), a storage device (disk or RAID group) in the storage apparatus (#SD), a block (#block) and the status of the block, e.g. “used” or “free”.

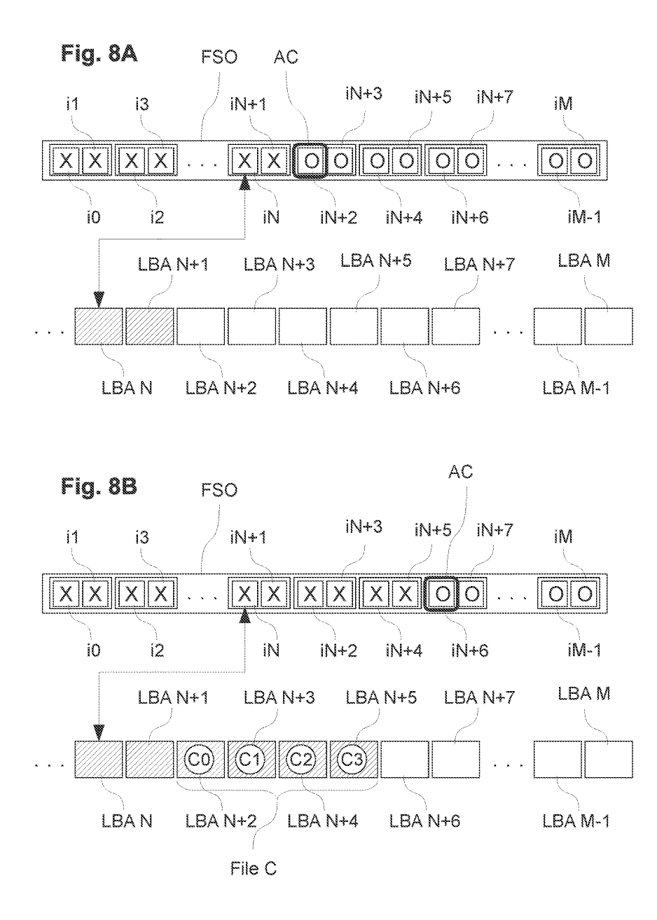

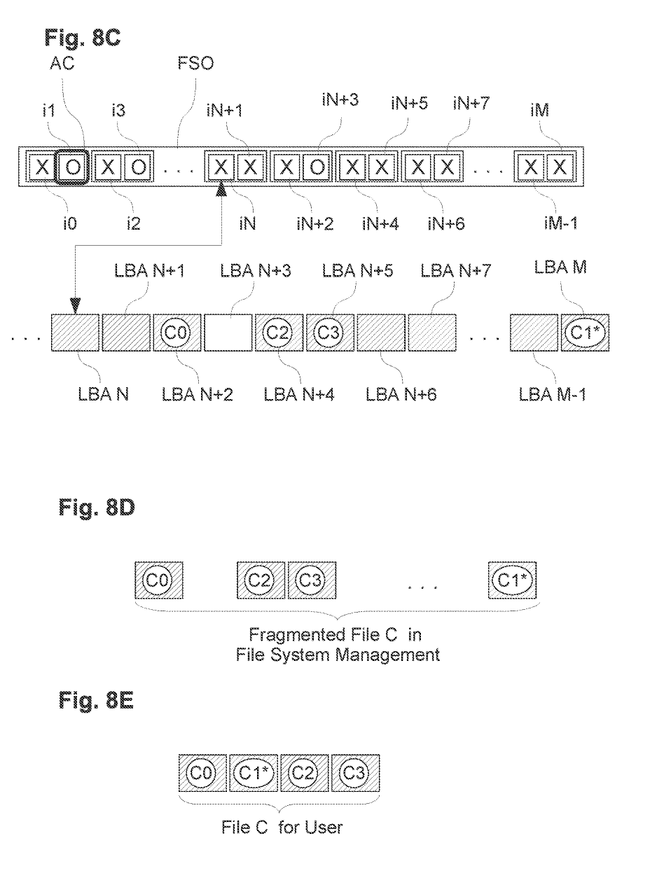

FIGS. 8A to 8E exemplarily illustrate operations of writing and updating file data in a file system based on an example of a free space object.

FIG. 8A exemplarily illustrates a situation in which the free space object (free space allocation information) is grouped into sets of two blocks (e.g. for parity management in which parity is calculated exemplarily for two blocks and a RAID configuration is used to distribute the respective two blocks and their parity among three storage devices or storage drives).

When initially filling the blocks by writing new data to the file system, the data is written contiguously to the next free blocks according to the free space object (free space allocation information). Exemplarily, the first N+2 indicators i0 to iN+1 indicate that the respective associated blocks are allocated and used already (as exemplarily identified by indicators X, see also FIGS. 5 and 6).

The allocation cursor AC is therefore currently placed so as to indicate the next free block by the indicator iN+2 (as exemplarily identified by an indicator 0, see also FIGS. 5 and 6). The indicator iN+2 is associated with the block having the logical block address LBA N+2 and is free. The previous blocks LBA N and LBA N+1 are used as indicated by the associated indicators iN and iN+1. All subsequent blocks LBA N+3 to LBA M are exemplarily still free (and it is exemplarily assumed that this is the first walkthrough through the free space object FSO).

In FIG. 8B, it is exemplarily assumed that in the next step, a new file C is written, the file C containing user data which is contiguously distributed among four blocks of data referred to as data C0, C1, C2 and C3. The allocation cursor moves through the free space object FSO until it finds the next four free blocks, which in this example means the blocks LBA N+2 to LBA N+4 as associated with the indicators iN+2 to iN+5. That is, in FIG. 8B, the blocks LBA N+2 to LBA N+4 are allocated for the data of file C, and data C0 to C3 is contiguously written to the allocated blocks LBA N+2 to LBA N+4. The next free block therefore is now the block LBA N+6 associated with indicator iN+6 of the free space object, and the allocation cursor AC has moved to the indicator iN+6.

In FIG. 8C, it assumed that plural blocks have been written and released again in the meantime, and the file C is updated by overwriting the data C1 with the updated data C1*. That is, the updated file C contains the data C0, C1*, c2 and C3. Nevertheless, the new data C1* is initially written to the next free block which is exemplarily assumed to be block LBA M associated with indicator iM of the free space object FSO. As the allocation cursor AC had in the meantime reached the last indicator, after allocating the block LBA M for the update data C1*, the allocation cursor moves back to the beginning of the free space object FSO, and exemplarily, it is placed at the next free block associated with the indicator i1 (which exemplarily had been freed previously since the situation of FIG. 8B).

Also, since the data C1 in block LBA N+3 has been updated, the file system management has now released the block (exemplarily in this case, because the data could also be retained still, e.g. in case it is associated with snapshots or older checkpoints, then it may be released/freed after the related snapshots have been removed or when the older checkpoint is erased as well), and new data can be allocated to the block LBA N+3 as also illustrated in that the associated indicator iN+3 indicates a free block.

Accordingly, while the file C appears as a contiguous file containing the consecutive data C0, C1*, C2, C3 to the user as illustrated exemplarily in FIG. 8E, the file system management according to the free space allocation information manages the related data in fragmented blocks as illustrated in FIG. 8D, in which the data C0 and C2 is separated by one block, and the data C1* is allocated to a very later block.

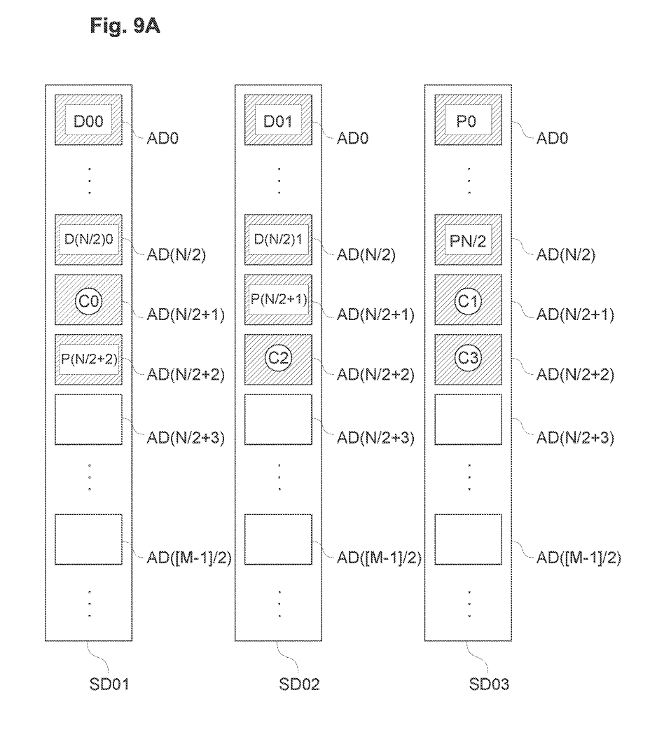

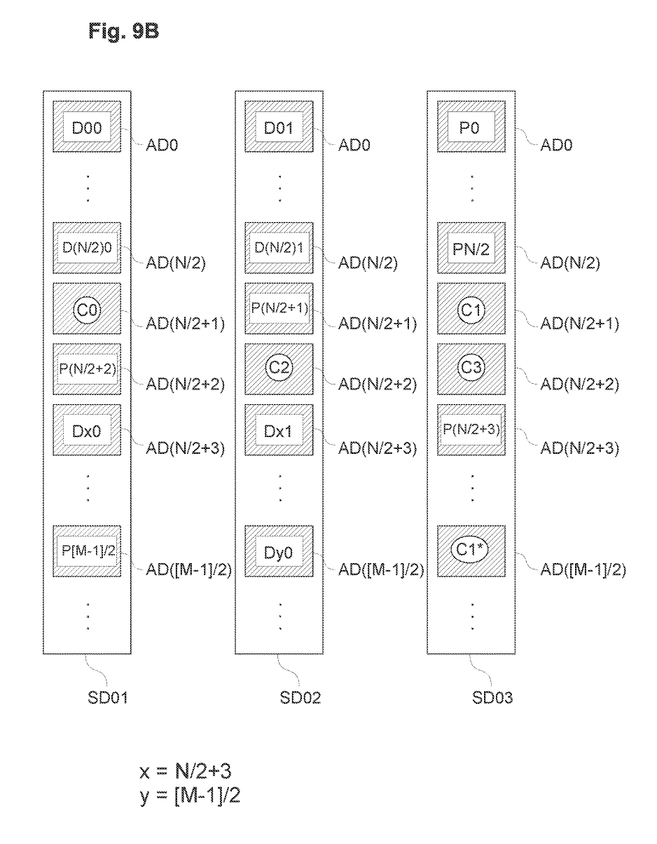

FIGS. 9A and 9B exemplarily illustrate management of parity for the operations of FIGS. 8A to 8E. Specifically, FIG. 9A exemplarily illustrates management of parity for the situation of FIG. 8B.

Exemplarily, it is assumed that the file system management section (e.g. the file server 1200, 1200A, 1200B) instructs to write the actual data to be distributed to three storage devices (or storage drives) SD01, SD02 and SD03, wherein the data is exemplarily managed in a RAID 5 configuration having two blocks associated with parity information. Of course, the present invention is not limited to such RAID 5 configurations, but the aspects and embodiments may further be applied to RAID 5 configurations having three or more blocks associated with parity information, or other RAID configurations such as RAID 3 or RAID 6, or even RAID and non-RAID configurations without parity management or parity calculations.

Exemplarily, each of the storage devices (or storage drives) SD01, SD02 and SD03 has different blocks for storing data managed in the respective storage addresses AD0 to AD[M−1]/2 and further. Here, addresses AD0 to AD[M−1]/2 and further may refer to physical addresses already, or to logical block addresses that are used by the storage device management. Also, the addresses AD0 to AD[M−1]/2 and further may be mapped to the file system logical block addresses directly or indirectly via one or more layers of further logical block addresses.

For example, in the addresses AD0 of the storage devices (or storage drives) SD01, SD02 and SD03 there is stored the data D00 on SD01 and D01 on SD03 together with associated parity information P0 on SD03. Here, exemplarily it is assumed that P0 can be calculated as D00 XOR D01, so that losing any of SD01 to SD03 e.g. due to failure allows to extract the lost data, e.g. in case of failure of SD01, the data D00 can be restored by calculating D01 XOR P0.

It is further assumed that the data of file system managed blocks LBA N and LBA N+1 is stored at storage addresses AD(N/2), wherein data of block LBA N is written to SD01 in address AD(N/2) as D(N/2)0 and data of block LBA N+1 is written to SD02 in address AD(N/2) as D(N/2)1, and the respective associated parity PN/2=D(N/2)0 XOR D(N/2)1 is written to SD03 in address AD(N/2).

Further, the data of file system managed blocks LBA N+2, i.e. C0, and LBA N+3, i.e. C1, according to FIG. 8B is stored at storage addresses AD(N/2+1), wherein data C0 of block LBA N+2 is written to SD01 in address AD(N/2+1) as D(N/2+1)0 and data C1 of block LBA N+3 is written to SD03 in address AD(N/2+1) as D(N/2+1)1, and the respective associated parity P(N/2+1)=D(N/2+1)0 XOR D(N/2+1)1=C0 XOR C1 is written to SD02 in address AD(N/2+1).

Finally, the data of file system managed blocks LBA N+4, i.e. C2, and LBA N+5, i.e. C3, according to FIG. 8B is stored at storage addresses AD(N/2+2), wherein data C2 of block LBA N+4 is written to SD02 in address AD(N/2+2) as D(N/2+2)0 and data C3 of block LBA N+5 is written to SD03 in address AD(N/2+2) as D(N/2+2)1, and the respective associated parity P(N/2+2)=D(N/2+2)0 XOR D(N/2+2)1=C2 XOR C3 is written to SD01 in address AD(N/2+2). Exemplarily, the parities are distributed according to RAID 5, but could be also all be stored on the same storage device/storage drive e.g. according to RAID 3, or additional parity might be provided on fourth storage device according to RAID 6 etc. Basically, the aspects and embodiments can be applied to any RAID configurations and any types of parity calculation and parity distribution.

FIG. 9B exemplarily illustrates management of parity for the situation of FIG. 8C. The data of file system managed blocks LBA N+6 and LBA N+7 is stored at storage addresses AD(N/2+3), wherein data of block LBA N+6 is written to SD01 in address AD(N/2+3) as D(N/2+3)0 and data of block LBA N+7 is written to SD02 in address AD(N/2+3) as D(N/2+3)1, and the respective associated parity P(N/2+3)=D(N/2+3)0 XOR D(N/2+3)1 is written to SD03 in address AD(N/2+3).

Further, the data of file system managed blocks LBA M and LBA M+1, i.e. C1*, according to FIG. 8C is stored at storage addresses AD([M−1/2]), wherein data of block LBA M is written to SD02 in address AD([M−1]/2) as D([M−1]/2)0 and data C1* of block LBA M+1 is written to SD03 in address AD([M−1]/2) as D([M−1]/2)1, and the respective associated parity P([M−1]/2)=D([M−1]/2)0 XOR D([M−1]/2)1=D([M−1]/2)0 XOR C1* is written to SD01 in address AD([M−1]/2).

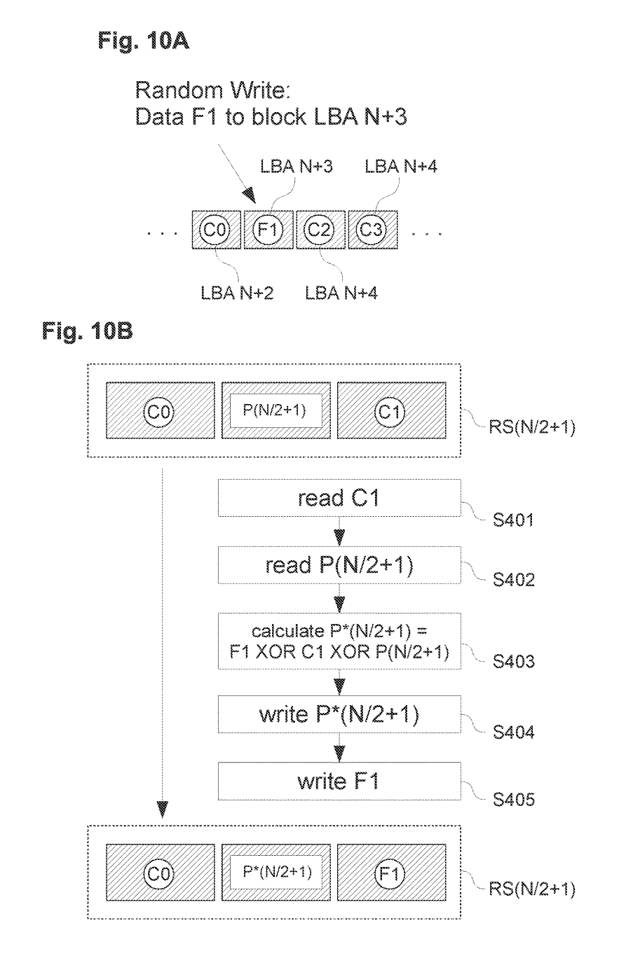

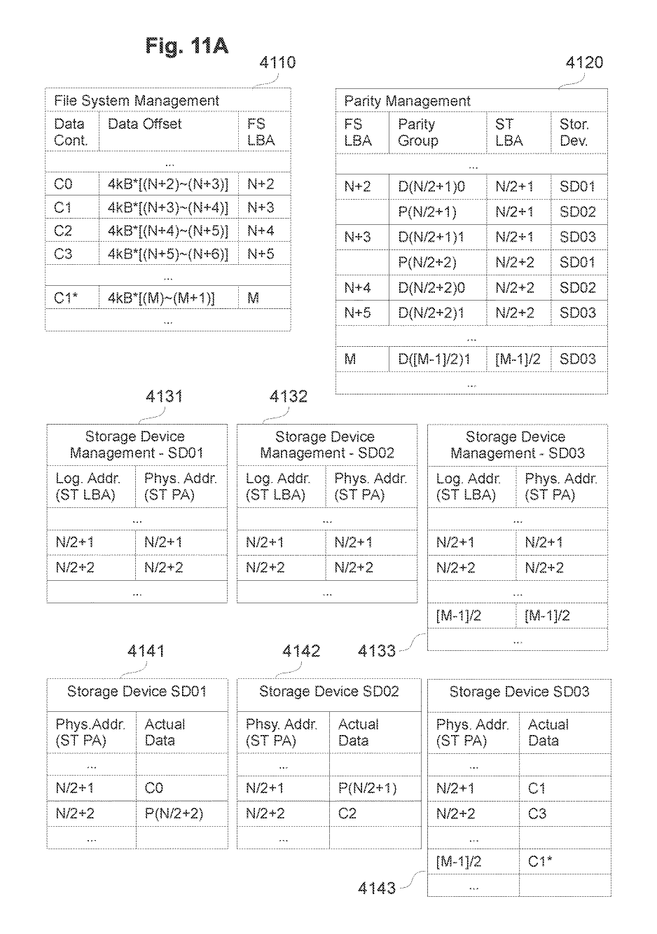

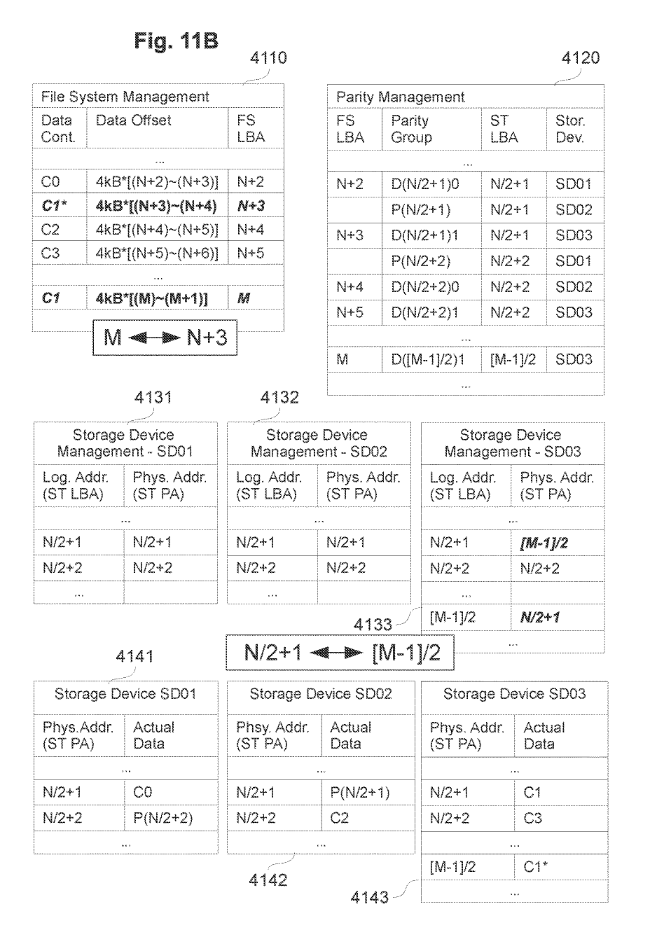

FIGS. 10A and 10B exemplarily illustrate a random write operation and management of parity for the random write operation.

Exemplarily, starting from the situation of FIG. 8C, it is assumed that a random write of writing data F1 to the block LBA N+3 is performed. That, is although only one block is indicated to be free between blocks LBA N+2 and LBA N+4, the data F1 is written to this block as it is the next free block as identified by the allocation cursor AC. Accordingly, random writes occur to write data not to contiguous blocks anymore, but to fragmented areas of blocks. So, the I/O performance to fragmented areas of blocks in the free space object/free space allocation information may decrease due to random writes instead of sequential writes to contiguous blocks as described earlier in connection with FIG. 8B.

In addition, in situation in which parity management is enabled or provided, I/O performance to fragmented areas of blocks may further be reduced to the situation that parity re-calculations may be necessary in connection with random writes to fragmented areas.

An example of such potential parity re-calculations is given in FIG. 10B in connection with writing the data F1 to block LBA N+3 according to a random write operation.

For example, according to FIG. 9B, the data C0 was previously included in the Raid stripe configuration RS(N/2+1) together with the old data C1 and the associated parity P(N/2+1)=C0 XOR C1, and due to the freeing of data block LBA N+3 and re-allocating it to be written to with the random write data F1, the updated Raid stripe configuration RS(N/2+1) would include data C0 and the new data F1 as well as the updated/new parity data P*(N/2+1)=C0 XOR F1.

However, in order to write the necessary information, the parity management needs to perform step S401 of reading data C1 and step S402 of reading data P(N/2+1) which is the old parity data, and then the new parity can be calculated in the step S403 as P*(N/2+1)=F1 XOR C1 XOR P(N/2+1), i.e. as “new data” XOR “old data” XOR “old parity data” (in case of only two blocks of data in the RAID stripe configuration, directly calculating C0 XOR F1 might be more efficient, however, the former formula using only the old data, the new data and the old parity becomes much more efficient for RAID stripe configurations having more than three blocks of data).

Then, in steps S404 and S405, the new data F1 and the new parity data P*(N/2+1) are written to the respective storage devices. Accordingly, parity re-calculations in connection with random writes may significantly reduce the I/O performance as writing new data in connection with a random write may include two read operations and two write operations as well as the step of re-calculation of the parity.

Some exemplary embodiments as described below aim at making I/O performance more efficient and improving I/O performance, in particular by aiming at reducing the random write operations or even avoiding random write operations as discussed above.

While in the prior art, it is known to execute processing-intensive defragmentation of the data stored in the storage system, see e.g. U.S. Pat. No. 8,359,430; but such defragmentation processes are usually quite inefficient and involve high processing burden due to high numbers of read and write operations involved, and potentially also significant parity re-calculations being involved. In contrast, some exemplary embodiments rather aim at improving the I/O performance by light-weight defragmentation techniques which may also involve cooperation between file system management, parity management and/or storage management, in particular by preferably re-allocating data in the free space object/free space allocation information in the file system management.

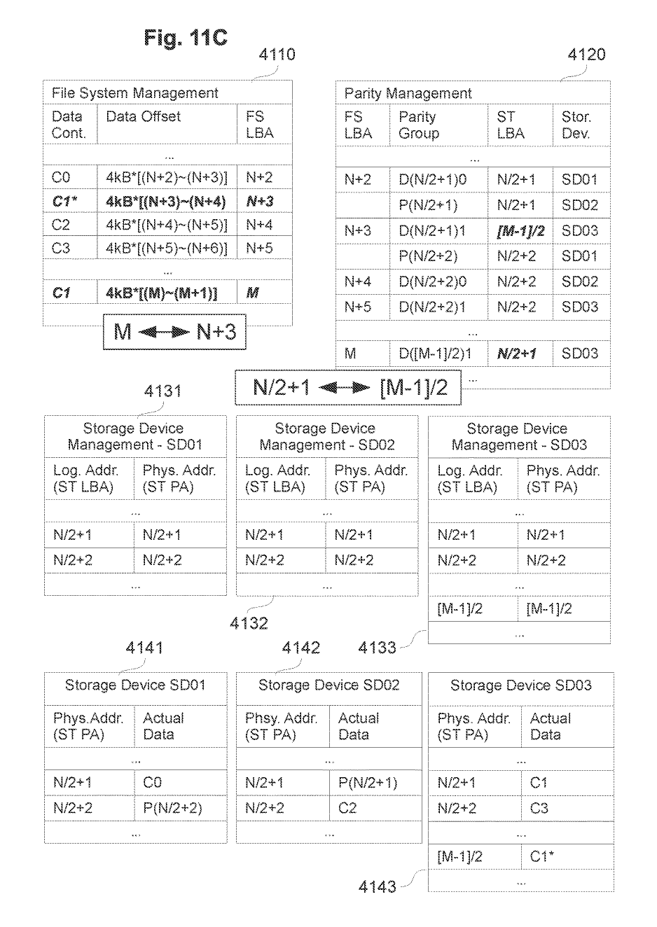

FIG. 11A exemplarily illustrates a relationship of file system management, parity management and storage device management according to some exemplary embodiments, exemplarily based on the example of FIGS. 8C and 9B.

At first, there is provided file system management information 4110 as managed by a file system management layer of the data storage system (e.g. at the side of the file system servers 1200, 1200A and 1200B, in particular e.g. at the data movement and file system management portion 1230, the file system management unit 1231_2A and/or the file system module 1230B etc.). Also, the file system management information 4110 may be provided as a registered list in a memory or it may be provided and/or managed as a file system object.

The file system management information 4110 is indicative of the association between data content and the associated logical address of data blocks which store the respective data content at the abstract file system management layer. That is, exemplarily, the data C0 is indicated to be associated with the logical block address LBA N+2 (wherein the term “FS LBA” indicates that this refers to the logical block addresses as used at the file system management layer, as other layers of logical block addresses may exist, and do in the present embodiments, see “ST LBA” below).

Further, the data C1 is indicated to be associated with the logical block address LBA N+3, the data C2 is indicated to be associated with the logical block address LBA N+4, the data C3 is indicated to be associated with the logical block address LBA N+5, and the data C1* (which is the update data of the old data C1) is indicated to be associated with the logical block address LBA M (see also FIGS. 8A to 8C).

Exemplarily, the file system management data 4110 of FIG. 11A also indicates the Data Offset (exemplarily for a block size of 4 kB, which is only an exemplary number and may typically be any number of bytes or kBytes or more).

Then, there is exemplarily provided parity management information 4120 as managed by a storage system management layer of the data storage system (e.g. at the side of the file system servers 1200, 1200A and 1200B, in particular e.g. at the data movement and file system management portion 1230, the file system management unit 1231_2A and/or the file system module 1230B etc.; but also at the storage apparatus, e.g. at the storage controller or memory control unit 1320 above). Also, the parity management information 4120 may be provided as a registered list in a memory or it may be provided and/or managed as another file system object.

The parity management information 4120 indicates the parity grouping, e.g. in that the respective parity group stripe labeling is given, and the file system sided logical block addresses are mapped to the storage side blocks addresses, in this case still exemplarily the storage system logical block addresses as identified by the term “ST LBA”, wherein the term “FS LBA” indicates that this refers to the logical block addresses as used at the storage management layer, as other layers of logical block addresses may exist (in particular the file system LBAs as discussed above). In addition, the parity management information 4120 indicates the storage devices/storage drives having the actual data associated with the respective logical block numbers, and it indicates the respective file system side logical block addresses so as to provide an address mapping information.

Exemplarily, associated with the data C0 of the file system management information 4110, the file system logic block address LBA N+1 is associated with the parity management data item D(N/2+1)0 (i.e. the data item that is grouped with the other item D(N/2+1)1 and used to calculate the associated parity P(N/2+1)) as indicated to be stored on storage device/storage drive SD01 as the storage management logical address N/2+1 (the situation that the FS LBA is equal to the ST LBA is only exemplary and may be a different one or different number, of course). The parity P(N/2+1) is indicated to be stored at storage logical address LBA N/2+1 of storage device/storage drive SD02, but no file system logical address is given/indicated as the parity data is not part of file system management but only of parity management at the parity management layer.

Further exemplarily, associated with the data C1 of the file system management information 4110, the file system logic block address LBA N+3 is associated with the parity management data item D(N/2+1)1 as indicated to be stored on storage device/storage drive SD03 at the storage management logical address N/2+1, and associated with the data C1* (i.e. the updated data of the old data C1) of the file system management information 4110, the file system logic block address LBA M is associated with the parity management data item D([M−1]/2)1 as indicated to be stored on storage device/storage drive SD03 at the storage management logical address [M−1]/2.

In addition to the file system management layer relating to the file system management information 4110 and the parity management layer relating to the parity management information 4120, there is additionally provided storage device information 4131 associated with storage device/storage drive SD01, storage device information 4132 associated with storage device/storage drive SD02, and storage device information 4133 associated with storage device/storage drive SD03. In other embodiments, it is of course possible to merge the storage device information for multiple or all of the storage devices/storage drives.

While in the above, the parity management information 4120 still indicated the storage management logical block addresses, the respective storage device information is exemplarily provided to indicate a mapping between a logical addressing layer and a physical addressing layer, i.e. to map respective (storage management) logical block addresses to associated physical addresses where the data is actually stored/written.

For example, for SD01, the storage device information 4131 indicates that the (storage management) logical block address LBA N/2+1 is mapped to (associated with) the physical address PA N/2+1 on storage device/storage drive SD01, and the (storage management) logical block address LBA N/2+2 is mapped to (associated with) the physical address PA N/2+2 on storage device/storage drive SD01. For SD02, the storage device information 4132 indicates that the (storage management) logical block address LBA N/2+1 is mapped to (associated with) the physical address PA N/2+1 on storage device/storage drive SD02, and the (storage management) logical block address LBA N/2+2 is mapped to (associated with) the physical address PA N/2+2 on storage device/storage drive SD02.

Further, for SD03, the storage device information 4133 indicates that the (storage management) logical block address LBA N/2+1 is mapped to (associated with) the physical address PA N/2+1 on storage device/storage drive SD03, the (storage management) logical block address LBA N/2+2 is mapped to (associated with) the physical address PA N/2+2 on storage device/storage drive SD03, and the (storage management) logical block address LBA [M−1]/2 is mapped to (associated with) the physical address PA [M−1]/2 on storage device/storage drive SD03.

In accordance with the above, the storage configuration information 4141, 4142 and 4143 respectively indicates the data storage configuration on the respective storage devices/storage drives SD01, SD02 and SD03.

For example, the storage configuration information 4141 indicates that SD01 stores data C0 at the physical address N/2+1 and stores parity data P(N/2+2) at the physical address N/2+2, while the storage configuration information 4142 indicates that SD02 stores parity data P(N/2+1) at the physical address N/2+1 and stores data C2 at the physical address N/2+2. Finally, the storage configuration information 4143 indicates that SD03 stores data C1 at the physical address N/2+1, stores data C3 at the physical address N/2+2 and stores the data C1* at the physical address [M−1]/2.

FIG. 11B exemplarily illustrates a process of defragmentation based on the relationship of file system management, parity management and storage device management of FIG. 11A in accordance with exemplary embodiments. As previously discussed, the data C1* represents the update data of previous data C1 of file C, wherein the old file C was represented by data C0, C1, C2 and C3, while the newly updated file is represented by data C0, C1*, C2 and C3, which was not sequentially distributed among the logical data block addresses on the file system management side and in the free space object/free space allocation information (cf. FIGS. 8C and 8D above).

According to some exemplary embodiments, the file system management layer (i.e. e.g. at the side of the file system servers 1200, 1200A and 1200B, in particular e.g. at the data movement and file system management portion 1230, the file system management unit 1231_2A and/or the file system module 1230B etc.) is configured to execute a swap operation of swapping data blocks in the file system logical block address layer, as indicated e.g. in connection with file system management information 4110 in FIG. 11B.

Exemplarily, for data C1* being the corresponding update data to update the old data C1, the file system management layer is configured to swap logical block addressing of the logical block of data C1* with the logical block addressing of the logical block of data C1, e.g. by indicating that data C1* is associated with file system LBA N+3 (instead of LBA M as previously before the swap operation) and by indicating that data C1 is associated with file system LBA M (instead of LBA N+3 as previously before the swap operation).

Accordingly, after the swap operation of FIG. 11B (and also below figures), the updated version of file C containing data C0, C1*, C2, and C3 is advantageously indicated to be sequentially provided in the contiguous blocks of logical block addresses N+2, N+3, N+4 and N+5, i.e. according to a non-fragmented or defragmented block distribution.

However, in order to provide a still correct logical to physical mapping, the file system management layer is further configured to inform the parity management layer and/or the storage device layer about the logical block address swap, or even to instruct the parity management layer and/or the storage device layer to execute a corresponding address swap, as discussed in some examples in the following.

For example in the exemplary embodiments of FIG. 11B, the block address swap is counter-balanced or even equalized by another corresponding swap in the logical-to-physical mapping of addresses at the storage management layers (e.g. here in the storage management information 4133).

For example, the file system management layer may inform the parity management layer on the swap of file system blocks M and N+3, or even instruct the parity management layer to execute a corresponding swap.

In return, when identifying based on the parity management information 4120 that the corresponding data of file system blocks M and N+3 is stored on SD03, the parity management layer may inform or even instruct the storage management layer to execute a corresponding swap of associated blocks.

Accordingly, in the present example embodiments of FIG. 11B, the storage management information 4133 is adjusted correspondingly by swapping the mapping of blocks, e.g. to swap physical addresses [M−1]/2 and N/2+1 (or alternatively the logical addresses [M−1]/2 and N/2+1) so that storage logical block address LBA N/2+1 is mapped to physical address [M−1]/2 and storage logical block address LBA [M−1]/2 is mapped to physical address N/2+1. Accordingly, the mapping information of storage management information 4133 is swapped to counter-act the swapping of addresses in the file system management information 4110 at the file system management layer.

Accordingly, with the significant benefits that no actual data needs to be re-written (C1 remains to be stored at physical address PA N/2+1 and C1* remains to be stored at physical address PA [M−1]/2) and no parity needs to be re-calculated, the double-swapping (e.g. once at the file system management layer and once at the storage management layer) of associated blocks allows to provide blocks C0, C1*, C2 and C3 of updated file C in sequential and de-fragmented blocks at the file system management layer in an efficient manner at low processing burden, thereby improving the further I/O processing performance due to light-weight defragmentation of the file system management layer in connection with data updates.

Here, in connection with above FIG. 11B and below FIG. 11C, it is to be noted that the map swapping is performed at the storage management layer, which may be provided e.g. at the storage controller or memory control unit 1320 in above configurations, or it may also be performed at the storage device control unit 1620 or any of storage device control units 1621 to 1623 above, depending exemplarily on the specific configuration of the data storage system.

For example, such embodiments may be applied preferably to storage systems in which a file server is connected to a storage controller (for parity management) and the storage controller may be connected to storage devices that include one or more solid state drives, solid state array devices or native flash arrays or the like, which typically have additional storage device control layers for managing a logical block address to physical block address mapping, e.g. to be controlled also in connection with block writing and erasing management, or level wearing management, as discussed already further above.

FIG. 11C exemplarily illustrates a process of defragmentation based on the relationship of file system management, parity management and storage device management of FIG. 11A in accordance with another exemplary embodiments.

In the exemplary embodiments of FIG. 11C, the block address swap is counter-balanced or even equalized by another corresponding swap in the logical-to-logical mapping of addresses at the parity management layers (e.g. here in the parity management information 4120).

For example, the file system management layer may inform the parity management layer on the swap of file system blocks FS LBA M and FS LBA N+3, or even instruct the parity management layer to execute a corresponding swap.

In return, when identifying based on the parity management information 4120 the corresponding storage management logical block addresses N/2+1 and [M−1]/2, the parity management layer may execute a corresponding swap of associated blocks.

Accordingly, in the present example embodiments of FIG. 11C, the parity management information 4120 is adjusted correspondingly by swapping the mapping of blocks, e.g. to swap storage management logical addresses [M−1]/2 and N/2+1 so that storage logical block address ST LBA N/2+1 is mapped to file system logical address FS LBA M and storage logical block address ST LBA [M−1]/2 is mapped to file system logical address FS LBA N+3. Accordingly, the mapping information of parity management information 4120 is swapped to counter-act the swapping of addresses in the file system management information 4110 at the file system management layer.

Accordingly, with the significant benefits that no actual data needs to be re-written (C1 remains to be stored at physical address PA N/2+1 and C1* remains to be stored at physical address PA [M−1]/2) and no parity needs to be re-calculated, the double-swapping (e.g. once at the file system management layer and once at the parity management layer) of associated logical block addresses allows to provide blocks C0, C1*, C2 and C3 of updated file C in sequential and de-fragmented blocks at the file system management layer in an efficient manner at low processing burden, thereby improving the further I/O processing performance due to light-weight defragmentation of the file system management layer in connection with data updates.

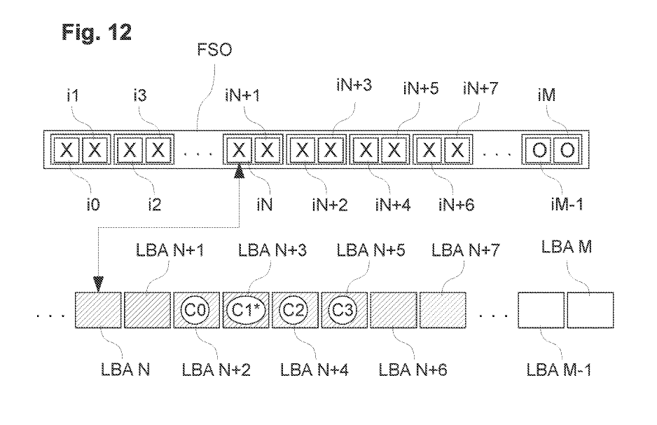

FIG. 12 exemplarily illustrates a free space object and logical block configuration based on the processes of FIGS. 11B and 11C at the file system management layer and according to the adjusted free space allocation information.

Due to the swapping of FS LBA M and FS LBA N+3 (here exemplarily after freeing the block having the old data C1), the updated file C containing data content C0, C1*, C2 and C3 is allocated to sequential logical blocks of FS LBAs N+2, N+3, N+4 and N+5, thereby also leading to sequential free blocks of LBAs M−1 and M (in contrast to the previous configuration of FIG. 8C).

Accordingly, the free space allocation information and logical block address configuration at the file system management layer can be efficiently be light-weight defragmented, although no actual data has been re-written in the storage devices/storage drives and no additional parity calculations needed to be performed, so that at comparatively low processing burden the I/O performance can be significantly improved, especially without actually re-writing data in a cumbersome defragmentation process according to the prior art.

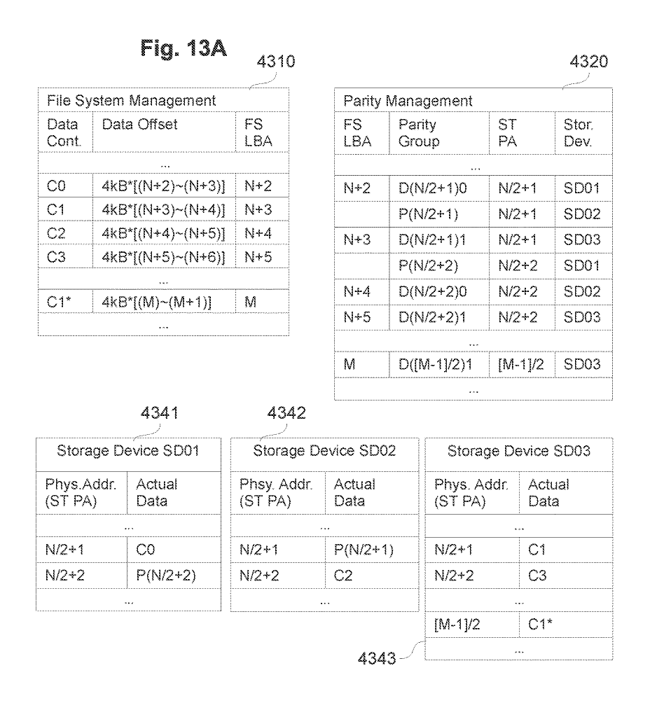

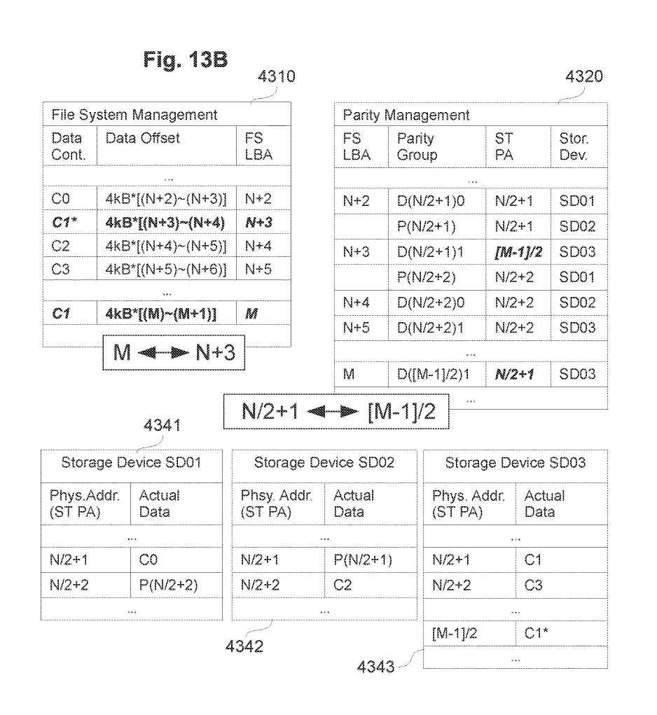

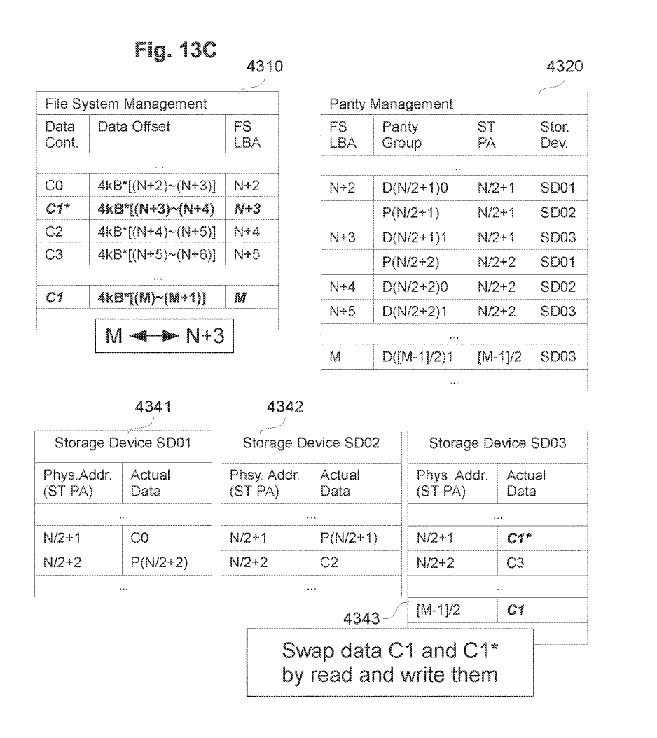

However, while the above embodiments of FIGS. 11A to 11C assumed that a logical-to-logical address mapping is provided at the parity management layer, and a logical-to-physical address mapping was provided at the storage management layer, the below embodiments of FIGS. 13A to 13C assume that the parity management layer provides a logical-to-physical address mapping, directly, such as could be implemented e.g. in case the storage devices/storage drives SD01 to SD03 are provided as magnetic hard disks or arrays of magnetic hard disks or the like.

Of course, it is to be noted that also it is further possible to provide embodiments having combinations of storage devices/storage drives, wherein a first group of storage drives/storage drives is managed according to FIGS. 11A, 11B, and/or 11C and a second group of storage drives/storage drives is managed according to FIGS. 13A, 13B, and/or 13C.

FIG. 13A exemplarily illustrates another relationship of file system management, parity management and storage device management.

At first, there is provided file system management information 4310 (similar to information 4110 above) as managed by a file system management layer of the data storage system (e.g. at the side of the file system servers 1200, 1200A and 1200B, in particular e.g. at the data movement and file system management portion 1230, the file system management unit 1231_2A and/or the file system module 1230B etc.). Also, the file system management information 4310 may be provided as a registered list in a memory or it may be provided and/or managed as a file system object.

The file system management information 4310 is indicative of the association between data content and the associated logical address of data blocks which store the respective data content at the abstract file system management layer. That is, exemplarily, the data C0 is indicated to be associated with the logical block address LBA N+2.

Further, the data C1 is indicated to be associated with the logical block address LBA N+3, the data C2 is indicated to be associated with the logical block address LBA N+4, the data C3 is indicated to be associated with the logical block address LBA N+5, and the data C1* is indicated to be associated with the logical block address LBA M (see also FIGS. 8A to 8C).

Exemplarily, the file system management data 4310 of FIG. 13A also indicates the Data Offset (exemplarily for a block size of 4 kB, which is only an exemplary number and may typically be any number of bytes or kBytes or more).

Then, there is exemplarily provided parity management information 4320 as managed by a storage system management layer of the data storage system (e.g. at the side of the file system servers 1200, 1200A and 1200B, in particular e.g. at the data movement and file system management portion 1230, the file system management unit 1231_2A and/or the file system module 1230B etc.; but also at the storage apparatus, e.g. at the storage controller or memory control unit 1320 above). Also, the parity management information 4320 may be provided as a registered list in a memory or it may be provided and/or managed as another file system object.

The parity management information 4320 indicates the parity grouping, e.g. in that the respective parity group stripe labeling is given, and the file system sided logical block addresses are mapped to the storage side physical blocks addresses. In addition, the parity management information 4320 indicates the storage devices/storage drives having the actual data associated with the respective physical addresses, and it indicates the respective file system side logical block addresses so as to provide a logical-to-physical address mapping information.

Exemplarily, associated with the data C0 of the file system management information 4310, the file system logic block address LBA N+1 is associated with the parity management data item D(N/2+1)0 (i.e. the data item that is grouped with the other item D(N/2+1)1 and used to calculate the associated parity P(N/2+1)) as indicated to be stored on storage device/storage drive SD01 at the physical address N/2+1. The parity P(N/2+1) is indicated to be stored at physical address N/2+1 of storage device/storage drive SD02, but no file system logical address is given/indicated as the parity data is not part of file system management but only of parity management at the parity management layer.

Further exemplarily, associated with the data C1 of the file system management information 4310, the file system logic block address LBA N+3 is associated with the parity management data item D(N/2+1)1 as indicated to be stored on storage device/storage drive SD03 at the physical address N/2+1, and associated with the data C1* (i.e. the updated data of the old data C1) of the file system management information 4310, the file system logic block address LBA M is associated with the parity management data item D([M−1]/2)1 as indicated to be stored on storage device/storage drive SD03 at the physical address [M−1]/2.

In accordance with the above, the storage configuration information 4341, 4342 and 4343 respectively indicates the data storage configuration on the respective storage devices/storage drives SD01, SD02 and SD03.

For example, the storage configuration information 4341 indicates that SD01 stores data C0 at the physical address N/2+1 and stores parity data P(N/2+2) at the physical address N/2+2, while the storage configuration information 4342 indicates that SD02 stores parity data P(N/2+1) at the physical address N/2+1 and stores data C2 at the physical address N/2+2. Finally, the storage configuration information 4343 indicates that SD03 stores data C1 at the physical address N/2+1, stores data C3 at the physical address N/2+2 and stores the data C1* at the physical address [M−1]/2.

FIG. 13B exemplarily illustrates a process of defragmentation based on the relationship of file system management, parity management and storage device management of FIG. 13A in accordance with some exemplary embodiments.

In the exemplary embodiments of FIG. 13B, the block address swap (performed at the file system management layer similar as discussed above for FIGS. 11A to 11C, see in particular the swap at that file system management information 4310 compared to file system management information 4110 above) is counter-balanced or even equalized by another corresponding swap in the logical-to-physical mapping of addresses at the parity management layers (e.g. here in the parity management information 4320).

For example, the file system management layer may inform the parity management layer on the swap of file system blocks FS LBA M and FS LBA N+3, or even instruct the parity management layer to execute a corresponding swap.

In return, when identifying based on the parity management information 4320 the corresponding storage physical block addresses N/2+1 and [M−1]/2, the parity management layer may execute a corresponding swap of associated physical block addresses.

Accordingly, in the present example embodiments of FIG. 13B, the parity management information 4320 is adjusted correspondingly by swapping the mapping of blocks, e.g. to swap physical addresses [M−1]/2 and N/2+1 so that storage physical address PA N/2+1 is mapped to file system logical address FS LBA M and storage physical address PA [M−1]/2 is mapped to file system logical address FS LBA N+3. Accordingly, the mapping information of parity management information 4320 is swapped to counter-act the swapping of addresses in the file system management information 4310 at the file system management layer.

Accordingly, with the significant benefits that no actual data needs to be re-written (C1 remains to be stored at physical address PA N/2+1 and C1* remains to be stored at physical address PA [M−1]/2) and no parity needs to be re-calculated, the double-swapping (e.g. once at the file system management layer and once at the parity management layer) of associated logical block addresses allows to provide blocks C0, C1*, C2 and C3 of updated file C in sequential and de-fragmented blocks at the file system management layer in an efficient manner at low processing burden, thereby improving the further I/O processing performance due to light-weight defragmentation of the file system management layer in connection with data updates.

FIG. 13C exemplarily illustrates a process of defragmentation based on the relationship of file system management, parity management and storage device management of FIG. 13A in accordance with another exemplary embodiments.

In the exemplary embodiments of FIG. 13C, the block address swap (performed at the file system management layer similar as discussed above for FIGS. 11A to 11C, see in particular the swap at that file system management information 4310 compared to file system management information 4110 above) is counter-balanced or even equalized by another corresponding swap, this time in the actual storage of the actual data, e.g. by reading C1 and C1* and writing C1* to physical address PA N/2+1 and writing C1 to physical address [M−1]/2.

For example, the file system management layer may inform the parity management layer on the swap of file system blocks FS LBA M and FS LBA N+3, or even instruct the parity management layer to execute a corresponding swap.

In return, when identifying based on the parity management information 4320 the corresponding storage physical block addresses N/2+1 and [M−1]/2, the parity management layer may execute a corresponding swap of the actual data at the storage device/storage drive SD03 by reading C1 and C1* and re-writing them to the swapped physical addresses.

Accordingly, with the benefits that no parity needs to be re-calculated, the double-swapping (e.g. once at the file system management layer and once of the actual data stored at the storage device) of associated logical block addresses allows to provide blocks C0, C1*, C2 and C3 of updated file C in sequential and de-fragmented blocks at the file system management layer in an efficient manner at low processing burden, thereby improving the further I/O processing performance due to light-weight defragmentation of the file system management layer in connection with data updates.

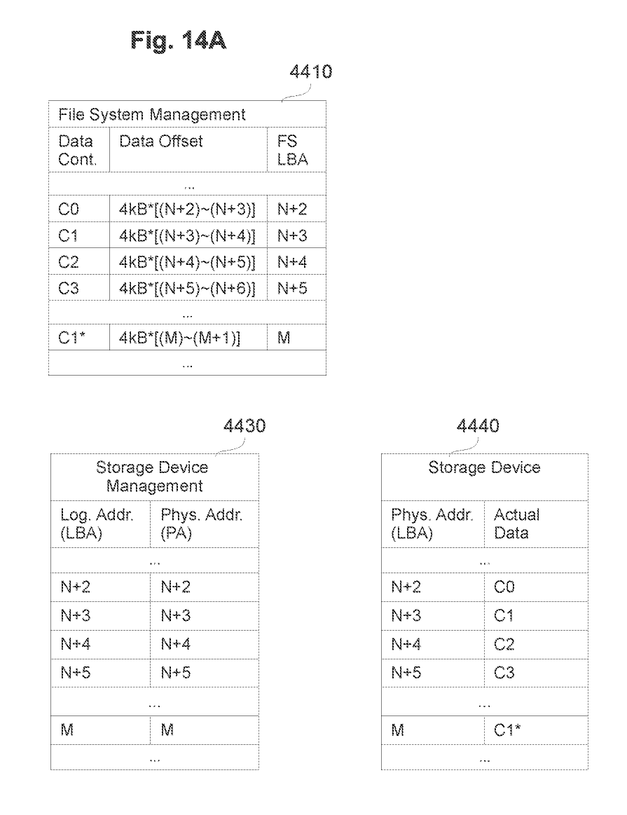

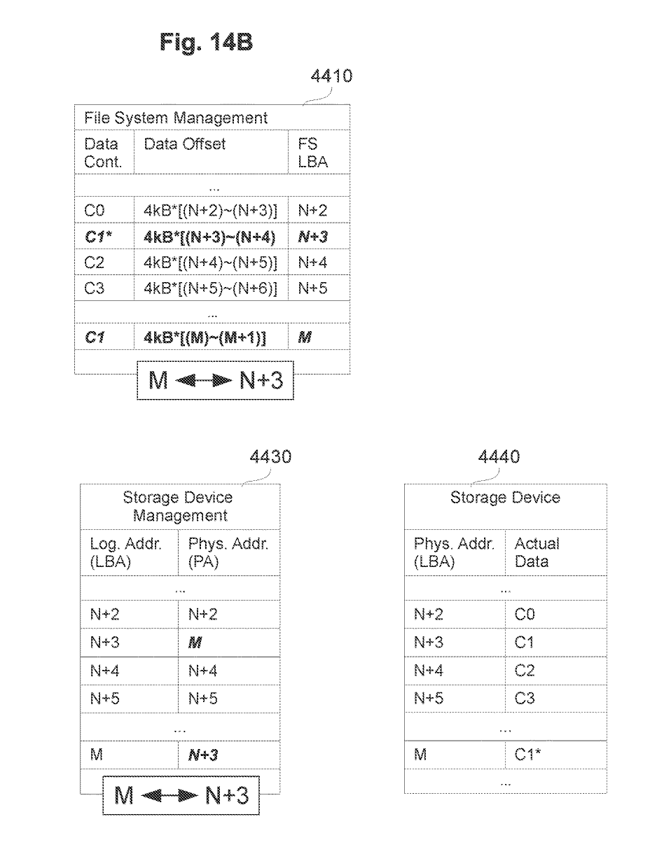

While the above embodiments of FIGS. 11A to 11C assumed that a logical-to-logical address mapping is provided at the parity management layer, and a logical-to-physical address mapping was provided at the storage management layer, the below embodiments of FIGS. 14A and 44B assume there is no parity management layer (e.g. without RAID configuration or in RAID configurations without parity such as RAID 0 and RAID 1, for example) and the file system management layer may be directly (or of course indirectly) be connected to a storage device management layer that provides a logical-to-physical address mapping management (without parity).

For example, such storage device management can be provided just as above, just without parity calculation, or in exemplary embodiments in which the storage device control units 1620 or any of units 1621, 1622, and 1623 may be directly connected to file servers 1200, 1200A or 1200B, for example, such as e.g. in configurations in which one or more flash/solid state drives or arrays are directly (or indirectly) connected to a file system server, and the storage device management is performed by control units which may also be responsible with write block management and erase block management, or such functions as e.g., level wearing etc. FIG. 14A exemplarily illustrates another relationship of file system management and storage device management.

At first, there is provided file system management information 4410 as managed by a file system management layer of the data storage system (e.g. at the side of the file system servers 1200, 1200A and 1200B, in particular e.g. at the data movement and file system management portion 1230, the file system management unit 1231_2A and/or the file system module 1230B etc.). Also, the file system management information 4410 may be provided as a registered list in a memory or it may be provided and/or managed as a file system object.

The file system management information 4410 is indicative of the association between data content and the associated logical address of data blocks which store the respective data content at the abstract file system management layer. That is, exemplarily, the data C0 is indicated to be associated with the logical block address LBA N+2.

Further, the data C1 is indicated to be associated with the logical block address LBA N+3, the data C2 is indicated to be associated with the logical block address LBA N+4, the data C3 is indicated to be associated with the logical block address LBA N+5, and the data C1* (which is the update data of the old data C1) is indicated to be associated with the logical block address LBA M (see also FIGS. 8A to 8C).

Exemplarily, the file system management data 4410 of FIG. 14A also indicates the Data Offset (exemplarily for a block size of 4 kB, which is only an exemplary number and may typically be any number of bytes or kBytes or more).

In addition to the file system management layer relating to the file system management information 4410, there is additionally provided storage device information 4430 associated with one or more storage devices/storage drives.

The storage device information 4430 is exemplarily provided to indicate a mapping between a (file system) logical addressing layer and a physical addressing layer, i.e. to map respective (file system management) logical block addresses to associated physical addresses where the data is actually stored/written.

For example, the storage device information 4130 indicates that the (file system management) logical block address LBA N+2 is mapped to (associated with) the physical address PA N+2 on the related storage devices/storage drives, logical block address LBA N+3 is mapped to (associated with) the physical address PA N+3 on the related storage devices/storage drives, logical block address LBA N+4 is mapped to (associated with) the physical address PA N+4 on the related storage devices/storage drives, logical block address LBA N+5 is mapped to (associated with) the physical address PA N+5 on the related storage devices/storage drives, and logical block address LBA M is mapped to (associated with) the physical address PA M on the related storage devices/storage drives.

In accordance with the above, the storage configuration information 4440 indicates the data storage configuration on the related storage devices/storage drives.

For example, the storage configuration information 4440 indicates that the related storage devices/storage drives store the data C0 at the physical address N+2, store the data C1 at the physical address N+3, store the data C2 at the physical address N+4, store the data C3 at the physical address N+5, and store the data C1* at the physical address M.

FIG. 14B exemplarily illustrates a process of defragmentation based on the relationship of file system management and storage device management of FIG. 14A in accordance with exemplary embodiments.

In the exemplary embodiments of FIG. 14B, the block address swap at the file system management layer (executed e.g. as in embodiments discussed above) is counter-balanced or even equalized by another corresponding swap in the logical-to-physical mapping of addresses at the storage device management layers (e.g. here in the storage management information 4430).

For example, the file system management layer may inform the storage device management layer on the swap of file system blocks FS LBA M and FS LBA N+3, or even instruct the storage device management layer to execute a corresponding swap.

In return, when identifying based on the storage device management information 4430 that the corresponding data of file system blocks LBA M and LBA N+3 are respectively stored to physical addresses PA M and PA N+3, the storage device management layer may execute a corresponding swap of associated blocks in the mapping information.

Accordingly, in the present example embodiments of FIG. 14B, the storage management information 4430 is adjusted correspondingly by swapping the mapping of blocks, e.g. to swap physical addresses PA M and PA N+3 (or alternatively the logical addresses LBA M and LBA N+3) so that file system logical block address LBA N+3 is mapped to physical address PA M and file system logical block address LBA M is mapped to physical address PA N+3. Accordingly, the mapping information of storage management information 4430 is swapped to counter-act the swapping of addresses in the file system management information 4410 at the file system management layer.

Accordingly, with the significant benefits that no actual data needs to be re-written (C1 remains to be stored at physical address PA N+3 and C1* remains to be stored at physical address PA M), the double-swapping (e.g. once at the file system management layer and once at the storage management layer) of associated blocks allows to provide blocks C0, C1*, C2 and C3 of updated file C in sequential and de-fragmented blocks at the file system management layer in an efficient manner at low processing burden, thereby improving the further I/O processing performance due to light-weight defragmentation of the file system management layer in connection with data updates.

Here, it is to be noted that the map swapping is performed at the storage management layer, which may be provided e.g. at the storage controller or memory control unit 1320 in above configurations, or it may also be performed at the storage device control unit 1620 or any of storage device control units 1621 to 1623 above, depending exemplarily on the specific configuration of the data storage system.

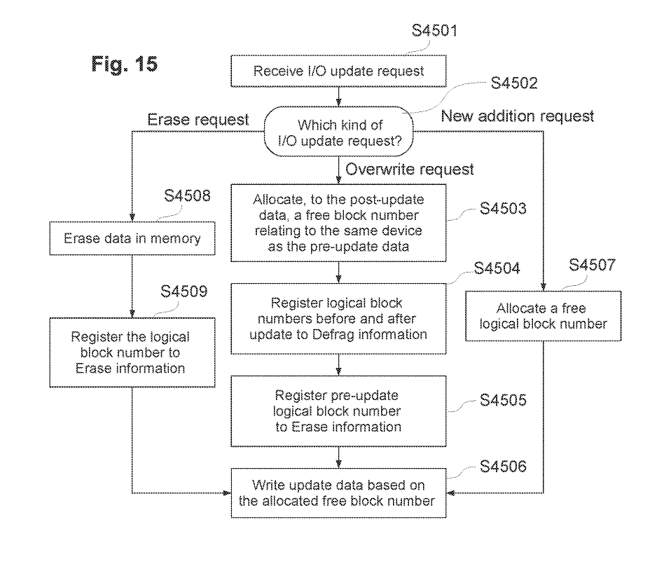

FIG. 15 is an exemplary flow chart of a process of I/O update request processing in accordance with some exemplary embodiments (which may be applied to each one or a combination of more of the above described embodiments).

In step S4501, an I/O update request is received at the file system management layer (e.g. at the side of the file system servers 1200, 1200A and 1200B, in particular e.g. at the data movement and file system management portion 1230, the file system management unit 1231_2A and/or the file system module 1230B) from one of the connected host computers (clients), for example, and in step S4502 it is determined whether the received I/O update request is either a new addition request (e.g. a write request that writes new data, such as a new file or portions of a new file, or additional data to be added to data of a previous file), an erase request (e.g. a request to delete a file or portions of a file), or an overwrite request (e.g. a write request which replaces one or more portions of an existing file or existing old data with new data to overwrite the old data, e.g. by writing C1* instead of old data C1 as discussed in the above).

If the request is determined to be a new addition request in step S4502, the file system management is adapted to process the free space object/free space allocation information as discussed above by means of the allocation cursor movement, to identify and allocate the next free block(s) at the logical file system management layer to the one or more blocks of data of the new addition request, and writes (or instructs writing by the storage management layer) the data of the new addition request to the allocated blocks according to the logical block addresses (e.g. the allocated block numbers) in step S4506.

If the request is determined to be an overwrite request in step S4502, the file system management is adapted to process the free space object/free space allocation information as discussed above by means of the allocation cursor movement, to identify and allocate the next free block(s) at the logical file system management layer to the one or more blocks of data of the overwrite request (i.e. to currently unallocated blocks, e.g. such as e.g. allocating C1* in the above to block LBA M) under the preferred condition that the block is allocated so as to store the data to the same storage device/storage drive as the old pre-update data (e.g. such as storing the post-update data content C1* to the same storage device/storage drive SD03 as already stores the related pre-update data C1). That is, the file system management is adapted to allocate a next free block (or next free blocks) for the post-update data to a free block number/logical block address relating to the same device/drive as stores the pre-update data, in step S4503.

In addition, the file system management layer is adapted in step S4504 to register the logical block address(es) (e.g. block number(s)) allocated to the post-update data block(s) and the logical block address(es) (e.g. block number(s)) allocated to the pre-update data block(s) to a stored defragmentation information (examples thereof being described further below). Accordingly, the file system management layer is adapted to create/update defragmentation information which associates one or more pairs of blocks, block numbers or logical block addresses to be swapped. That is, each of a plurality of pairs of blocks, block numbers or logical block addresses relates to one (or more) block(s) of pre-update data and one or more block(s) of corresponding post-update data to be swapped (or moved).

Also, optionally, if the block(s) related to the pre-update data may be freed, the file system management layer may optionally be adapted in step S4505 to register the block information (block number and/or logical block address) of the related pre-update data to erase information (which may be a list, table, register or file system object indicating blocks that can be freed in a next block freeing processing, e.g. at a next checkpoint or the like, or if no pointers exist anymore to such block(s)).

Furthermore, the file system management layer is adapted to write (or instruct writing by the storage management layer) the data of the overwrite request to the allocated blocks according to the logical block addresses (e.g. the allocated block numbers) in step S4506.

On the other hand, if the request is determined to be an erase request in step S4502 (e.g. a request to delete data content of one or more used blocks), the file system management layer is adapted to erase (and/or instruct deletion) the respective data in the cache, memory and/or storage in step S4508, and in step S4509 to register the block information (block number and/or logical block address) of the related data of the erase request to the erase information (which may be a list, table, register or file system object indicating blocks that can be freed in a next block freeing processing, e.g. at a next checkpoint or the like, or if no pointers exist anymore to such block(s)).

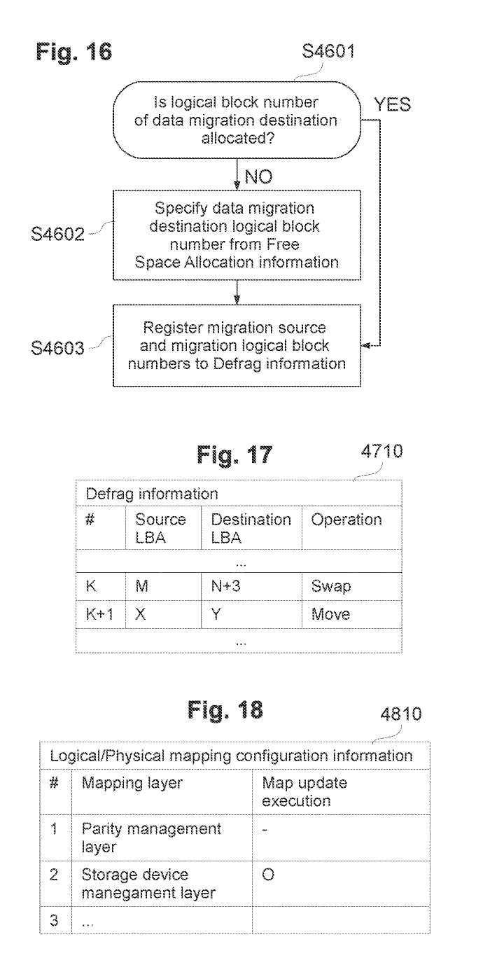

FIG. 16 is an exemplary flow chart of a process of defragmentation information processing in accordance with some exemplary embodiments (which may relate to step S4504 above in some embodiments).

In step S4601, in connection with one (or more) update data block(s) to be swapped or moved at the file system management layer (e.g. relating to one or more newly written update data blocks of an overwrite request or new addition request), the file system management layer is adapted to analyze and/or process the free space object/free space allocation information, to determine whether a destination logical block address is allocated (used) or not (e.g. when writing the data C1*, it is determined whether the logical block address of associated post-update data C1 is allocated/used or not, e.g. in case it has been previously freed already it would not be allocated anymore), step S4601.

If the step S4601 returns YES, the file system management layer is adapted to determine based on the free space object/free space allocation information the logical block address/block number of the one or more destination blocks, and to register the logical addresses of the source and destination blocks to be swapped to the defragmentation information (defragmentation management information) in step S4603.

On the other hand, if step S4601 returns NO (e.g. the corresponding data has been freed already and is not allocated anymore, such as e.g. in FIG. 8C in which the block of previous data C1 had be freed already exemplarily), the file system management layer is adapted to (re-)allocate the respective one or more destination blocks in step S4602 before registering the logical addresses of the source and destination blocks to be swapped to the defragmentation information (defragmentation management information) in step S4603.

FIG. 17 exemplarily illustrates an example of defragmentation management information 4710 in accordance with some exemplary embodiments. For example, in an exemplary list or table (or in a corresponding defragmentation information file system object), in an exemplary row No. K, the blocks LBA M and LBA N+3 are registered to be swapped (according to the examples of swapping the LBAs of C1 and C1* in embodiments above, at the file system management layer, and with one corresponding counter-acting swap at a lower layer to be determined according to specific embodiments such as the various embodiments above).

That is, in some embodiments, the defragmentation management information 4710 indicates the blocks to be swapped (or moved), in particular exemplarily as a Source LBA (exemplarily corresponding to the LBA of the newly written post-update data such as e.g. C1*) and as a Destination LBA (exemplarily corresponding to the LBA of the related pre-update data such as e.g. C1), to indicate that Source LBA and Destination LBA shall be swapped (or moved).

Specifically, in some embodiments such as in FIG. 17, the defragmentation management information may also indicate whether a swap operation or a move operation shall be applied (where a swap needs to actually swap the two indicated LBAs, and move means that the Source LBA shall be moved to the Destination LBA, e.g. by direct swapping or indirectly by other operations involving one or more other move operations and/or one or more other swap operations, e.g. moving LBA 1 to LBA 2, moving LBA 2 to LBA 3, and moving LBA 3 to LBA1, etc.).

That is, while the swap/move operations of modifying mapping between logical-to-logical address mappings and/or logical-to-physical address mappings may be performed synchronously with the write request/overwrite requests, in some preferred embodiments, the plural defragmentation operations (including one or more block-swaps and/or one or more block-moves as discussed above) may be executed asynchronously by synchronously (or asynchronously) updating the defragmentation management information e.g. as discussed above, and asynchronously processing the defragmentation management information to execute the one or more outstanding defragmentation operations (including one or more block-swaps and/or one or more block-moves as discussed above) according to the or based on the defragmentation management information.

For example, such asynchronous defragmentation may be executed regularly or periodically, e.g. according to time or frequency management settings as may be set by a management computer 1500 or the like, or upon manual instruction via the management computer 1500 or the like, e.g. when a decrease of I/O performance is determined but actual defragmentation processes including shifting of actual data and parity re-calculations shall still be avoided, or the like.

Also, it is possible to conceive that file systems which automatically, periodically, regularly or upon manual instruction create checkpoints or checkpoint versions of the current file system (sometimes referred to as snapshots, not to be confused with snapshot objects as discussed further above) to obtain (non-modifiable) images of the file system at certain points in time, it is possible to synchronize the defragmentation processing or processing of the defragmentation management information based on the timing of taking file system checkpoints, e.g. after a new checkpoint number has been issued. This may be specifically advantageous in embodiments in which issuing a new checkpoint involves freeing of old blocks that have been released (e.g. added to erase information) in a previous checkpoint, because such freeing of block may lead to defragmented situations in which the defragmentation operations may be particularly beneficial.

FIG. 18 exemplarily illustrates an example of logical/physical mapping configuration information 4810 in accordance with some exemplary embodiments.

Exemplarily, the logical/physical mapping configuration information 4810 may indicate whether there exists a logical/physical mapping (or logical-to-logical mapping layer), and if there is such layer, the logical/physical mapping configuration information 4810 may further indicate whether the map update (i.e. the counter-balancing swap/move as discussed above for various embodiments at different layers) is to be performed at the particular layer.

For example, the example of logical/physical mapping configuration information 4810 of FIG. 18 indicates that the parity management layer exists which includes an address mapping layer, and that a storage device management layer exists which includes an address mapping layer, wherein the storage device management layer is indicated to execute the map update. That is, according to the example of logical/physical mapping configuration information 4810 of FIG. 18, the swap may be executed similar to FIG. 11B above, in which (logical-to-logical) address mapping exists at the parity management layer in the parity management information 4120 and another (logical-to-physical) address mapping exists at the storage device management layer in the storage management information 4131 to 4133, wherein the counter-balancing/equalizing block swap is performed at the storage device management layer. Of course, it may be possible in some embodiments that the logical/physical mapping configuration information 4810 can be set/adjusted/modified by a user via the management computer 1500, for example.

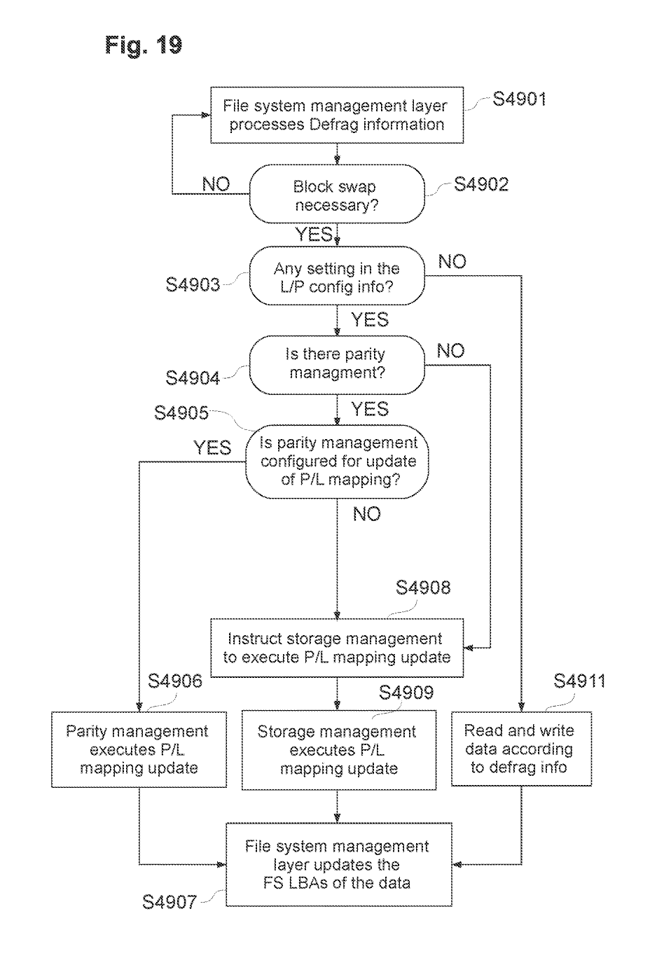

FIG. 19 is an exemplary flow chart of a process of defragmentation processing in accordance with some exemplary embodiments.

In step S4901, the file system management layer processes the defragmentation management information, to swap or move blocks/block numbers/logical block addresses at the file system management layer, e.g. as discussed above in plural embodiments in connection with file system management information 4110, 4310 and/or 4410 etc.

Then, in step S4902, while processing the defragmentation management information, the file system management layer is adapted to determine whether a block swap (or one or more block moves) are necessary, and continues processing until the defragmentation information is completely processed, and if it is determined that a block swap (or one or more block moves) are necessary, step S4902 returns YES, the file system management layer is adapted to process or analyze the logical/physical mapping configuration information 4810 or the like.

For example, it may be determined in step S4903 whether there is any setting in the logical/physical mapping configuration information 4810 (referred to as “L/P config info” in FIG. 19). If step S4903 returns NO, this means that there may be no (additional) layer of address mapping, which means that no parity management and no intermediate storage device management may exist, and the address mapping information of the file system management layer may directly map to physical addresses and the file system management layer shall read and write (or instruct to read and write) the data according to the defragmentation information (e.g. by reading C1 and C1* and actually writing C1 and C1* to the respective swapped physical addresses) in step S4911 (similar e.g. to FIG. 13C above).

If step S4903 returns YES, it is determined whether there exists a parity management layer in step S4904, e.g. based on the logical/physical mapping configuration information 4810 or other configuration information. If step S4904 returns YES, it is determined based on the logical/physical mapping configuration information 4810 whether the parity management layer shall execute the address mapping update (including one or more address swap operations and/or move operations) in step S4905.

If step S4905 returns YES, the parity management layer continues with step S4906 of executing the corresponding address mapping update (including one or more address swap operations and/or move operations (e.g. such as in FIGS. 11C and/or 13B) based on the defragmentation management information or defragmentation management instruction received from the file system management layer at the parity management layer, and the file system management layer continues to execute the corresponding address mapping update (including one or more address swap operations and/or move operations) at the file system management layer in step S4907 (e.g. such as in FIGS. 11C and/or 13B), which may be executed before, after or at the same time as step S4906.

On the other hand, if step S4905 returns NO, the parity management layer continues with step S4908 of instructing or initiating a corresponding address mapping update (including one or more address swap operations and/or move operations) based on the defragmentation management information or defragmentation management instruction received from the file system management layer at the parity management layer, e.g. by transmitting (translated) defragmentation management information or a (translated) defragmentation management instruction to the storage management layer.

Then, in step S4909, the storage management layer continues with executing a corresponding address mapping update (including one or more address swap operations and/or move operations) based on the defragmentation management information or defragmentation management instruction received from the parity management layer at the storage management layer (e.g. such as in FIG. 11B).

The file system management layer continues to execute the corresponding address mapping update (including one or more address swap operations and/or move operations at the file system management layer in step S4907 (e.g. such as in FIG. 11B), which may be executed before, after or at the same time as step S4909.

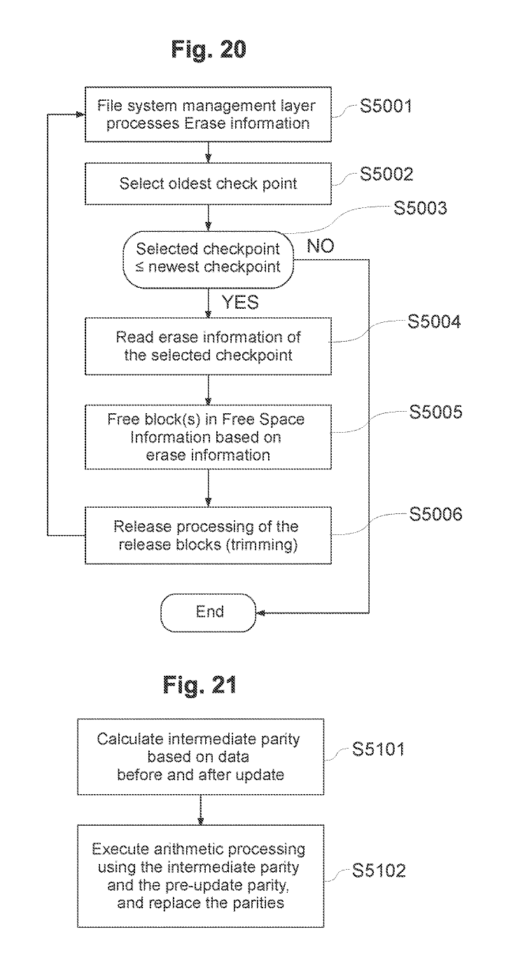

FIG. 20 is an exemplary flow chart of a process of erase information processing in accordance with some exemplary embodiments.

In step S5001, the file system management layer may be adapted to process erase information which indicates one or more logical blocks (logical address blocks, or logical block numbers, preferable) to be erased (e.g. based on erase requests as discussed in connection with FIG. 15).

In step S5002, the file system management layer selects the oldest (still preserved) checkpoint (e.g. when releasing this oldest checkpoint to issue a new checkpoint in a system that retains a specified number of checkpoints, or the like).

Unless the selected oldest checkpoint is equal to the current/newest checkpoint (step S5003 would give NO and the process would end), step S5003 gives YES, and the file system management layer is configured to process and read the erase information related with the selected checkpoint in step S5004.

The blocks of the selected checkpoint in the erase information (or in other embodiments potentially the blocks as indicated in the erase information of the selected checkpoint, e.g. if the erase information is managed as a file system object), can be freed in step S5005 to update the free space object/free space allocation information, e.g. such that the respective blocks will thereafter be indicated to be free in the free space object/free space allocation information.

In step S5006, the respective data of the freed blocks is further released e.g. by executing a release processing of the release blocks (e.g. trimming of the data or indicating trimming in metadata associated with the data etc.).

FIG. 21 is an exemplary flow chart of a process of parity processing in accordance with some exemplary embodiments.

In step S5101, the parity management layer is adapted to calculate intermediate parities based on pre-update data and post-update data. As mentioned above, the potential parity calculations may include calculating a new parity based on old data, new data and old parity (specifically as new parity=old parity XOR new data XOR old data), wherein the pre-calculation of the intermediate parity (“new data XOR old data” or “pre-update data XOR post-update data”) may make the parity calculations more efficient when needed, as the intermediate parity is pre-calculated and the calculation of new parity only involves the step of calculating the new parity based on the pre-calculated intermediate parity and the old parity (i.e. new parity=pre-calculated intermediate parity XOR old parity).

Then, in step S5102, if needed later, the parity management layer can exemplarily execute arithmetic processing to calculate a new parity using the pre-calculated intermediate parity and the pre-update parity (i.e. old parity) to replace the old parity.

For example, in the above examples, the data C0 was in a parity management group with pre-update data C1 being associated with parity P(N/2+1). Now, if at updating the post-update data C1*, the parity management layer may pre-calculate the intermediate parity IntP=C1 XOR C1*, and later if the data C0 and post-update data shall be included in one parity management group e.g. in another defragmentation process, the new parity can simply be calculated in one step as new parity Pnew=old parity P(N/2+1) XOR intermediate parity IntP, which makes later rearrangements in the parity management more efficient due to the use of pre-calculated intermediate parities.

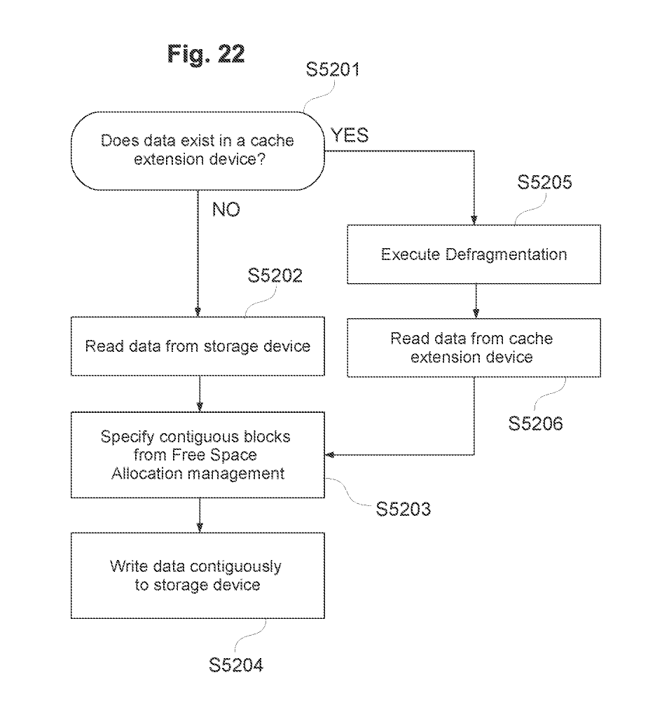

FIG. 22 is an exemplary flow chart of a process of I/O update processing in data storage systems having a cache extension device (e.g. based on Flash-based or solid state drive based technology) in accordance with some exemplary embodiments.

The underlying idea is that defragmentation can be performed similar to one or more of the above embodiments on data that is currently stored in the cache storage/cache memory of the cache extension device, and then storage blocks are written contiguously to the physical addresses of the storage devices (such as e.g. magnetic hard disc devices or also Flash-based or solid state drive based technology) in accordance with the non-fragmented logical block addressing at the file system management layer.

For example, in a potential defragmentation process, in step S5201, it is determined whether data exists in the memory/storage of the cache extension device.

If step S5202 returns NO, data can be read from the storage device step S5202 (e.g. related to fragmented areas) to be able to specify contiguous blocks from the free space object/free space allocation information in step S5203 and to write the data contiguously to the storage device in step S5204 (e.g. by regular defragmentation or by a method similar to FIG. 13C).

However, if the step S5201 returns YES, the method continues with executing the light-weight defragmentation e.g. according to any of the above embodiments, and in particular by address swapping/address moving at the file system management layer, and by performing one counter-balancing/equalizing mapping update in any potential logical-to-logical address map layer or logical-to-physical address map layer, which may exist between the file server management and the physical storage layer of the cache extension apparatus, in step S5205. Then, with the data can be read as contiguous data from the cache extension apparatus in step S5206 to be able to then specify contiguous blocks from the free space object/free space allocation information in step S5203 and to write the data contiguously to the storage device in step S5204.

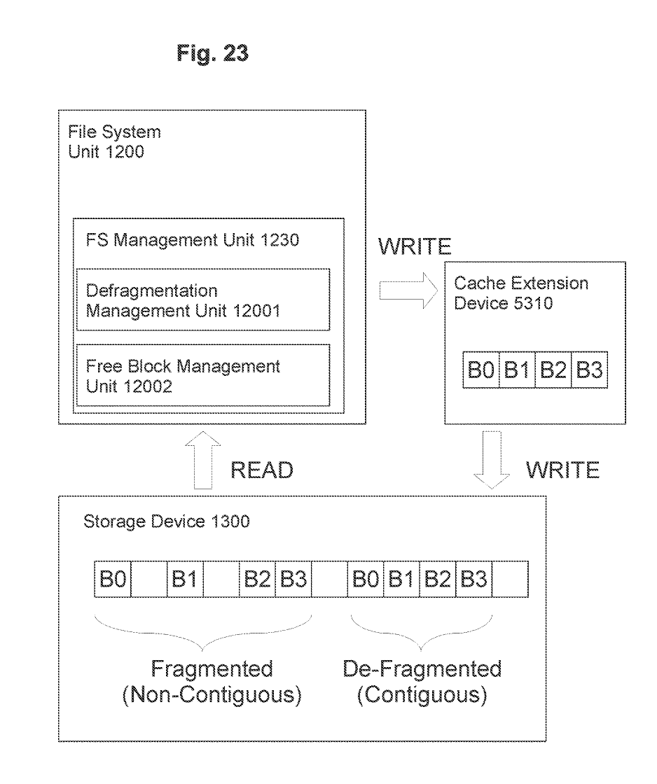

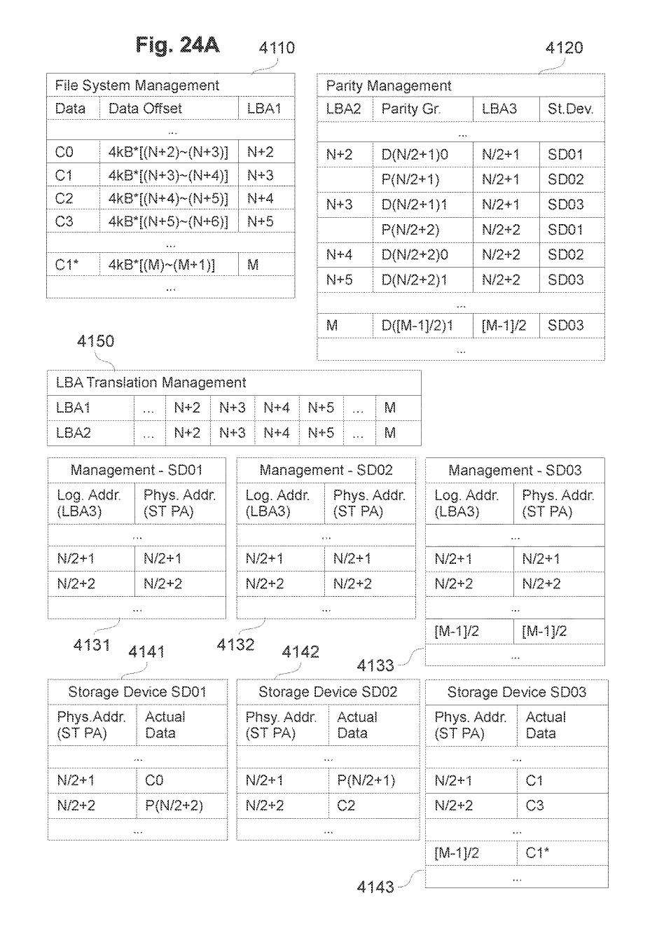

FIG. 23 exemplarily illustrates I/O update processing in a data storage system having a cache extension device 5310 in accordance with some exemplary embodiments.

In analogy to above embodiments the data storage system includes the file system unit 1200 (e.g. a file system server 1200, 1200A or 1200B as discussed above) connected (directly or indirectly) to a storage device 1300 (or array or system of plural storage devices). In addition, the system includes the cache extension device 5310. Exemplarily, it is shown that the file system management unit 1230 may include a defragmentation management unit 12001 and a free space/free block management unit 12002.

Exemplarily, the storage device 1300 stores data B0 to B3 in a non-contiguous fragmented manner, as illustrated on the left-hand side in the storage device 1300. The file system unit 1200 may read the data of blocks Bo to B3 from the storage device 1300 and write them into the cache extension device 5310 (e.g. deliberately for performing defragmentation, or in connection with user requests from connected host computers), and some or all of the data content of blocks Bo to B3 may be stored in the cache extension device.

Then, based on one or more of the above embodiments, the swapping of file system management may be used to defragment the blocks stored in the cache extension device 5310, and when the data of blocks Bo to B3 is stored in a non-fragmented manner in the cache extension device 5310 (on a logical mapping layer level), the data of blocks Bo to B3 can be again stored to the storage device 1300, now in a contiguous region of non-fragmented sequential free blocks as identified by the free block management unit 12002, as illustrated on the right-hand side in the storage device 1300, and the initial storage region of blocks Bo to B3 may be freed to provide a non-fragmented area of storage.

FIG. 24A exemplarily illustrates a relationship of file system management, LBA translation management, parity management and storage device management in accordance with some exemplary embodiments. Basically, the configuration of FIG. 24A is similar to the configuration of FIG. 11A above. However, in addition to the file system management information 4110 at the file system management layer and the parity management information 4120 at the parity management layer, there is additionally provided LBA translation management information 4150, which may in some preferred embodiments be provided also at the file system management layer (e.g. at a file server processing section, as e.g. explained above).

Exemplarily, the LBA translation management information 4150 provides another logical-to-logical block address mapping layer which maps logical block addresses LBA1, as used at the file system management layer, to another set of logical block addresses LBA2, as exemplarily used at the parity management layer.

The parity management information 4120 then provides another logical-to-logical block address mapping layer which maps logical block addresses LBA2, as used at the parity management layer, to another set of logical block addresses LBA3, as exemplarily used at the storage device management layer (e.g. such as the addresses ST LBA mentioned above). The storage management information 4131, 4132 and 4132 provides a logical-to-physical block address mapping layer which maps logical block addresses LBA3, as used at the storage device management layer, to another set of physical block addresses ST PA.

In other exemplary embodiments, such additional logical-to-logical mapping by LBA translation information may additionally or alternatively be provided also between the parity management layer and the storage management layer, instead of between the logical addresses of file system management layer and parity management layer as in FIG. 24A. Also, such LBA translation information as an additional logical-to-logical address mapping layer may be provided in any of the FIGS. 11A to 11C, 13A to 13C, and also in FIGS. 14A to 14B (e.g. as an additional logical-to-logical address mapping layer between file system management and storage device management, e.g. in case no parity computing section or parity management layer is provided).

FIG. 24B exemplarily illustrates a process of defragmentation based on the relationship of file system management, LBA translation management, parity management and storage device management of FIG. 24A in accordance with some exemplary embodiments.

In contrast to FIG. 11B, for example, in the embodiments of FIG. 24B, if a swap between logical block addresses shall be performed, e.g. for swapping the block addresses of data C1 and update data C1* for defragmentation purposes, the swap is not performed in the file system management information 4110 but in the additionally provided LBA translation management information 4150, which in FIG. 24B exemplarily swaps the logical block addresses LBA2 M with LBA2 N+3. No swap is performed at the parity management information 4120. However, exemplarily, the data offset of data C1 and C1* is updated in the file system management information 4110, wherein logical block addresses LBA1 of the file system management layer are not swapped or otherwise adjusted.

That is, as previously discussed, the data C1* represents the update data of previous data C1 of file C, wherein the old file C was represented by data C0, C1, C2 and C3, while the newly updated file is represented by data C0, C1*, C2 and C3, which was not sequentially distributed among the logical data block addresses on the file system management side and in the free space object/free space allocation information (cf. FIGS. 8C and 8D above).

According to some exemplary embodiments, the file system management layer (i.e. e.g. at the side of the file system servers 1200, 1200A and 1200B, in particular e.g. at the data movement and file system management portion 1230, the file system management unit 1231_2A and/or the file system module 1230B etc.) is configured to execute or instruct a swap operation of swapping data blocks in the logical-to-logical block address mapping layer, as indicated e.g. in connection with LBA translation management information 4150 in FIG. 24B.

Exemplarily, for data C1* being the corresponding update data to update the old data C1, the file system management layer is configured to instruct swapping logical block addressing of the logical block of data C1* with the logical block addressing of the logical block of data C1, e.g. by indicating that data C1* is associated with LBA2 N+3 (instead of LBA2 M as previously before the swap operation) and by indicating that data C1 is associated with LBA2 M (instead of LBA2 N+3 as previously before the swap operation) in the LBA translation management information 4150.

However, in order to provide a still correct logical to physical mapping, the file system management layer is further configured to inform the parity management layer and/or the storage device layer about the logical block address swap, or even to instruct the parity management layer and/or the storage device layer to execute a corresponding address swap, as discussed in some examples in the above.

For example in the exemplary embodiments of FIG. 24B, the block address swap is counter-balanced or even equalized by another corresponding swap in the logical-to-physical mapping of addresses at the storage management layers (e.g. here in the storage management information 4133).

For example, the file system management layer may inform the parity management layer on the swap of file system blocks M and N+3, or even instruct the parity management layer to execute a corresponding swap.

In return, when identifying based on the parity management information 4120 or the swapped LBA translation management information 4150 that the corresponding data of file system blocks M and N+3 is stored on SD03, the parity management layer may inform or even instruct the storage management layer to execute a corresponding swap of associated blocks.

Accordingly, in the present example embodiments of FIG. 24B, the storage management information 4133 is adjusted correspondingly by swapping the mapping of blocks, e.g. to swap physical addresses [M−1]/2 and N/2+1 (or alternatively the logical addresses [M−1]/2 and N/2+1) so that storage logical block address LBA N/2+1 is mapped to physical address [M−1]/2 and storage logical block address LBA [M−1]/2 is mapped to physical address N/2+1.

Accordingly, the mapping information of storage management information 4133 is swapped to counter-act the swapping of addresses in the LBA translation management information 4150.

Accordingly, with the significant benefits that no actual data needs to be re-written (C1 remains to be stored at physical address PA N/2+1 and C1* remains to be stored at physical address PA [M−1]/2) and no parity needs to be re-calculated, the double-swapping (e.g. once at the logical-to-logical address mapping layer and once at the storage management layer) of associated blocks allows to provide blocks C0, C1*, C2 and C3 of updated file C in sequential and de-fragmented blocks in an efficient manner at low processing burden, thereby improving the further I/O processing performance due to light-weight defragmentation of the file system management layer in connection with data updates.

Here, in connection with above FIG. 24B, it is to be noted that the map swapping is performed at the files system management layer or at the storage management layer, which may be provided e.g. at the storage controller or memory control unit 1320 in above configurations, or it may also be performed at the storage device control unit 1620 or any of storage device control units 1621 to 1623 above, depending exemplarily on the specific configuration of the data storage system.

For example, such embodiments may be applied preferably to storage systems in which a file server is connected to a storage controller (for parity management) and the storage controller may be connected to storage devices that include one or more solid state drives, solid state array devices or native flash arrays or the like, which typically have additional storage device control layers for managing a logical block address to physical block address mapping, e.g. to be controlled also in connection with block writing and erasing management, or level wearing management, as discussed already further above.

In the above example of FIGS. 24A and 24B, when receiving I/O requests, the file system management layer is preferably configured to process, analyze, decode or execute such I/O requests by referring to and/or by accessing the logical block addresses LBA2 in the LBA translation management information 4150.

In the following description, configurations, aspects and features of implementations and background information on exemplary data storage systems and aspects thereof are described, wherein above aspects, features and embodiments may be applied to, embodied in or implemented together with configurations, aspects and features of implementations and background information as described below.

FIG. 25 is a logical block diagram of an exemplary embodiment of a file server to which various aspects and embodiments are applicable.

A file server of this type is described in U.S. Pat. No. 7,457,822, entitled “Apparatus and Method for Hardware-based File System” which is incorporated herein by reference and PCT application publication number WO 01/28179 A2, published Apr. 19, 2001, entitled “Apparatus and Method for Hardware Implementation or Acceleration of Operating System Functions” which is incorporated herein by reference. A file server 12 of FIG. 25 herein exemplarily has components that include a service module 13, in communication with a network 11. The service module 13 receives and responds to service requests over the network, and is in communication with a file system module 14, which translates service requests pertinent to storage access into a format appropriate for the pertinent file system protocol (and it translates from such format to generate responses to such requests). The file system module 14, in turn, is in communication with a storage module 15, which converts the output of the file system module 14 into a format permitting access to a storage system with which the storage module 15 is in communication. The storage module has a sector cache for file content data that is being read from and written to storage. Further, each of the various modules may be hardware implemented or hardware accelerated.

In exemplary implementations, the service module 13, file system module 14, and storage module 15 of FIG. 25 may be implemented by a network interface board 21, a file system board 22, and a storage interface board 23 respectively. For example, the storage interface board 23 is in communication with storage device 24, constituting the storage system for use with the embodiment. Further details concerning this implementation are set forth in U.S. application Ser. No. 09/879,798, filed Jun. 12, 2001, entitled “Apparatus and Method for Hardware Implementation or Acceleration of Operating System Functions”, which is incorporated herein by reference.

However, in alternative exemplary implementations, the service module 13, file system module 14, and storage module 15 of FIG. 25 can be implemented integrally on a singular board such as a board having a single field programmable array chip (FPGA). In yet another alternative implementation, the network interface board 21 can be configured on a first board which is separate from the file system board 22 and storage interface board 23 which are configured together on a second board. It should be noted that the present invention is in no way limited to these specific board configurations or any particular number of boards.

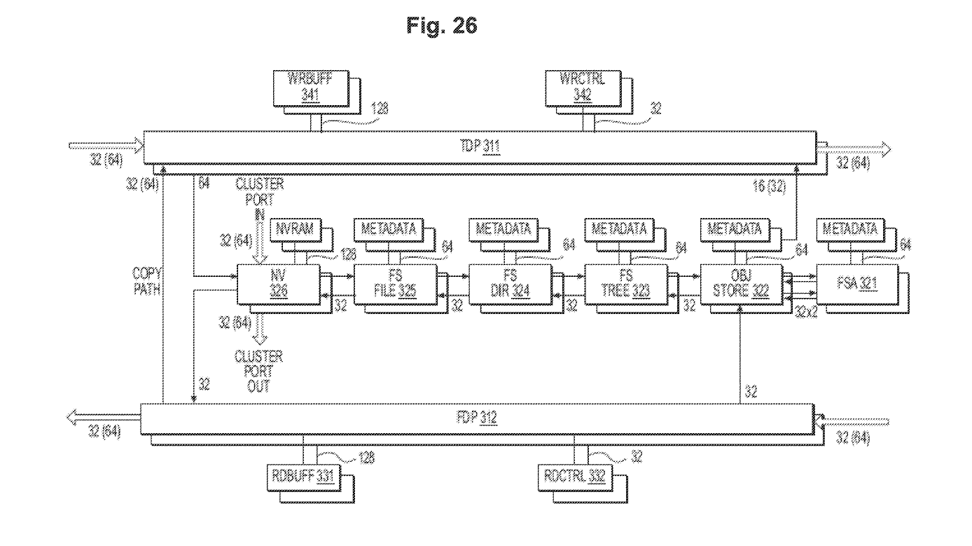

FIG. 26 is an exemplary block diagram of an embodiment of a file system module. The file system module embodiment may be used in systems of the type described in FIG. 25 and/or in system implementations according to FIGS. 2 to 3B.

Exemplary bus widths for various interfaces are shown, although it should be noted that the present invention is in no way limited to these bus widths or to any particular bus widths.

The data is shown by upper bus 311, which is labeled TDP, for To Disk Protocol, and by lower bus 312, which is labeled FDP, for From Disk Protocol, such Protocols referring generally to communication with the storage module 15 of FIG. 25 as may be implemented, for example, by storage interface board 23. The file system module always uses a control path that is distinct from the data buses 311 and 312, and in this control path uses pointers to data that is transported over the buses 311 and 312. The buses 311 and 312 are provided with a write buffer WRBUFF and read buffer RDBUFF respectively. For back up purposes, such as onto magnetic tape, there is provided a direct data path, identified in the left portion of the drawing as COPY PATH, from bus 312 to bus 311, between the two buffers.

A storage module 15 according to exemplary embodiments may be configured by a storage part configured from a plurality of hard disk drives, and a control unit for controlling the hard disk drives (otherwise referred to as a disk) of the storage part, see also FIGS. 4A to 4C and the description thereof for exemplary implementations.

The hard disk drive, for instance, is configured from an expensive disk drive such as an FC (Fibre Channel) disk, or an inexpensive disk such as a SATA (Serial AT Attachment) disk drive or an optical disk drive or the like. One or more logical volumes are defined in the storage areas (hereinafter referred to as “RAID groups”) provided by one or more of the hard disk drives. Data from the host system can be accessed (read from and written into) the logical volumes in block units (data storage units) of a prescribed size.

A unique identifier (Logical Unit Number: LUN) is allocated to each logical volume 26. In the case of this embodiment, the input and output of data are performed by setting the combination of the foregoing identifier and a unique number (LBA: Logical Block Address) that is allocated to the respective logical blocks as the address, and designating this address.

The control unit may comprise a plurality of interfaces (I/F), a disk adapter, a cache memory, a memory controller, a bridge, a memory, and a CPU (and/or FPGA(s)).

The interface may be an external interface used for sending and receiving write data, read data and various commands to and from the storage system. The disk adapter may be an interface to the storage part, and, for example, is used for sending and receiving write data, read data or various commands to and from the storage part according to a fibre channel protocol.

The cache memory, for instance, can be configured from a nonvolatile semiconductor memory, and is used for temporarily storing commands and data to be read from and written into the storage part. The memory controller controls the data transfer between the cache memory and the memory, and the data transfer between the cache memory and the disk adapter. The bridge may be used for sending and receiving read commands and write commands and performing filing processing and the like between the memory controller and the CPU, or between the memory controller and the memory.

In addition to being used for retaining various control programs and various types of control information, the memory may also be used as a work memory of the CPU. The CPU is a processor for controlling the input and output of data to and from the storage part in response to the read command or write command, and controls the interface, the disk adapter, the memory controller and the like based on various control programs and various types of control information stored in the memory.

Returning to the example of FIG. 26, a series of separate sub-modules of the file system module handle the tasks associated with file system management. Each of these sub-modules typically has its own cache memory for storing metadata pertinent to the tasks of the sub-module. (Metadata refers to file overhead information as opposed to actual file content data; the file content data is handled along the buses 311 and 312 discussed previously.) These sub-modules are Free Space Allocation 321, Object Store 322, File System Tree 323, File System Directory 324, File System File 325, and Non-Volatile Storage Processing 326.

The sub-modules operate under general supervision of a processor, but are organized to handle their specialized tasks in a manner dictated by the nature of file system requests being processed. In particular, the sub-modules are hierarchically arranged, so that successively more senior sub-modules are located successively farther to the left. Each sub-module receives requests from the left, and has the job of fulfilling each request and issuing a response to the left, and, if it does not fulfill the request directly, it can in turn issue a request and send it to the right and receive a response on the right from a subordinate sub-module. A given sub-module may store a response, provided by a subordinate sub-module, locally in its associated cache to avoid resending a request for the same data. In one embodiment, these sub-modules are implemented in hardware, using suitably configured field-programmable gate arrays. Each sub-module may be implemented using a separate field-programmable gate array, or multiple sub-modules may be combined into a single field-programmable gate array (for example, the File System Tree 323 and File System Directory 324 sub-modules may be combined into a single field-programmable gate array). Alternatively, each sub-module (or combination of sub-modules) may be implemented, for example, using integrated circuitry or a dedicated processor that has been programmed for the purpose.

Although the storage system, with respect to which the file system embodiment herein is being used, is referred to as the “disk,” it will be understood that the storage system may be any suitable large data storage arrangement, including but not limited to an array of one or more magnetic or magneto-optical or optical disk drives, solid state storage devices, and magnetic tapes.

The Free Space Allocation sub-module 321 manages data necessary for operation of the Object Store sub-module 322, and tracks the overall allocation of space on the disk as affected by the Object Store sub-module 322. On receipt of a request from the Object Store sub-module 322, the Free Space Allocation sub-module 321 provides available block numbers to the Object Store sub-module. To track free space allocation, the Free Space Allocation sub-module establishes a bit map of the disk, with a single bit indicating the free/not-free status of each block of data on the disk. This bit map is itself stored on the disk as a special object handled by the Object Store sub-module. There are two two-way paths between the Object Store and Free Space Allocation sub-modules since, on the one hand, the Object Store sub-module has two-way communication with the Free Space Allocation sub-module for purposes of management and assignment of free space on the disk, and since, on the other hand, the Free Space Allocation sub-module has two-way communication with the Object Store sub-module for purposes of retrieving and updating data for the disk free-space bit map.

The File System File sub-module 325 manages the data structure associated with file attributes, such as the file's time stamp, who owns the file, how many links there are to the file (i.e., how many names the file has), read-only status, etc. Among other things, this sub-module handles requests to create a file, create a directory, insert a file name in a parent directory, and update a parent directory. This sub-module in turn interacts with other sub-modules described below.

The File System Directory sub-module 324 handles directory management. The directory is managed as a listing of files that are associated with the directory, together with associated object numbers of such files. File System Directory sub-module 324 manages the following operations of directories: create, delete, insert a file into the directory, remove an entry, look up an entry, and list contents of directory.

The File System Directory sub-module 324 works in concert with the File System Tree sub-module 323 to handle efficient directory lookups. Although a conventional tree structure is created for the directory, the branching on the tree is handled in a non-alphabetical fashion by using a pseudo-random value, such as a CRC (cyclic redundancy check sum), that is generated from a file name, rather than using the file name itself. Because the CRC tends to be random and usually unique for each file name, this approach typically forces the tree to be balanced, even if all file names happen to be similar. For this reason, when updating a directory listing with a new file name, the File System Directory sub-module 324 generates the CRC of a file name, and asks the File System Tree sub-module 323 to utilize that CRC in its index. The File System Tree sub-module associates the CRC of a file name with an index into the directory table. Thus, the sub-module performs the lookup of a CRC and returns an index.

The File System Tree sub-module 323 functions in a manner similar to the File System Directory sub-module 324, and supports the following functions: create, delete, insert a CRC into the directory, remove an entry, look up an entry. But in each case the function is with respect a CRC rather than a file.

The Non-Volatile Storage Processing sub-module 326 interfaces with associated non-volatile storage (e.g. an NVRAM) to provide a method for recovery in the event of power interruption or other event that prevents cached data—which is slated for being saved to disk—from actually being saved to disk. In particular, since, at the last checkpoint, a complete set of file system structure has been stored, it is the task of the Non-Volatile Storage Processing sub-module 326 to handle storage of file system request data since the last checkpoint. In this fashion, recovery, following interruption of processing of file system request data, can be achieved by using the file system structure data from the last stored checkpoint and then reprocessing the subsequent file system requests stored in NVRAM.

In operation, the Non-Volatile Storage Processing sub-module 326, for every file system request that is received (other than a non-modifying request), is told by the processor whether to store the request in NVRAM, and, if so told, then stores in the request in NVRAM. (If this sub-module is a part of a multi-node file server system, then the request is also stored in the NVRAM of another node.) No acknowledgment of fulfillment of the request is sent back to the client until the sub-module determines that there has been storage locally in NVRAM by it (and any paired sub-module on another file server node). This approach to caching of file system requests is considerably different from prior art systems wherein a processor first writes the file system request to NVRAM and then to disk. This is approach is different because there is no processor time consumed in copying the file system request to NVRAM—the copying is performed automatically.

In order to prevent overflow of NVRAM, a checkpoint is forced to occur whenever the amount of data in NVRAM has reached a pre-determined threshold. A checkpoint is only valid until the next checkpoint has been created, at which point the earlier checkpoint no longer exists.

When file server systems are clustered, non-volatile storage may be mirrored using a switch to achieve a virtual loop.

As described herein, a consistent file system image (termed a checkpoint) can be stored on disk at regular intervals, and all file system changes that have been requested by the processor but have not yet been stored on disk in a checkpoint are stored in NVRAM by the Non-Volatile Storage Processing sub-module.

In the event of a system failure, the processor detects that the on disk file system is not “clean” and it begins the recovery procedure. Initially, the on disk file system is reverted to the state represented by the last checkpoint stored on disk. Since this is a checkpoint, it will be internally consistent. However, any changes that were requested following the taking of this checkpoint will have been lost. To complete the recovery procedure, these changes must be restored. This is possible since these changes would all have been caused by requests issued by the processor, and (as explained above) all file system changes that have been requested by the processor but have not yet been stored on disk in a checkpoint are stored in NVRAM. The lost changes can therefore be restored by repeating the sequence of file system changing operations that were requested by the processor from the time of the last checkpoint until the system failure.

When file server systems are clustered, non-volatile storage may be mirrored using a switch to achieve a virtual loop.

As described herein, a consistent file system image (termed a checkpoint) may be stored on disk at regular intervals, and all file system changes that have been requested by the processor but have not yet been stored on disk in a checkpoint are stored in NVRAM by the Non-Volatile Storage Processing sub-module. In order to prevent overflow of NVRAM, a checkpoint is forced to occur, for example, whenever the amount of data in NVRAM has reached a pre-determined threshold. A checkpoint is only valid until the next checkpoint has been created, at which point the earlier checkpoint is no longer considered current.

Exemplary Filesystem

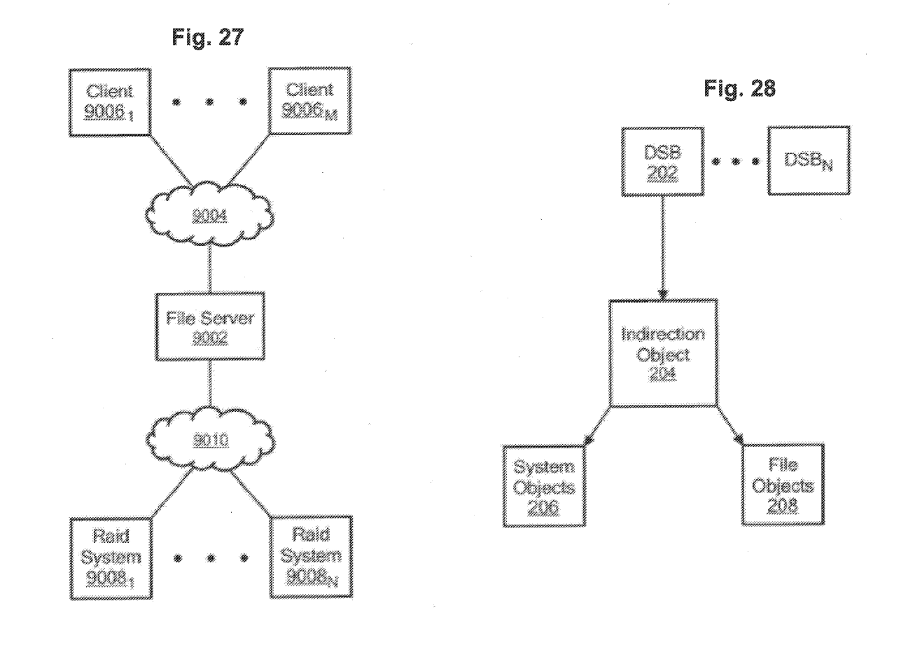

FIG. 27 is a schematic block diagram of an exemplary file storage system. The file storage system in FIG. 27 is also described in WO 2012/071335 and U.S. application Ser. No. 13/301,241 entitled “File Cloning and De-Cloning in a Data Storage System”, which was filed on Nov. 21, 2011, and are incorporated herein by reference.

Among other things, the file storage system includes a number of file servers (a single file server 9002 is shown for the sake of simplicity and convenience) in communication with various client devices 90061-9006M over a communication network 9004 such as an Internet Protocol network (e.g., the Internet) and also in communication with various RAID systems 90081-9008N over a storage network 9010 such as a FibreChannel network. The client devices 90061-9006M and the file server 9002 communicate using one or more network file protocols, such as CIFS and/or NFS. The file server 9002 and the RAID systems 90081-9008N communicate using a storage protocol, such as SCSI. It should be noted that the file storage system could include multiple file servers and multiple RAID systems interconnected in various configurations, including a full mesh configuration in which any file server can communicate with any RAID system over a redundant and switched FibreChannel network.

The file server 9002 includes a storage processor for managing one or more file systems. The file server 9002 can be configured to allow client access to portions of the file systems, such as trees or sub-trees under designated names. In CIFS parlance, such access may be referred to as a “share” while in NFS parlance, such access may be referred to as an “export.” Internally, the file server 9002 may include various hardware-implemented and/or hardware-accelerated subsystems, for example, as described in U.S. patent application Ser. Nos. 09/879,798 and 10/889,158, which were incorporated by reference above, and may include a hardware-based file system including a plurality of linked sub-modules, for example, as described in U.S. patent application Ser. Nos. 10/286,015 and 11/841,353, which were incorporated by reference above.

Each RAID system 9008 typically includes at least one RAID controller (and usually two RAID controllers for redundancy) as well as a number of physical storage devices (e.g., disks) that are managed by the RAID controller(s). The RAID system 9008 aggregates its storage resources into a number of SDs. For example, each RAID system 9008 may be configured with between 2 and 32 SDs. Each SD may be limited to a predetermined maximum size (e.g., 2 TB-64 TB or more).

Filesystem Tree Structure

The file server 9002 stores various types of objects in the file system. The objects may be classified generally as system objects and file objects. File objects are created for storage of user data and associated attributes, such as a word processor or spreadsheet files. System objects are created by the file storage system for managing information and include such things as root directory objects, free-space allocation objects, modified checkpoint objects list objects, modified retained objects list objects, and software metadata objects, to name but a few. More particularly, directory objects are created for storage of directory information.

Free-space allocation objects are created for storage of free-space allocation information. Modified checkpoint objects list objects and modified retained objects list objects (both of which are described in more detail below) are created for storage of information relating to checkpoints and retained checkpoints, respectively. An software metadata object (which is described in more detail below) is a special object for holding excess file attributes associated with a file or directory object (i.e., file attributes that cannot fit within pre-designated areas within the file or directory object as described below, such as CIFS security attributes), and is created by the creator of the file or directory object, which includes a reference to the software metadata object within the file or directory object.

An instantiation of the file system is managed using a tree structure having root node (referred to as a dynamic superblock or DSB) that is preferably stored at a fixed location within the storage system. Among other things, storing the DSB at a fixed location makes it easy for the file server 9002 to locate the DSB. The file server 9002 may maintain multiple DSBs to store different versions of the file system representing different checkpoints (e.g., a current “working” version and one or more “checkpoint” versions). In an exemplary embodiment, the DSB includes a pointer to an indirection object (described in detail below), which in turn includes pointers to other objects.

FIG. 28 is an exemplary schematic block diagram showing the exemplary general format of a file system instantiation in accordance with an exemplary embodiments. The DSB 202 is a special structure that represents the root of the file system tree structure. Among other things, the DSB 202 includes a pointer to an indirection object 204, which in turn includes pointers to other objects in the file system including system objects 206 and file objects 208.

In some exemplary embodiments, N dynamic superblocks (N>2) are maintained for a file system, only one of which is considered to be the most up to date at any given point in time. The number of DSBs may be fixed or configurable. The DSBs are located at fixed locations and are used to record the state of the checkpoints on the disk. Each DSB points to an indirection object.

Among other things, the following information may be stored in each dynamic superblock: the checkpoint number associated with this dynamic superblock; the handle of the modified checkpoint objects list object for this checkpoint; the object number of the modified retained objects list object from the last retained checkpoint; the state of this checkpoint (i.e., whether or not a checkpoint has been created); and/or a CRC and various other information to allow the DSB and other structures (e.g., the indirection object) to be checked for validity.

In an exemplary embodiment, the DSBs are treated as a circular list (i.e., the first dynamic superblock is considered to successively follow the last dynamic superblock), and each successive checkpoint uses the next successive dynamic superblock in the circular list. When the file server 9002 opens the volume, it typically reads in all dynamic superblocks and performs various checks on the DSBs. The DSB having the latest checkpoint number with the checkpoint state marked as completed and various other sanity checks passed is considered to represent the latest valid checkpoint on this volume. The file server 9002 begins using the next DSB in the circular list for the next checkpoint.

The general format of the indirection object 204 is discussed below.

Object Tree Structure

Generally speaking, each object in the file system, including the indirection object 204, each of the system objects 206, and each of the file objects 208, is implemented using a separate tree structure that includes a separate object root node and optionally includes a number of indirect nodes, direct nodes, and storage blocks. The DSB 202 includes a pointer to the root node of the indirection object 204. The indirection object 204 includes pointers to the root nodes of the other objects.

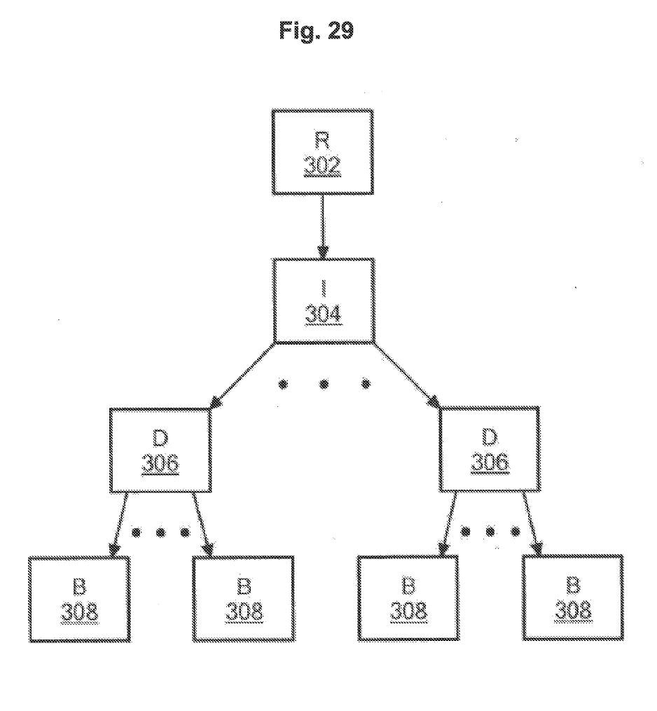

FIG. 29 is a schematic block diagram showing the exemplary general format of an object tree structure in accordance with an exemplary embodiments.

A root (“R”) node 302 may point to various indirect (“I”) nodes 304, each of which may point to a number of direct (“D”) nodes 306, each of which may point to a number of storage blocks (“B”) 308. In practice, object tree structures can vary widely, for example, depending on the size of the object. Also, the tree structure of a particular object can vary over time as information is added to and deleted from the object. For example, nodes may be dynamically added to the tree structure as more storage space is used for the object, and different levels of indirection may be used as needed (e.g., an indirect node can point to direct nodes or to other indirect nodes).

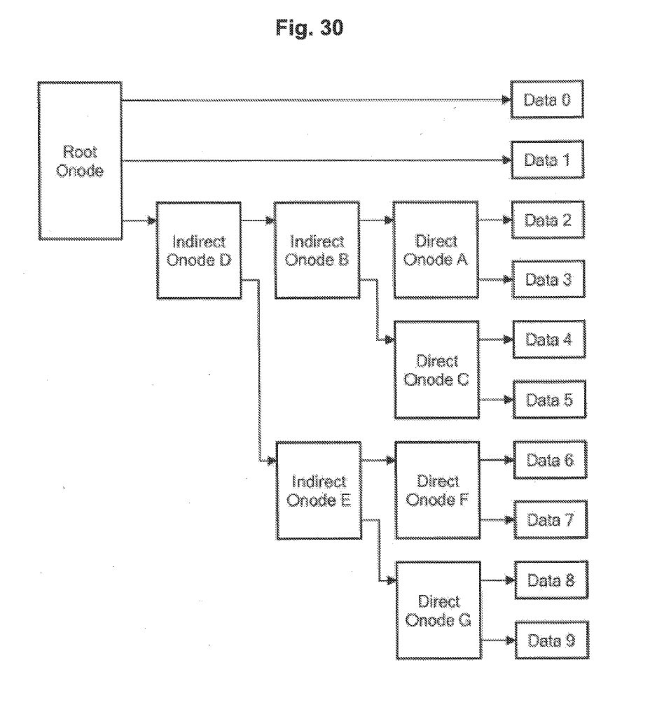

FIG. 30 is an exemplary block diagram illustrating use of multiple layers of indirect onodes placed between the root onode and the direct onodes in accordance with exemplary embodiments.

When an object (e.g. file object or system object) is created, an object root node is created for the object. Initially, the root node of such an “empty” object has no pointers to any indirect nodes, direct nodes, or data blocks.

As data is added to the object, it is first of all put into data blocks pointed to directly from the root node. For the sake of simplicity in FIG. 29, the root node is exemplarily shown as having only two data pointers and one pointer to another direct or indirect node, and the indirect nodes are exemplarily shown as only having two indirect or direct node pointers, and direct nodes are exemplarily shown as having two data pointers. Of course, in other implementations, much more pointers may be used per node.

Once all the direct block pointers in the root node are filled, then a direct node A is created with a pointer from the root node to the direct node. Note that the root node has multiple data block pointers but only a single pointer to either a direct or an indirect node.

If the data in the object grows to fill all the data pointers in the direct node, then an indirect node B is created. The pointer in the root node which was pointing to the direct node A, is changed to point at the indirect node B, and the first pointer in the indirect node B is set to point at the direct node A. At the same time a new direct node C is created, which is also pointed to from the indirect node B. As more data is created more direct nodes are created, all of which are pointed to from the indirect node.

Once all the direct node pointers in the indirect node B have been used another indirect node D is created which is inserted between the root node and the first indirect node B. Another indirect node E and direct node F are also created to allow more data blocks to be referenced. These circumstances are shown in FIG. 30, which exemplarily illustrates use of multiple layers of indirect nodes placed between the root node and the direct nodes.

This process of adding indirect nodes to create more levels of indirection is repeated to accommodate however much data the object contains.

The object root node may include a checkpoint number to identify the checkpoint in which the object was last modified (the checkpoint number initially identifies the checkpoint in which the object was created and thereafter the checkpoint number changes each time the object is modified in a new checkpoint). In an exemplary embodiment, the checkpoint number at which the object was created is also stored in the object root node. Also in the object root node is a parameter to identify the type of object for which the object root node is providing metadata. The object type may, for example, be any of a free space object, file, or directory. In addition to object type, the object root node also has a parameter for the length of the object in blocks.

The object root node also carries a series of pointers. One of these is a pointer to any immediately preceding version of the object root node. If it turns out that a retained checkpoint has been taken for the pertinent checkpoint, then there may have been stored an immediately preceding version of the object root node in question, and the pointer identifies the sector number of such an immediately preceding version of the object root node.

For the actual data to which the object root node corresponds, the object root node includes a separate pointer to each block of data associated with the corresponding object. The location of up to 18 data blocks is stored in the object root node. For data going beyond 18 blocks, a direct node is additionally required, in which case the object root node also has a pointer to the direct node, which is identified in the object root node by sector number on the disk.

The direct node includes a checkpoint number and is arranged to store the locations of a certain number of blocks (e.g., about 60 or 61 blocks) pertinent to the object.

When a first direct node is fully utilized to identify data blocks, then one or more indirect node are used to identify the first direct node as well as additional direct nodes that have blocks of data corresponding to the object. In such a case, the object root node has a pointer to the indirect node, and the indirect node has pointers to corresponding direct nodes. When an indirect node is fully utilized, then additional intervening indirect nodes are employed as necessary. This structure permits fast identification of a part of a file, irrespective of the file's fragmentation.

Node structure may also be established, in an exemplary embodiment, in a manner to further reduce disk writes in connection with node structures. In the end, the node structure needs to accommodate the storage not only of file contents but also of file attributes. File attributes include a variety of parameters, including file size, file creation time and date, file modification time and date, read-only status, and access permissions, among others. This connection takes advantage of the fact that changing the contents of an object root node can be performed frequently during a given checkpoint, since the object root node is not yet written to disk (i.e., because disk writes of object root nodes are delayed, as discussed above). Therefore, in an exemplary embodiment, a portion of the object root node is reserved for storage of file attributes.

More generally, the following structures for storage of file attributes are defined in an exemplary embodiment: enode (little overhead to update, limited capacity; this structure is defined in the object root node and is 128 bytes in an exemplary embodiment); software metadata object (expensive in overhead to update, near infinite capacity; this is a dedicated object for storage of metadata and therefore has its own storage locations on disk); the object is identified in the enode.

Thus, in an exemplary embodiment, each object root node stores the following types of information: the checkpoint number; the data length for this version of the object; the number of levels of indirection used in the runlist for this object; the type of the object (this is primarily used as a sanity check when a request comes in to access the object); a pointer to an older root node version made for a retained checkpoint (if there is one); a pointer to a newer root node version (will only be valid if this is a copy of a root node made for a retained checkpoint); up to 16 (or more) data block pointers per root onode (each data block descriptor includes a pointer to a data block, the checkpoint number, and a bit to say whether the block is zero filled); a single pointer to either a direct node or an indirect node; the 128 bytes of enode data for this object; and/or a CRC and various sanity dwords to allow the root node to be checked for validity.

As discussed below, an object may include copies of root nodes that are created each time a retained checkpoint is taken. The pointer to the older root node version and the pointer to the newer root node version allow a doubly-linked list of root nodes to be created including the current root node and any copies of root nodes that are created for retained checkpoints. The doubly-linked list facilitates creation and deletion of retained checkpoints.

As discussed above, the indirect node provides a level of indirection between the root node and the direct node. The following information is stored in the indirect node in an exemplary embodiment: the checkpoint number; pointers to either indirect or direct nodes (e.g., up to 60 such pointers); and/or a CRC and various sanity dwords to allow the indirect node to be checked for validity.

As discussed above, the direct node provides direct pointers to data blocks on the disk. The following information is stored in the direct node in an exemplary embodiment: the checkpoint number; a number of data block descriptors (e.g., up to 62 such descriptors; each data block descriptor includes a pointer to a data block, the checkpoint number, and a bit to say whether the block is zero filled); and/or a CRC and various sanity dwords to allow the indirect node to be checked for validity.

As data is deleted from the object and data blocks and direct and indirect nodes are no longer required, they are returned to the free space allocation controller.

Within the file storage system, each object is associated with an object number that is used to reference the object. System objects typically have fixed, predefined object numbers, since they generally always exist in the system. File objects are typically assigned object numbers dynamically from a pool of available object numbers. These file object numbers may be reused in some circumstances (e.g., when a file is deleted, its object number may be freed for reuse by a subsequent file object).

The file system may include Z object numbers (where Z is variable and may grow over time as the number of objects increases). A certain range of object numbers is reserved for system objects 206 (in an example, object numbers 1-J), and the remaining object numbers (in this example, object numbers K-Z) are assigned to file objects 208. Typically, the number of system objects 206 is fixed, while the number of file objects 208 may vary.

In an exemplary embodiment, the indirection object 204 is logically organized as a table, with one table entry per object indexed by object number. For example, each entry in the table may include an object type field and a pointer field. A number of different values are defined for the object type field, but for the sake of discussion, one set of values is defined for “used” objects and another set of values is defined for “free” objects. Thus, the value in the object type field of a particular table entry will indicate whether the corresponding object number is used or free.

In an exemplary embodiment, the indirection object may be implemented as a “pseudo-file” having no actual storage blocks. In an exemplary embodiment, instead of having pointers to actual data blocks in the object tree structure, such pointers in the indirection object tree structure point to the root nodes of the corresponding objects. Thus, in an exemplary embodiment, the indirection object maps each object number to the sector address of the root node associated with the corresponding file system object. The indirection object tree structure can then be traversed based on an object number in order to obtain a pointer to the root node of the corresponding object.

A root directory object is a system object (i.e., it has a root node and a fixed predetermined object number) that maps file names to their corresponding object numbers. Thus, when a file is created, the file storage system allocates a root node for the file, assigns an object number for the file, adds an entry to the root directory object mapping the file name to the object number, and adds an entry to the indirection object mapping the object number to the disk address of the root node for the file. An entry in the indirection object maps the root directory object number to the disk address of the root directory object's root node.

As mentioned above, an entry in the indirection object maps the root directory object number to the disk address of the root directory object's root node, the root directory object maps file names to object numbers, and the indirection object maps object numbers to objects. Therefore, when the file server needs to locate an object based on the object's file name, the file server can locate the root directory object via the indirection object (i.e., using the object number associated with the root directory object), map the file name to its corresponding object number using the root directory object, and then locate the object via the indirection object using the object number.

Multi-Way Checkpoints

In some exemplary embodiments, multiple checkpoints may be taken so that multiple versions of the file system can be maintained over time. For example, multiple separate root structures (referred to hereinafter as “dynamic superblocks” or “DSBs”) are used to manage multiple instantiations of the file system. The DSBs are preferably stored in fixed locations within the storage system for easy access, although the DSBs may alternatively be stored in other ways. There are typically more than two DSBs, and the number of DSBs may be fixed or variable. There is no theoretical limit to the number of DSBs (although there may be practical limits for various implementations). In this way, if it becomes necessary or desirable to revert the file system back to a previous “checkpoint,” there are multiple “checkpoints” from which to choose, providing a better chance that there will be an intact version of the file system to which the file system can be reverted or a checkpoint that contains a particular version of the file system.

With respect to each successive checkpoint, there is stored, on disk, current file structure information that supersedes previously stored file structure information from the immediately preceding checkpoint. Checkpoints are numbered sequentially and are used to temporally group processing of file requests.

As discussed above, some exemplary embodiments may maintain N DSBs (where N is greater than two, e.g., 16). The DSBs are used to take successive checkpoints.

Thus, at any given time, there is a current (working) version of the file system and one or more checkpoint versions of the file system. Because the storage system is typically quite dynamic, the current version of the file system will almost certainly begin changing almost immediately after taking a checkpoint. For example, file system objects may be added, deleted, or modified over time. In order to maintain checkpoints, however, none of the structures associated with stored checkpoints can be permitted to change, at least until a particular checkpoint is deleted or overwritten. Therefore, as objects in the current version of the file system are added, deleted, and modified, new versions of object tree structures are created as needed, and the various pointers are updated accordingly.

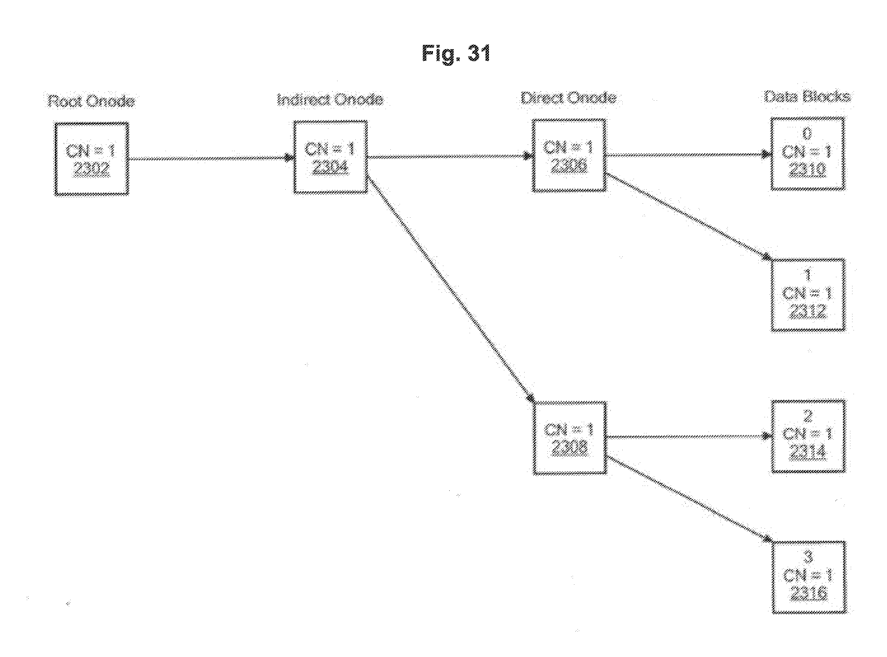

For example, FIG. 31 schematically shows an object structure for an exemplary object that was created at a checkpoint number 1. The object includes four data blocks, namely data block 0 (2310), data block 1 (2312), data block 2 (2314), and data block 3 (2316). A direct node 2306 includes a pointer to data block 0 (2310) and a pointer to data block 1 (2312). A direct node 2308 includes a pointer to data block 2 (2314) and a pointer to data block 3 (2316). An indirect node 2304 includes a pointer to direct node 2306 and a pointer to direct node 2308. A root node 2302 includes a pointer to indirect node 2304. All nodes and all data blocks are marked with checkpoint number 1.

Suppose now that data block 0 (2310) is to be modified in checkpoint number 3. Since root node 2402 is part of an earlier checkpoint, it cannot be modified. Instead, the Object Store sub-module of the file server 9002 saves a copy of the old root node 2302 to free space on the disk and marks this new root node with checkpoint number 3 (i.e., the checkpoint at which it was created). At this point, both root node 2402 and new root node 2403 point to indirect node 2304.

The Object Store sub-module then traverses the object structure starting at the root node until it reaches the descriptor for data block 0 (2310). Since data block 0 (2310) is part of an earlier checkpoint, it cannot be modified. Instead, the Object Store sub-module creates a modified copy of data block 2310 in free space on the disk and marks this new data block with checkpoint number 3 (i.e., the checkpoint at which it was created).

The Object Store sub-module now needs to put a pointer to the new data block 2510 in a direct node, but the Object Store sub-module cannot put a pointer to the new data block 2510 in the direct node 2306 because the direct node 2306 is a component of the earlier checkpoint. The Object Store sub-module therefore creates a modified copy of direct node 2306 to free space on the disk including pointers to the new data block 0 (2510) and the old data block 1 (2312) and marks this new direct node with checkpoint number 3 (i.e., the checkpoint at which it was created). The Object Store sub-module now needs to put a pointer to the new direct node 2606 in an indirect node, but the Object Store sub-module cannot put a pointer to the new direct node 2606 in the indirect node 2304 because the indirect node 2304 is a component of the earlier checkpoint. The Object Store sub-module therefore creates a modified copy of indirect node 2304 with pointers to the new direct node 2606 and the old direct node 2308.

Finally, the Object Store sub-module writes a pointer to the new indirect node 2704 in the new root node 2403.

Then, FIG. 32 schematically shows the object structure after the pointer to the new indirect node 2704 is written into the new root node 2403.

It should be noted that, after modification of data block 0 is complete, blocks 2402, 2304, 2306, and 2310 are components of the checkpoint 1 version but are not components of the current checkpoint 3 version of the object; blocks 2308, 2312, 2314, and 2316 are components of both the checkpoint 1 version and the current checkpoint 3 version of the object; and blocks 2403, 2704, 2606, and 2510 are components of the current checkpoint 3 version of the object but are not components of the checkpoint 1 version.

It should also be noted that the new node do not necessarily need to be created in the order described above. For example, the new root node could be created last rather than first.

Thus, when a file system object is modified, the changes propagate up through the object tree structure so that a new root node is created for the modified object. A new root node would only need to be created for an object once in a given checkpoint; the new root node can be revised multiple times during a single checkpoint.

In order for the new version of the object to be included in the current version of the file system, the current indirection object is modified to point to the root node of the modified object rather than to the root node of the previous version of the object. For example, with reference again to FIG. 32, the current indirection object would be updated to point to root node 2403 rather than to root node 2402 for the object number associated with this object.

Similarly, if a new object is created or an existing object is deleted in the current version of the file system, the current indirection object is updated accordingly. For example, if a new object is created, the indirection object is modified to include a pointer to the root node of the new object. If an existing object is deleted, the indirection object is modified to mark the corresponding object number as free.

Since the indirection object is also a tree structure having a root node, modification of the indirection object also propagates up through the tree structure so that a new root node would be created for the modified indirection object. Again, a new root node would only need to be created for the indirection object once in a given checkpoint; the new root node can be revised multiple times during a single checkpoint.

Thus, when a new version of the indirection object is created during a particular checkpoint, the DSB associated with that checkpoint is updated to point to the new root node for the modified indirection object. Therefore, each version of the file system (i.e., the current version and each checkpoint version) generally will include a separate version of the indirection object, each having a different indirection object root node (but possibly sharing one or more indirect nodes, direct nodes, and/or data blocks).

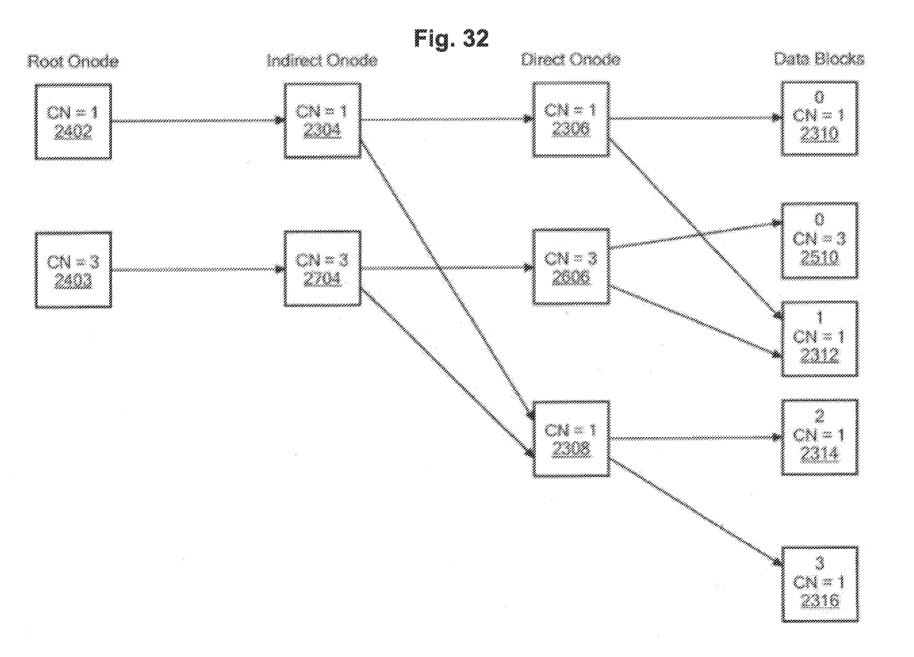

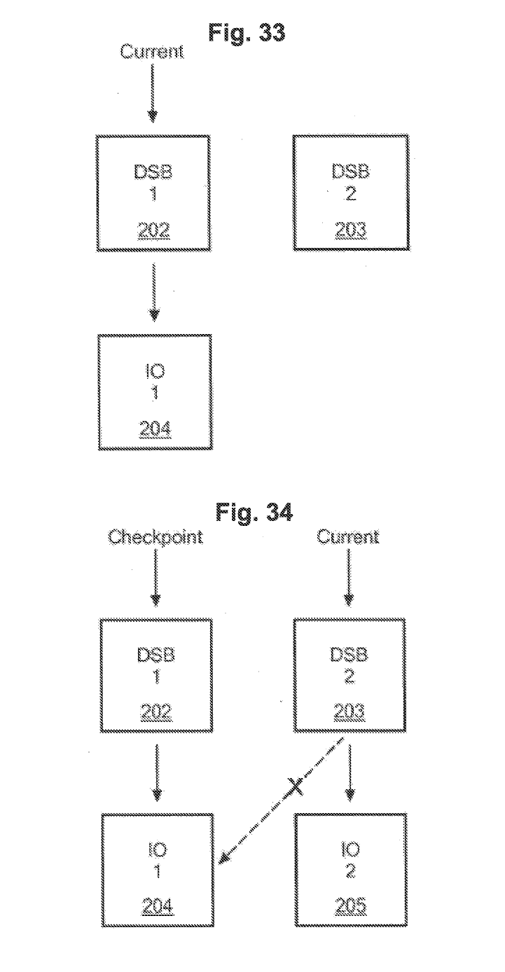

FIG. 33 is a schematic diagram showing various file system structures prior to the taking of a checkpoint, in accordance with some exemplary embodiments. Specifically, two DSBs numbered 202 and 203 are shown. DSB 202 is associated with the current version of the file system and includes a pointer to the root node of the current version of the indirection object 204. DSB 203 is the next available DSB.

In order to create a checkpoint from the current version of the file system, the next DSB in the circular list (i.e., DSB 203 in this example) is initialized for the new checkpoint. Among other things, such initialization includes writing the next checkpoint number into DSB 203 and storing a pointer to the root node of indirection object 204 into DSB 203.

At this point, DSB 202 represents the most recent checkpoint version of the file system, while DSB 203 represents the current (working) version of the file system.

As discussed above, the current version of the file system may change as objects are created, modified, and deleted. Also, as discussed above, when the current version of the file system changes, a new version of the indirection object (having a new root node) is created. Consequently, when the current version of the indirection object changes after a checkpoint is taken, such that a new indirection object root node is created, the DSB for the current file system version (i.e., DSB 203) is updated to point to the new indirection object root node rather than to the prior indirection object root node.

FIG. 34 is a schematic diagram showing the various file system structures after modification of the indirection object, in accordance with some exemplary embodiments. Here, DSB 202, which is associated with the checkpoint version of the file system, points to the checkpoint version of the indirection object 204, while DSB 203, which is associated with the current version of the file system, points to the root node of new indirection object 205.

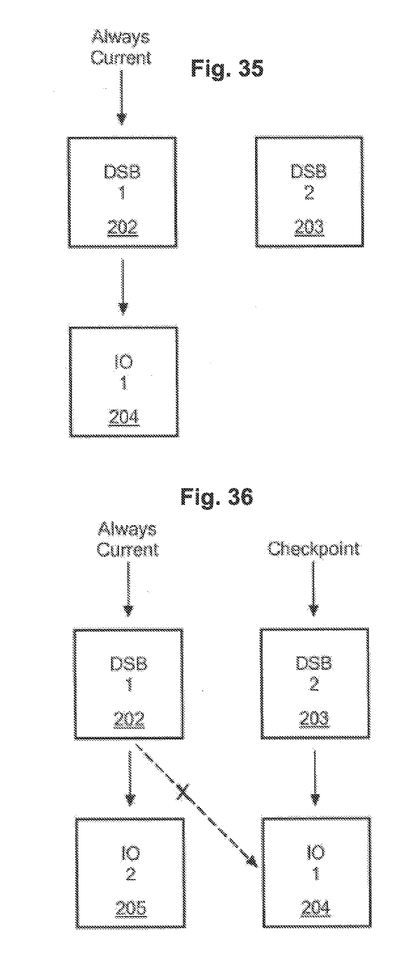

FIG. 35 is a schematic diagram showing various file system structures prior to the taking of a checkpoint, in accordance with some exemplary embodiments. Specifically, two DSBs numbered 202 and 203 are exemplarily shown. DSB 202 is associated with the current version of the file system and includes a pointer to the root node of the current version of the indirection object 204. DSB 203 is the next available DSB.

In order to create a checkpoint from the current version of the file system, the next DSB 203 is initialized for the new checkpoint. Among other things, such initialization includes writing the next checkpoint number into DSB 203 and storing a pointer to the root node of indirection object 204 into DSB 203. At this point, DSB 203 represents the most recent checkpoint version of the file system, while DSB 202 continues to represent the current (working) version of the file system.

As discussed above, the current version of the file system may change as objects are created, modified, and deleted. Also, as discussed above, when the current version of the file system changes, a new version of the indirection object (having a new root node) is created. Consequently, when the current version of the indirection object changes after a checkpoint is taken, such that a new indirection object root node is created, the DSB for the current file system version (i.e., DSB 202) is updated to point to the new indirection object root node rather than to the prior indirection object root node.

FIG. 36 is a schematic diagram showing the various file system structures after modification of the indirection object, in accordance with some exemplary embodiments. Here, DSB 203, which is associated with the checkpoint version of the file system, points to the checkpoint version of the indirection object 204, while DSB 202, which continues to be associated with the current version of the file system, points to the root node of new indirection object 205.

File Cloning

The process of file cloning is explained in U.S. patent application Ser. No. 10/286,015, which is incorporated by reference above. Relevant portions of the process are reprinted below from U.S. patent application Ser. No. 10/286,015 and some portions are omitted. According to some embodiments of the present invention, file cloning is performed according to the following process.

In certain embodiments of the present invention, a file cloning mechanism is employed to allow for quickly creating copies (clones) of files within a file system, such as when a user makes a copy of a file. In exemplary embodiments, a clone of a source object is at least initially represented by a structure containing references to various elements of the source object (e.g., indirect onodes, direct onodes, and data blocks). Both read-only and mutable clones can be created. The source file and the clone initially share such elements and continue to share unmodified elements as changes are made to the source file or mutable clone. None of the user data blocks or the metadata blocks describing the data stream (i.e., the indirect/direct onodes) associated with the source file need to be copied at the time the clone is created.

In exemplary embodiments, a file system object is cloned by first creating a new object that represents a read-only clone (snapshot) of the source object, referred to hereinafter as a “data-stream-snapshot” object or “DSS,” and then creating a mutable clone of the object. The block pointers and onode block pointer in the root onode of the clone objects are initially set to point to the same blocks as the source object. Certain metadata from the source object (e.g., file times, security, etc.) and named data streams are not copied to the clone object. Metadata is maintained in the source object and in the clone objects to link the data-stream-snapshot object with the source object and the mutable clone object and also to link the source object and the mutable clone object with the data-stream-snapshot object. In exemplary embodiments, the data-stream-snapshot object is a “hidden” object in that it is not visible to the file system users. Both the source object and the mutable clone object effectively become writable versions of the DSS object and effectively store their divergences from the DSS object.

Before creating the data-stream-snapshot object, the system preferably ensures that the source object is quiescent.

Some of the file cloning concepts described above can be demonstrated by the examples in U.S. patent application Ser. No. 10/286,015, which is incorporated by reference above.

As is apparent from the present description of exemplary embodiments of the present invention, modifications to the cloning and checkpointing mechanisms described above can be implemented.

It should be noted that headings are used above for convenience and readability of the detailed description and are not to be construed as limiting the present invention in any way.

As will be appreciated by one of skill in the art, the present invention, as described hereinabove and the accompanying figures, may be embodied as a method (e.g., a computer-implemented process, a business process, or any other process), apparatus (including a device, machine, system, computer program product, and/or any other apparatus), or a combination of the foregoing.

Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system” Furthermore, embodiments of the present invention may take the form of a computer program product on a computer-readable medium having computer-executable program code embodied in the medium.

It should be noted that arrows may be used in drawings to represent communication, transfer, or other activity involving two or more entities. Double-ended arrows generally indicate that activity may occur in both directions (e.g., a command/request in one direction with a corresponding reply back in the other direction, or peer-to-peer communications initiated by either entity), although in some situations, activity may not necessarily occur in both directions.

Single-ended arrows generally indicate activity exclusively or predominantly in one direction, although it should be noted that, in certain situations, such directional activity actually may involve activities in both directions (e.g., a message from a sender to a receiver and an acknowledgement back from the receiver to the sender, or establishment of a connection prior to a transfer and termination of the connection following the transfer). Thus, the type of arrow used in a particular drawing to represent a particular activity is exemplary and should not be seen as limiting.

Embodiments of the present invention are described hereinabove with reference to flowchart illustrations and/or block diagrams of methods and apparatuses, and with reference to a number of sample views of a graphical user interface generated by the methods and/or apparatuses. It will be understood that each block of the flowchart illustrations and/or block diagrams, and/or combinations of blocks in the flowchart illustrations and/or block diagrams, as well as the graphical user interface, can be implemented by computer-executable program code.

The computer-executable program code may be provided to a processor of a general purpose computer, special purpose computer, or other programmable data processing apparatus to produce a particular machine, such that the program code, which executes via the processor of the computer or other programmable data processing apparatus, create means for implementing the functions/acts/outputs specified in the flowchart, block diagram block or blocks, figures, and/or written description.

These computer-executable program code may also be stored in a computer-readable memory that can direct a computer or other programmable data processing apparatus to function in a particular manner, such that the program code stored in the computer readable memory produce an article of manufacture including instruction means which implement the function/act/output specified in the flowchart, block diagram block(s), figures, and/or written description.

The computer-executable program code may also be loaded onto a computer or other programmable data processing apparatus to cause a series of operational steps to be performed on the computer or other programmable apparatus to produce a computer-implemented process such that the program code which executes on the computer or other programmable apparatus provides steps for implementing the functions/acts/outputs specified in the flowchart, block diagram block(s), figures, and/or written description. Alternatively, computer program implemented steps or acts may be combined with operator or human implemented steps or acts in order to carry out an embodiment of the invention.

It should be noted that terms such as “server” and “processor” may be used herein to describe devices that may be used in certain embodiments of the present invention and should not be construed to limit the present invention to any particular device type unless the context otherwise requires. Thus, a device may include, without limitation, a bridge, router, bridge-router (brouter), switch, node, server, computer, appliance, or other type of device. Such devices typically include one or more network interfaces for communicating over a communication network and a processor (e.g., a microprocessor with memory and other peripherals and/or application-specific hardware) configured accordingly to perform device functions.

Communication networks generally may include public and/or private networks; may include local-area, wide-area, metropolitan-area, storage, and/or other types of networks; and may employ communication technologies including, but in no way limited to, analog technologies, digital technologies, optical technologies, wireless technologies (e.g., Bluetooth), networking technologies, and internetworking technologies.

It should also be noted that devices may use communication protocols and messages (e.g., messages created, transmitted, received, stored, and/or processed by the device), and such messages may be conveyed by a communication network or medium.

Unless the context otherwise requires, the present invention should not be construed as being limited to any particular communication message type, communication message format, or communication protocol. Thus, a communication message generally may include, without limitation, a frame, packet, datagram, user datagram, cell, or other type of communication message.

Unless the context requires otherwise, references to specific communication protocols are exemplary, and it should be understood that alternative embodiments may, as appropriate, employ variations of such communication protocols (e.g., modifications or extensions of the protocol that may be made from time-to-time) or other protocols either known or developed in the future.

It should also be noted that logic flows may be described herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention.

Often times, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof Computer program logic implementing some or all of the described functionality is typically implemented as a set of computer program instructions that is converted into a computer executable form, stored as such in a computer readable medium, and executed by a microprocessor under the control of an operating system. Hardware-based logic implementing some or all of the described functionality may be implemented using one or more appropriately configured FPGAs.

Computer program logic implementing all or part of the functionality previously described herein may be embodied in various forms, including, but in no way limited to, a source code form, a computer executable form, and various intermediate forms (e.g., forms generated by an assembler, compiler, linker, or locator).

Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code maybe converted (e.g., via a translator, assembler, or compiler) into a computer executable form.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Computer program logic implementing all or part of the functionality previously described herein may be executed at different times on a single processor (e.g., concurrently) or may be executed at the same or different times on multiple processors and may run under a single operating system process/thread or under different operating system processes/threads.

Thus, the term “computer process” refers generally to the execution of a set of computer program instructions regardless of whether different computer processes are executed on the same or different processors and regardless of whether different computer processes run under the same operating system process/thread or different operating system processes/threads.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device.

The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies.

The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Any suitable computer readable medium may be utilized. The computer readable medium may be, for example but not limited to, an electronic, magnetic, optical, electromagnetic, infrared, or semiconductor system, apparatus, device, or medium.

More specific examples of the computer readable medium include, but are not limited to, an electrical connection having one or more wires or other tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device.

The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies.

The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web). Of course, some embodiments of the invention may be implemented as a combination of both software (e.g., a computer program product) and hardware. Still other embodiments of the invention are implemented as entirely hardware, or entirely software.

While certain exemplary embodiments have been described and shown in the accompanying drawings, it is to be understood that such embodiments are merely illustrative of and are not restrictive on the broad invention, and that the embodiments of invention are not limited to the specific constructions and arrangements shown and described, since various other changes, combinations, omissions, modifications and substitutions, in addition to those set forth in the above paragraphs, are possible.

Those skilled in the art will appreciate that various adaptations, modifications, and/or combination of the just described embodiments can be configured without departing from the scope and spirit of the invention. Therefore, it is to be understood that, within the scope of the appended claims, the invention may be practiced other than as specifically described herein. For example, unless expressly stated otherwise, the steps of processes described herein may be performed in orders different from those described herein and one or more steps may be combined, split, or performed simultaneously.

Those skilled in the art will also appreciate, in view of this disclosure, that different embodiments of the invention described herein may be combined to form other embodiments of the invention.

1. A computer program product comprising computer-readable program instructions which, when running on or loaded into a file system server or computer connected to the file system server or when being executed by one or more processors or processing units of the file system server or the computer, cause the file system server to execute a method for managing defragmentation of a file system in a data storage system comprising the file system server connectable to one or more storage apparatuses and to one or more host computers,
the method comprising:
allocating, in response to receiving an update request to update data stored in one or more first storage units of the of the plurality of storage units, one or more second storage units of the plurality of storage units indicated to be free based on free space allocation information for writing update data of the update request,
controlling writing update data to the allocated one or more second storage units, and
controlling swapping logical addresses associated with the one or more second storage units with respective logical addresses associated with the one or more first storage units.

2. The computer program product according to claim 1, further comprising:
managing defragmentation management information indicating logical addresses associated with the one or more second storage units and logical addresses associated with the one or more first storage units.

3. The computer program product according to claim 1, further comprising:
determining, upon receiving the update request, the logical addresses of the one or more first storage units of data to be updated with update data, and
upon allocating the one or more second storage units based on the free space allocation information, registering respective logical addresses of the allocated one or more second storage units together with the respective determined logical addresses of the one or more second storage units in managing defragmentation management information.

4. The computer program product according to claim 1, wherein
controlling swapping logical addresses is executed on the basis of defragmentation management information.

5. The computer program product according to claim 1, wherein
controlling swapping logical addresses is executed synchronously or asynchronously with respect to receiving the update request.

6. The computer program product according to claim 1, wherein
the one or more storage apparatuses include a plurality of storage devices, and the one or more second storage units are allocated such that the update data stored to the allocated one or more second storage units is stored on same storage device as the data stored to the one or more first storage units.

7. The computer program product according to claim 1, further comprising:
reading update data from the one or more second storage units and writing the read update data to the one or more first storage units after controlling swapping logical addresses associated with the one or more second storage units with respective logical addresses associated with the one or more first storage units, and, in particular at the same time further comprising reading data from the one or more first storage units and writing the read data to the one or more second storage units to swap actual data of the one or more first storage units and the one or more second storage units.

8. The computer program product according to claim 1, further comprising:
issuing a request to update an address mapping based on the swapping of the logical addresses associated with the one or more second storage units with the respective logical addresses associated with the one or more first storage units.

9. The computer program product according to claim 8, wherein:
the request to update an address mapping is a request to swap corresponding logical addresses in a logical-to-logical address map managed at a parity management unit configured to manage data redundant parity.

10. The computer program product according to claim 8, wherein:
the request to update an address mapping is a request to swap corresponding logical addresses or physical addresses in a logical-to-physical address map of a parity management layer managed at a parity management unit configured to manage data redundant parity or in a logical-to-physical address map of a storage device management layer managed at a storage device management unit configured to manage an array of one or more storage devices.

11. The computer program product according to claim 7, further comprising:
providing mapping configuration information, wherein the mapping configuration information indicates one or more logical-to-logical or logical-to-physical addresses mapping layers, and further indicates a layer at which the address mapping is to be updated, and the request to update the address mapping is issued on the basis of the provided mapping configuration information.

12. The computer program product according to claim 1, further comprising:
managing data redundant parity including calculating, upon receiving the update request, one or more intermediate parities respectively based on data of the one or more first data storage units and the update data of the one or more second data storage units.

13. The computer program product according to claim 1, wherein
controlling swapping logical addresses associated with the one or more second storage units with respective logical addresses associated with the one or more first storage units is performed for data stored on a cache extension device,
further comprising contiguously writing data associated with logical addresses of the one or more first storage units after swapping with logical addresses of the one or more second storage units to storage areas of the one or more storage devices.

14. A method for managing defragmentation of a file system in a data storage system comprising a file system server connectable to one or more storage apparatuses and to one or more host computers, the method comprising:
allocating, in response to receiving an update request to update data stored in one or more first storage units of the of the plurality of storage units, one or more second storage units of the plurality of storage units indicated to be free based on free space allocation information for writing update data of the update request,
controlling writing update data to the allocated one or more second storage units, and
controlling swapping logical addresses associated with the one or more second storage units with respective logical addresses associated with the one or more first storage units.

15. An apparatus, in particular a file system server, being connectable to one or more storage apparatuses and to one or more host computers, the apparatus being adapted for use in a data storage system comprising a file system server connectable to one or more storage apparatuses and to one or more host computers, the apparatus comprising a file system management controller configured to execute:
allocating, in response to receiving an update request to update data stored in one or more first storage units of the of the plurality of storage units, one or more second storage units of the plurality of storage units indicated to be free based on free space allocation information for writing update data of the update request,
controlling writing update data to the allocated one or more second storage units, and
controlling swapping logical addresses associated with the one or more second storage units with respective logical addresses associated with the one or more first storage units.

16. A data storage system comprising:
one or more storage apparatuses, and
an apparatus according to claim 15 being connected to the one or more storage apparatuses and being connectable to one or more host computers.
